(19) United States
(12) Patent Application Publication
(10) Pub. No.: US 2008/0072139 A1
(43) Pub. Date: Mar. 20, 2008

(54) Mobilizing Webpages by Selecting, Arranging, Adapting, Substituting and/or Supplementing Content for Mobile and/or other Electronic Devices; and Optimizing Content for Mobile and/or other Electronic Devices; and Enhancing Usability of Mobile Devices

(76) Inventors: Robert Salinas, Palm Springs, CA (US); Iain Glendinning, Palm Springs, CA (US)

Correspondence Address: KENYON D. POTTER, 1180 EDDY ST. UNIT C, SAN FRANCISCO, CA, 94109, US

(21) Appl. No.: 11/840,924

(22) Filed: Aug. 17, 2007

Related U.S. Application Data
(60) Provisional application No. 60/822,941, filed on Aug. 20, 2006.

(51) Int. Cl. G06F 3/048; G06F 17/00

(52) U.S. Cl. 715/238; 707/100; 715/764; 715/810; 715/836; 715/838; 707/E17.005

(57) ABSTRACT

The invention includes systems and methods for selecting, arranging, adapting, substituting, supplementing, and optimizing content for mobile and/or other electronic devices. Mobilized content is accessible from any web-enabled electronic device including mobile phones and game devices as well as desktops and laptops. Mobilized content includes media files such as images, music, and videos as well as media clips of these files. In addition to mobilized media files and media clips, such methods and systems can also be used to enable mobile access to user's contacts, email, documents, tickets, and so on. Several methods enhance the usability of mobile phone with a graphical user interface with that enables the mobile user to select an option by pressing a single button on the keypad as an efficient alternative to scrolling from link to link.

### COPYRIGHT RIGHTS

A portion of the disclosure of this patent document contains material which is subject to (copyright or mask work) protection. The (copyright or mask work) owner has no objection to the facsimile reproduction by any-one of the patent document or the patent disclosure, as it appears in the Patent and Trademark Office patent file or records, but otherwise reserves all (copyright or mask work) rights whatsoever.

### FIELD OF THE INVENTION

This invention relates to computer-implemented systems and methods for converting existing webpages to webpages that can be displayed on both mobile devices with miniature size screens and computers with full size screens, and in particular, methods and systems for selecting, arranging, and/or adapting existing content, substituting existing representations of such content with images, pictures, iconographics, abbreviations and/or symbols, and supplementing existing content with additional content, links or other coding.

This invention also relates to computer-implemented systems and methods for optimizing content for mobile and/or other electronic devices, and in particular, methods and systems for optimizing content for display on mobile and/or other electronic devices that have miniature size screens with lower screen resolution, e.g. cell phones, smart phones, PDAs, and the like, and methods and systems for optimizing content to take advantage of functionality specific to certain mobile devices, such as cell phones, smart phones, hybrid PDAs, and so on.

This invention also relates to computer-implemented systems and methods for enhancing the usability of mobile devices, and in particular, methods and systems for enhancing the user interface including but not limited to the representation of graphical objects on the display in order to enable efficient selection of function represented by a graphical object the display.

This invention also relates to computer-implemented systems and methods for distributing targeted messages and the serving, collecting, managing, and analyzing and reporting of information relating to mobile and other electronic devices, and in particular, to methods and systems for targeting messages to users of mobile devices and other electronic devices using geographical and other pertinent information, and to methods and systems for serving, collecting, managing, analyzing and reporting information of users of mobile devices for individuals and/or multiple users of mobile and electronic devices. Such methods and systems can also be used for advertising, marketing, promotions, campaigns, orders, sales, subscriptions, donations, pledges and so on.

### DEFINITIONS

The following abbreviations and defined terms apply to methods or systems of the inventions described in this document. Abbreviations include but are not limited to acronyms and short hand expressions:
AC area code
A-GPS Assisted Global Positioning System (A-GPS)
AOA angle of arrival
CCTV closed circuit TV
CF compact flash (memory)
cHTML Compact Hypertext Markup Language
CORS Continuously Operating Reference Station
CRT cathode ray tube
CSS cascading style sheet
CT closing time
DGPS digital GPS
DLP digital light processing
DMS degree-minute-seconds
DPI dot per inch
dt delta (time)
DS destination size
DSL digital subscriber line
DTV digital television
E-FLT enhanced forward link triangulation
E-OTD enhanced observed time difference
ETA estimated time of arrival
FPD flat panel display
FTP file transfer protocol
GPS global positioning system
GUI graphical user interface
HDTV high definition television
HH hour(s)
HTML hypertext markup language
HTTP hypertext transfer protocol
IM instant message(ing)
IP internet protocol
IR infrared
ISP internet service provider
kph kilometers per hour
LAN Local area network
LCD Liquid crystal display
LED Liquid emitting diode (display)
MM minute (time)
MSA metropolitan statistical area
NFC near field communications
NXX prefix of telephone number (also known as exchange)
OEM original equipment manufacturer
OT opening time
PAN personal area network
PDA personal digital assistant
PIN personal identification number
POS point of sale
PPI pixels per inch
QCIF Quarter Common Intermediate Format
QVGA Quarter Video Graphics Array
QXGA Quantum eXtended Graphics Array
RDF resource description framework.
RF radio frequency
RFI request for information
RFID radio frequency identification
RFRSS radio frequency signal strength
RIR regional internet registry
ROW right of way
RSS RDF Site Summary or Rich Site Summary (an XML format for syndicating web content)
SD secure digital
SQRT square root
SOD size of destination
SVGA Super Visual Graphics Array
SXGA Super Extended Graphics Array
SS second (time)
SSR Small screen rendering
TDA time difference of arrival
TEL telephone
TFT thin film transistor
TOA time of arrival
TOD time of departure
TT travel time
TV television
T-Vel travel velocity
UTM Universal Transverse Mercator
ZIP zip code
° degree (geographical)
′ minute (geographical)
″ second (geographical)
UPC Uniform Product Code
Vel velocity
VGA Video Graphics Array
W3C World Wide Web Consortium
WAAS Wide Area Augmentation System
WAN wide area network
WAP wireless application protocol
WIFI wireless fidelity
WML wireless markup language
XGA Extended Graphics Array
XML extensible markup language
XHTML XML-compliant version of HTML

Definitions and defined terms include but are not limited to the following:

The term “screen” means any visual display including but not limited to a CRT, LED, LCD, FPD, TV, HDTV, projection screen, etc., and is used interchangeably with the term “visual display”. A screen is capable of displaying M pixels by N lines whereby a screen with 800 pixels by 600 lines is capable of displaying 800 distinct dots on each of 600 lines, or about 480,000 pixels

The term “screen resolution” means the clarity or sharpness of a display and is signified by the number of dots (pixels) on the entire screen and denoted by M pixels×N lines and is contrasted with unitized “resolution” which is signified by DPI or PPI.

The term “full size screen” means any visual display capable of a screen resolution of at least 800 pixels by 600 lines (e.g. SVGA), and typically has 1024 by 768 pixels (e.g. XGA), or 1248 by 1024 pixels (e.g. SXGA), 2048 by 1536 pixels (e.g. QXGA), and so on. The term “full size screen” also means any visual display regardless of type of hardware including but not limited a CRT, LED, LCD, FPD, TV, HDTV, projection screen, and so on.

The term “miniature size screen” is any screen that has fewer pixels than a full size screen including but not limited to 640×480 pixels (e.g. VGA), 320×240 pixels (e.g. QVGA), or 352×288 pixels (e.g. CIF), or 176×144 pixels (e.g. QCIF), and so on. The term “miniature screen” also means any visual display including but not limited a LED, LCD, FPD, TV, HDTV, and so on.

The term “mobilize” means conversion of one or more webpages that are capable of being displayed on a computer with a full size screen, e.g. desktop, laptop or notebook, to a one or more webpages that can be displayed on at least one mobile device with a miniature screen, e.g. PDA, mobile phone, smart phone, and so on. The term “mobilize” also means the conversion of one or more webpages that are capable of being displayed on a computer with a full size screen to one or more webpages that can be displayed on both a computer with a full size screen and at least one mobile device with a miniature screen, or that can be displayed on a computer with a full size screen and multiple mobile devices with miniature screens. The term “mobilize” also means creation of one or more webpages that are capable of being displayed on at least one mobile device with a miniature screen, e.g. PDA, mobile phone, smart phone, and so on, with or without benefit of one or more pre-existing webpages as a starting point. As used herein, the term “conversion” includes but is not limited to selecting, arranging, and/or adapting content from one or more existing webpages for display on mobile devices, substituting existing representations of such content with images, pictures, iconographics and/or symbols, and supplementing existing content with additional content such as text, pictures, and so on. As used herein, the term “creation” includes but is not limited to selecting, arranging, and/or adapting content from any source (digital or non-digital) for display on mobile devices.

The term “mobile module library” means a library of software modules that are called or referenced by pre-defined and/or user-customized tags or any other type of reference included in the markup language or source code of a webpage. The mobile module library also means any software code regardless of its language, organization, and/or storage location.

The term “tag” means any code or computer instruction whatsoever inserted in the markup language or source code of a webpage. A tag usually but does not necessarily take the form of “<tag> . . . </tag>” or “<tag [- . . . ]> . . . </tag>” or the like.

The term “call” means any code or computer instruction whatsoever inserted in the markup language or source code of a webpage that references a script, binary, or executable code. A “call” usually but does not necessarily take the form of “<!--#command-->”, <#include> or the like.

The term “area code” means digits 1-3 of a 10-digit telephone number representing a unique code that corresponds to a particular geographic area, e.g. 415 is the area code for the city of San Francisco, Calif. In a full telephone number, the digits of “area code” typically precede the digits of the “exchange code”. The term “area code” may also be known as “city code” and these terms may be used interchangeably.

The term “day” is any day or date whatsoever and can mean any period of time having a 24-hour duration including but not limited to a calendar day, a working day, a day of week, a day of month, a day of year, any holiday, e.g. Valentine's day, New Year's Eve, New Year's Day, Christmas Eve, Christmas Day, Independence Day, and so on. The “term” day may also mean “date” or “calendar date” and these terms may be used interchangeably. See also “time of day” defined below.

The term “country code” means the number, e.g. typically 2 digits, that precedes the telephone number and is a unique code that corresponds to a particular country.

The term “delivery” means delivery in any form whatsoever including but not limited to delivery by voice messages, text messages, IM, email with or without attached documents, multi-media including streaming, tickers, RSS, WAP, internet, messaging service, narrowcast, and so on, and may utilize any communication protocol such as IP, mobile IP, FTP, HTTP, HTTPS, and so on.

The term “device” means any electronic device including but not limited to mobile electronic devices or immobile electronic devices that are capable of either one-way or two-way communications including but not limited to cellular phones, handheld radios, pagers, laptop computers, notebook computers, ultra-compact computers, desktop computers, set-top boxes, cable boxes, satellite phones, video phones, PDAs, MP3 players, devices on-board vehicles including but not limited to planes, ships, cars or trucks, and so on, and RFID devices attached to other tangible items such as products, packaging, shelves, displays, signs, exhibits, and so on.

The term “elevation” means the latitude of a device as measured in a standard unit of distance, e.g. meters, or measured in units of distances with trailing decimals. The term “elevation” may be known as “altitude” and these terms may be used interchangeably.

The term “exchange code” means digits 4-6 of a 10-digit telephone number or digits 1-3 of a 7-digit telephone number. In the latter context, the term “exchange code” may also be known as a “prefix”, e.g. NXX, and these terms may be used interchangeably. In a full telephone number, the digits of “exchange code” typically follow the digits of the “area code”.

The term “geographical variable” can include any variable, or combination of variables, whatsoever having information relating either directly or indirectly to geographical information including but not limited to latitude, longitude, UTM, street number, street name, cross-street name, residential address, billing address, neighborhood, city, county, state, country, zip code, telephone number, area or city code, exchange, IP address, building name, building number, floor number, station name, station number, call box number, survey point, landmark, and so on.

The term “identifier” means any information in any form whatsoever that uniquely identifies a device including but not limited to a telephone number, a device identification number, a device's name, a user's name, a street address, a pre-assigned identification number, a user-defined passcode, a pre-assigned or user-defined username, birthplace, and so on.

The term “internet service provider” means any person or entity whatsoever that provides an access point to the internet including but not limited to telephone companies, telecommunications companies, cable companies, media companies and any other commercial organizations as well as universities and other institutions, not-for-profits, community associations, government entities, and so on.

The term “IP location” means the act of locating a device by, or the location derived from, use of an IP address whether or not static or dynamic assigned address, based on the point of access.

The term “latitude” means the latitude of a device as measured in degrees, a combination of degrees and minutes, or a combination of degrees, minutes and seconds where a degree comprises 60′ and a minute comprises 60″, or as measured in degrees with trailing decimals or as measured in degrees and minutes with trailing decimals. By convention, the latitude is often measured from the equator, with positive values to the north of the equator and negative values to the south of the equator.

The term “longitude” means the longitude of a device as measured in degrees, or a combination of degrees and minutes, or a combination of degrees, minutes and seconds where a degree comprises 60′ and a minute comprises 60′, or as measured in degrees with trailing decimals or degrees and minutes with trailing decimals. By convention, the longitude is often measured from the prime meridian, with positive values to the east of the prime meridian and negative values to the west of the prime meridian.

The term “location” means the act of locating a device by, or the location derived from, use of GPS location, RF location, Tele location, ZIP location, and so on.

The term “GPS location” means the act of locating a device by, or the location derived from, use of GPS in any form whatsoever, including but not limited to A-GPS. GPS Location is based on technique of “resection” where knowing the distance from an unknown location to a certain number of known locations allows the determination of the position, e.g. coordinates, of the previously unknown location.

The term “message” means information in any form whatsoever including but not limited to a text message, picture, photo, cartoon, audio, video, animation, presentation, and so on, and any combination of these forms include multi-media message, audio-video, voice over animation, voice over presentation, pictures or photos with captions, cartoons with captions or call-outs, and so on. A message can be information pushed by a customer to a device, requested by the user of the device, e.g. information about a popular destination, or initiated by any person, organization, or entity. A message may be initiated in response to a specific request or in response to an automated protocol.

The term “narrowcast” means transmission of a RF signal, or the act of transmitting a RF signal, from a source resulting in receipt of the RF signal in relatively small geographical area. A narrowcast can be from any RF source whatsoever including but not limited to a single cell tower, a transmitter, a base station, a repeater station, a two-way radio, a bluetooth source, a RFID source, a NFC source, any electronic device capable of RF transmission, and so on. The geographical area of a narrowcast typically has a maximum range of up to 10 kilometers but may have a lesser or greater range.

The term “near field communication” means transmission of a RF signal, or the act of transmitting a RF signal, from a source resulting in receipt of the RF signal in a small or very small spatial area. A near field communication can be from any source such as an electronic device, a POS device, a RFID source, a NFC source, a microchip, and so on, or any source attached to or embedded in another electronic device. The spatial area of a near field communication typically has a maximum range up to 1 meter but may have a lesser or greater range.

The term “network” means any communications network, any subnetwork (aka “subnet”) or any combination of these, including but not limited to ethernet, LAN, WAN, PAN, internet, intranet, extranet, wired network, wireless network, telephone network, cellular network, cable network, satellite network, a mesh of network connections or access points, and so on, including but limited to transmission via conventional electrical conductors, twisted pair, Cat-V, Cat-10, or Cat-100 cables, coaxial cables, fiberoptic cables, DSL, broadband, light transmission, laser transmission, and RF transmission at any frequency, and so on.

The term “RF location” means the act of locating a device by, or the location derived from, use of GPS, A-GPS, or by any RF means whatsoever such as triangulation, AOA, E-FLT, E-OTD, RFRSS, TDA, TOA, near field communications, and so on.

The term “Telelocation” means the act of locating a device by, or the location derived from, use of a telephone number in any form whatsoever in whole or in part such as the 10-digit telephone number, a 7-digit telephone number without the area code (or city code), the area code (or city code) alone, the exchange code alone, and/or a combination of the area and exchange codes or the area code and exchange codes.

The term “telephone number” means a number that corresponds to a particular electronic device including but not limited to a mobile phone, PDA, an electronic device connected to a landline, and so on. A telephone number typically corresponds to an electronic device that is capable of voice communications but also correspond to an electronic device that is capable of voice, facsimile, text, and/or video communications.

The term “ZIP location” means the act of locating a device by, or the location derived from, use of ZIP code in any form whatsoever including the 5-digit zip code, a portion of the ZIP code such as the 2 leading digits, the leading 3 digits, and so on, or the zip code plus 4 trailing digits.

The term “Five Digit Zip” means the act of locating a device by, or the location derived from, use of the 5-digit zip code without more or fewer digits.

The term “ZIP plus 4” means the act of locating a device by, or the location derived from, use of the 5-digit zip code plus 4 trailing digits.

The term “time” means the duration oftime as measured in seconds from an established point in time to the current time of day as measured in years, days, hours, minutes, seconds, or any combination of these, where a year comprises about 365.25 days, a day comprises 24 hours, an hour comprises 60 minutes, and a minute comprises 60 seconds. By convention, time is often measured as the number of seconds from beginning of Jan. 6, 1980. The term “time” can also mean anything that represents time or has temporal significance, e.g. time of day, time of month, time of year, summer time, and holiday's including St. Valentine's day, New Year's eve, Christmas, the time between thanksgiving and Christmas, etc. See also the term “time of day” defined below.

The term “time of day” means the time of day in any form whatsoever including time of day as measured in hours, or a combination of hours and minutes, e.g. HH:MM, or a combination of hours, minutes, and seconds, e.g. HH:MM:SS, from the beginning of the current day where a day comprises 24 hours, an hour comprises 60 minutes and a minute comprises 60 seconds. The term “time of day” may also be measured in a portion of a 24-hour period that occurs each day such as morning, afternoon, evening, night, breakfast, lunch, dinner, dawn, sunrise, dusk, sunset, and so on.

The term “wireless service provider” means any person or entity whatsoever that provides access to the internet and/or other network(s) including but not limited to telephone companies, telecommunications companies, cable companies, media companies and any other commercial organizations as well as universities and other institutions, not-for-profits, community associations, government entities, and so on. Access may be WIFI (including any type of 802.11 network, e.g. 802.11b, 802.11a, 11g, dual-band, etc.), bluetooth (including any type of personal area network), broadband, or any other wireless protocol and may be connected through a wireless access point, a host device with wireless capability, or any other means of access such as a publicly accessible grid of devices (or mesh).

### BACKGROUND OF THE PRESENT INVENTION

Prior methods of authoring, creating or publishing content on the internet required the author, web developer, webmaster, etc. to create code for these webpages using a specific markup language and/or protocol that is compatible with the device used to view or “browse” the content. Thus, the code is inherently device dependent.

Initially, this dependency was a problem for desktop computers that had different hardware and software configurations. This dependency was alleviated in part by the establishment of standard protocols, e.g. HTTP and WAP by international standard setting organizations such as the W3C, and because a single browser application that operates on most platforms, Microsoft Internet Explorer (IE), has became dominate in the marketplace.

Thus, this dependency is no longer a problem with respect to authoring, creating, or publishing content exclusively on platforms having full size screens, e.g. desktops, laptops, and notebooks. Several vendors market software applications to produce markup language, e.g. HTML or XML, for desktop platforms as well as other platforms that have full size screens, e.g. laptops and notebooks. For example, one software application is named Dreamweaver and made by Adobe Systems of San Jose, Calif., but only supports devices with full size screens.

However, the dependency has again arose as a significant problem for authors, web developers, webmasters who wish to author, create, or publish content on mobile platforms such as mobile phones, smart phones, or PDAs. This dependency is especially a problem for those who wish to author, create, or publish content on both desktop and mobile platforms. Vendors that market software applications to produce markup language for mobile devices but do not adequately alleviate this dependency. One software application is Go Live made by Adobe Systems of San Jose, Calif., which perform SSR using the Opera browser but only addresses reformatting of a webpage. For example, CSS-based websites created in GoLive CS2 are automatically reformatted so they appear properly on any size screen. Also, several new browser applications are specifically designed for viewing webpages on mobile phones. For example, the Opera Mobile or Opera Mini browsers made by Opera Systems of Oslo, Norway, can display existing web pages on a mobile device having any screen size. Thus, the Opera Mini browser essentially reformat the webpage. Heretofore, none of these applications adapt the webpage to the mobile device by removing, substituting or supplementing content.

Currently authors, web developers, and webmasters who wish to optimize website for mobile devices must create and maintain separate code for desktop platforms and for each mobile platform. Even if mobile platform standardize on a single language and/or protocol or a browser can view all existing websites, there will remain a difference between content required for desktop platform and the mobile platform due to screen resolution, screen size, on-board memory, bandwidth, input device, and so on.

Further, even if one or more methods is developed for browsers to trim webpages as is used by editors to trim inches of newspapers articles, there will remain a difference between content required for desktop platform and the mobile platform due to functionality specific to mobile devices. An example of functionality specific to mobile devices but heretofore not supported any application is markup language for making telephone calls such as a mobile tag, e.g. <phone> . . . </phone> where “ . . . ” represents the device-specific code for making a telephone call. Another example of functionality specific to mobile devices but not supported by any existing software is markup language for making telephone calls such as a mobile tag, e.g. <sms> . . . </sms> where “ . . . ” represents the device-specific code for creating and sending a SMS message. There are many other examples including but not limited to sending email, uploading pictures, and so on.

A browser application does not know what a webmaster is thinking unless additional code specific to mobile devices is added to the webpage. Thus, the webmaster or his or her agent, needs to include code specific for mobile devices if the webmaster wishes to optimize the webpage for mobile devices.

Early computer-implemented systems and methods for promotions included banner ads, pop-up ads, display ads on desktop computers and other stationary devices with internet browsers such as Internet Explorer (IE) made by Microsoft Corporation and the type made by Prodigy Networks, Netscape Communications, and America Online (AOL). Such computer-implemented methods for promotions were also utilized on mobile computers using the same types of internet ‘browsers’ over dial-up, broadband, and/or wireless technologies. Such browsers and related software, e.g. cookies, can track users preferences, websites visited, and so on, and can also customize webpages to individual users, e.g. MyYahoo! or My {brand}, so that web content can be targeted to the individual. More recently, such computer-implemented methods for promotions were moved to mobile communications devices such as mobile phones using a similar type of browser modified to be suitable for the screen size and memory limitations of cellular phones. Such browsers are of the type made by Qualcomm, Inc. or Samsung Electronics.

However, whether or not modified for cell phones, such ‘browsers’ have inherent limitations for promotion due to their origin as browsers. Due to their origin on the desktop, the design of the browser and related software does not track the location of the user. Even for mobile computers, the browser does not track the location of the user. From the perspective of hardware, the architecture or the desktop computer does not incorporate GPS technology. Since the architecture of the notebook computer is based in large part on miniaturization of the desktop computer, the architecture of the notebook computer also does not incorporate adequate technology for location tracking of the device.

Unlike other some mobile devices, laptops and notebooks do not have the capability for GPS location. OEMs have incorporated GPS technology in some types of mobile devices for the purpose of user navigation. Yet, such GPS technology are not incorporated in laptops and notebooks. Thus, GPS location may not be effective for laptops or notebooks because the typical laptop or notebook lacks the on-board capability for self. Similarly, Telelocation may not be effective for laptops or notebooks because the typical laptop or notebook does not have a telephone number assigned to it. Even though GPS location or Telelocation may not be effective for laptops or notebooks, other methods of location such as IP Location would still be effective. To date, only a few OEMs include technology location tracking using IP address, to assist in the recovery of stolen portable computers, e.g. laptops. This technology is based on location using the IP address through which the portable computer is connected to the internet. Although GPS location may not be effective for the laptop or notebook computer, GPS location would still be effective for many mobile devices.

Mobile phones have heretofore been designed and used for multiple purposes. Mobiles phones are undoubtedly designed to be used for communication purposes. In addition, mobile phones are designed to be used for other purposes such as calculators, calendars, notepads, and games. Mobile phones are increasingly becoming the standard ‘device’ for mobile communications as well as many other purposes. The market for mobile phones is continuing to experience significant growth and appears to be merging with the market for PDAs such as the iPAQ made by Hewlett-Packard or the Treo made by Palm, Inc. As such, the most popular device of today and tomorrow is likely to be a mobile electronic device that includes wireless communications including voice, email, IM, and so on plus other applications such as calendar, calculator, notes, navigation, and so on. Thus, marketers need to be able to market products and services to users of these devices by distributing messages to these devices, and optionally, completing the sale and/or distribution of actual products or services. Also, users of devices need to be able to request information via these devices, and optionally, to take further action based on requested information.

However, mobile communication devices were not specifically designed for locating of the person, animal, or object carrying or transporting the device. Although some techniques exist for RF Location such as time of travel, triangulation and signal strength, GPS location has only recently been become the leading standard. When technology for GPS location is augmented with additional technology, e.g. A-GPS, it also provides the elevation, altitude, or vertical position of the device. In particular, A-GPS is being mandated for incorporation future phones principally so that a user can be located in the event of an emergency situation including but not limited to becoming injured, incapacitated, or lost. Yet, such technology can be used for many other purposes including tracking of potential criminal activity by law enforcement, monitoring of a child whereabouts by parents, monitoring of employee activity by employers, and so on.

Another potential use of GPS location is to target ads to users of mobile devices based on geographical location of the users, e.g. to alert users to nearby tourist destinations, points-of-interest, events and venues, eating and shopping establishments, fuel stations, and so on. Yet, such potential use of GPS location has not been exploited. Thus, GPS location offers significant opportunities to target information or messages to the user of the mobile phone in addition to tracking of humans, animals, and objects. However, using GPS alone is not always sufficient because it may be over-inclusive. Typically, information, advertisements, or messages must be targeted to users based on variables including but not limited current location, time of day, and place of residence in addition to or in lieu of user demographics and preferences. Without more variables, GPS would allow display of information, advertisements, or messages at an unattended time of day and/or to unattended person such as travelers from out-of-town rather than local residents. Thus, location of a device using GPS alone is not ideal method of target information, advertisements, or messages to users of a device.

As a result, mobile phones, PDAs, and other electronic devices have remained devoid of advertisements and promotions despite the growth in use of such devices. Advertisements, marketing, selling or promotion was primarily limited to web browsers or email on mobile devices but not in other contexts. Heretofore, mobile devices have not been effectively used as a marketing channel for promotion and sales. In particular, mobile devices have not been used for “targeted” marketing. Past examples of marketing or promotion include only “direct” marketing to an individual mobile device based on a reservation, e.g. hotel, dinner, entertainment and so on made by the user, or a to an existing customer or client who is already registered to receive information. One alternative method is a broadcast of a message to all users within a network. For example, the prior art describes the broadcast of a message to all users of mobile phones who were subscribers to the network. Yet, such a broadcast is both overinclusive and underinclusive. The broadcast is overinclusive because it is sent to persons of all demographics and does not target a message to a particular subset of users; it is underinclusive because it is limited to subscribers to the network and does not target a message to users outside the network.

In addition, the prior art teaches GPS or A-GPS location as the sole solution in the future. Yet, many existing mobile devices do not yet have GPS technology nor will all mobile devices have such GPS technology in the foreseeable future. Further, users may retain the option to turn off the GPS technology for one or several reasons including the right of privacy. Further still, the precise locations of individual users may not need to be known for marketing purposes. Thus, GPS location would not be a solution for these existing mobile devices. Heretofore, the prior art does teach the use of GPS location for targeted distribution of messages but does not teach a method that is effective for targeting of messages based on geographical location and other factors such travel velocity, heading, temporal criteria, and other criteria. For example, U.S. Pat. No. 6,983,139 to Dowling describes targeting messages to users of mobile phones based solely on geographical location using RF location including GPS location.

GPS capability is based on satellite and land-based positioning stations that supports location with varied accuracy depending on the device's capability to operate in autonomous positioning mode vs differential positioning mode, and the availability of positioning stations such as CORS, DGPS, and WAAS or one or more standalone base stations. See table 1 below.

TABLE 1
Levels of GPS Precision

| Level | Accuracy |
|---|---|
| Highest | <1 meter |
| Very High | ˜1 meter |
| High | 3 meters |
| Typical | 10 meters |
| Lower | 30 meters |
| Lowest | >100 meters |

Although not all mobile devices have GPS capability today and those having GPS may lack the greatest precision, the present invention recognizes that mobile phones and other mobile communication devices attract a growing number of users like television attracts millions of viewers, radio attracts millions of listeners, and the web sites attract millions of visitors. One reason is that although a high level of precision is needed for activities such as land surveying, such precision is not necessary for most purposes. Hence, mobile computer devices have potential as a marketing channel like television, radio, and the internet are marketing channels. Yet, mobile communications devices have not heretofore been recognized as a marketing channel for advertising, marketing, sales or other promotion. Hence, the present invention enables advertisers and marketers to overcome past failures to recognize and develop this marketing channel.

Whether contracts on a monthly, annual or biennial basis or prepaid agreements, subscriptions are the primary source of revenue in the mobile phone industry. Under the subscription model, a user of a mobile phone subscribes to a service plan. Sales of auxiliary features, e.g. text messages, ringtones, etc. are currently a secondary source of revenue. Yet, these are often included as a standard feature, offered as a premium feature, or bundled with standard or premium features in the subscription revenue model. However, mobile phones are often sold at or below cost in order to promote purchase of subscriptions. Hence, subscriptions are the profit center of the mobile phone industry.

Given this industry model, the mobile phone industry presently lacks other sources of revenue. Except for promotion of add-on features themselves, a mobile phone did not incorporate advertising, marketing, selling, or promotion of other products such as goods, services, real property or other things. Traditional advertisements on computers may take the form of banners, scrolling text or tickers, flashing objects, pop-up windows, frames or borders, etc. during execution of the game. One problem is that these advertisements reduce the display area available for the mobile phone's GUI. Another problem caused by these advertisements is that these advertisements delay a communication. Still another problem is that advertisers and marketers did not understand that mobile phones represented an untapped channel for advertising, marketing, selling and promotion similar to print ads, billboards, television, radio, cable, and the internet.

As a result, mobile phones have remained devoid of advertisements and promotions despite the growth in mobile phone use. Advertisements, marketing, selling or promotion was primarily limited to web browsers or email on mobile devices but not in other contexts. Heretofore, mobile devices have not been used as a marketing channel for promotion and sales.

Another problem is that existing navigation tools on mobile phones do not optimize potential destinations according to needs of the user of the mobile phone. For example, potential destinations, e.g. points of interest, may be displayed in a menu, on a map, with directions, and so on. Such navigation systems include systems like StreetAtlas USA in PDAs such as iPAQ or Treo. However, if any potential destinations display information, the information is typically limited to the size of the visual display or GUI such that a map is cropped and a menu or list truncated or separated in sequential pages. Except for the limited size of visual display, the potential destinations are not filtered, sorted, or otherwise processed without input of additional information or directions from the user. For example, unless the default is set to the current location of the user, the user must select the current location, or if planning a trip, must select a destination.

In addition, if unfamiliar with the destination, the user must generally select particular type of destination, e.g. accommodations, hotels, points of interest, stadiums, events and so on. Thus, information about potential destinations are not specifically tailored to the user of the device. For example, patent application US20060085419 by Rosen describes navigation and matching methods for users of mobile phones based on certain geographical variables including cell site zones or GPS as well as other variables from profiles based on user input. Except for GPS, these other variables require input by user which is problematic due to concerns about privacy as well as burdensome, and thus, consumers are unlikely to adopt. As a result, the potential destinations identified by existing methods are suboptimal and often ineffective to assist the user of the device. Heretofore, the prior art does not tailor destinations in a manner that provides effective assistance to the user of the device. In particular, except for GPS, the prior art does not utilize methods that are self-executing without user input of variables.

### SUMMARY OF THE INVENTION

This invention relates to computer-implemented systems and methods for converting existing webpages to webpages that can be displayed on both mobile devices with miniature size screens and computers with full size screens, and in particular, methods and systems for selecting, arranging, and/or adapting existing content, substituting existing representations of such content with images, pictures, iconographics, abbreviations and/or symbols, and supplementing existing content with additional content, links or other coding.

This invention also relates to computer-implemented systems and methods for optimizing content for mobile and/or other electronic devices, and in particular, methods and systems for optimizing content for display on mobile and/or other electronic devices that have miniature size screens with lower screen resolution, e.g. cell phones, smart phones, PDAs, and the like, and methods and systems for optimizing content to take advantage of functionality specific to certain mobile devices, such as cell phones, smart phones, hybrid PDAs, and so on.

This invention also relates to computer-implemented systems and methods for enhancing the usability of mobile devices, and in particular, methods and systems for enhancing the user interface including but not limited to the representation of graphical objects on the display in order to enable efficient selection of function represented by a graphical object the display.

An object of the present invention is to “mobilize” webpage(s). Such mobilization can be accomplished by converting existing webpage(s) including both content and code, e.g. HTML or XML, for display on mobile devices. One method parses an existing page and employs a wizard to build the converted page(s) for display on mobile devices. Another method employs a wizard to build a mobile webpage from source material with or without use of existing webpage(s).

Another object of the present invention is to “mobilize” webpage(s) by taking the converted or “mobilized” webpage(s) and supplementing the converted webpage(s) with additional code that takes advantage of the functionality of the mobile devices.

Another object of the invention is the generation of code for display of webpages on both mobile devices and desktop devices using a single electronic template or web-based form for data entry.

One embodiment of the invention includes a method or process by which the user either enters the URL address of a web page or pastes the source of a page into the application. After the page is parsed, the user is able to select elements that are identified in the html, like titles, headings, images, anything the user wants to include on the mobilized page. After the user selects a template that has the elements he or she wants to include on the mobile page, the user can save the new page that contains a script to identify the browser as a WAP device or a desktop browser and present the code accordingly.

Another embodiment of the invention includes a method or process by which the user identifies one or more sources of content to include on a mobilized page, selected a template, and subsequently uploads the content to a mobile page without benefit of an existing webpage(s).

The invention includes a method or process embodied in a mobilizer module comprising a plain language wizard that allows users to easily create dynamic pages. The output pages can be displayed on mobile phones, e.g. WML, as well as other formats. As an example, the wizard can take the form of pre-determined or canned formats, or an interview format so that the webpage can be partially or fully customized.

For example, in a pre-determined or canned format, a webmaster or web author is presented with a choice of one or more page layouts and the user selects a page layout which has predetermined background colors, text colors, and so on. In one embodiment, the page layouts use CSS; in another embodiment the page layout doe not use CSS. For example, a relatively simple page layout may include a header with title at the top of webpage and a body comprising the remaining webpage as shown in Table 2.

TABLE 2
Example of Simple Page Layout

```
Header:
  I would like the TITLE to say “MY WIRELESS HOMEPAGE”
Body:
  I would like the IMAGE to be “UPLOADED IMAGE”
  I would like the TEXT to say “THIS IS MY WIRELESS HOMEPAGE”
  I would like the PHONE LINK to say “CALL ME” and dial
  “7602183048”
  I would Like the EMAIL LINK to say “EMAIL ME” and go to
“NAME@EMAIL.COM”
```

For example, in an interview format, a webmaster or web author is presented with a choice or one or more Page Layout templates. In one embodiment, the templates are formulated as simple, moderate, and complex. In another embodiment, the templates are formulated as beginner or experienced. For example, a relatively simple template may have the following questions:

TITLE

Yes No If yes, I would like a TITLE on my page

IMAGE

Yes No If yes, then I would like an IMAGE on my page

EMAIL LINK

Yes No If yes, then I would like an EMAIL LINK on my page

PHONE LINK

Yes No If yes, then I would like a PHONE LINK on my page

TEXT

```
Yes   No   If yes, then I would like some TEXT on my page
  DONE? Yes   No   If yes, then I am DONE;
  if not then continue
```

WEBLINK

```
Yes   No   If yes, then I would like a WEBLINK on my page
  DONE? Yes   No   If yes, then I am DONE;
  if not then continue
```

ANOTHER IMAGE

```
Yes   No   If yes, then I would like an ANOTHER IMAGE
on my page
  DONE? Yes   No   If yes, then I am DONE;
  if not then continue
```

Continuing the example, the webmaster or author is then prompted to enter the data, information, or objects for the objects selected above.

I would like the TITLE to say “MY WIRELESS HOMEPAGE”

I would like the IMAGE to be “UPLOAD IMAGE”

I would like the EMAIL LINK to say “EMAIL ME” and go to “NAME@EMAIL.COM”

I would like the PHONE LINK to say “CALL ME” and dial “7602183048”

I would like the TEXT to say “THIS IS MY WIRELESS HOMEPAGE”

I would like the ANOTHER IMAGE to be “UPLOAD IMAGE”

I would like the WEBLINK to be “MY CONTACTS”

This top down object oriented way of building perfect syntax WML files, removes any errors that are common when developing WML files, and exposes all of the powerful functionality of WML such as “wtai” commands. The webpage(s) are dynamically generated and uses all the functionality of PHP to create teh WML pages. Using this method with your existing HTML, PHP, or other web pages is straightforward.

Every function of WML is encapsulated in this wizard and the user is able to access these functions using plain language, e.g. English, Spanish or other language, rather than codes or other computer language. In one embodiment, the wizard is printed text; in another embodiment the wizard is uses spoken words.

Optionally, the webmaster or web author selects what category to list the webpage in a directory. In one embodiment, the webmaster or webauthor includes the webpage in a directory visible to others—that is—viewable by other cell phones users and/or desktop browsers. In another embodiment, the webmaster or webauthor includes the webpage in a directory that is not visible to others without authentication such as access is restricted to use of a PIN or username and/or password. Alternatively, the webmaster or web author may include code or instructions, e.g. META tags, in the web page so that it is not indexed by search engines or spiders.

I would like my page to be listed in the “PERSONAL” category

Mobile Module Library is setup to allow custom tags to reference these modules. Table 3 below shows an example of the Mobile Module Library:

TABLE 3
Example of Mobile Module Library

| Item No. | Tags | Description |
|---|---|---|
| 1 | <phone> . . . </phone> | Inserts a direct link to a phone number |
| 2 | <email> . . . </email> | Inserts a direct link to an email |
| 3 | <form> . . . </form> | Inserts a form mailer for collecting information |
| 4 | <pb> . . . </pb> | Inserts a link that adds a name and number to the |
| | | phonebook |
| 5 | <timer> . . . </timer> | Inserts a timer that goes to an address after a |
| | | specified number of seconds |
| 6 | <video> . . . </video> | Inserts a link to a mobile video file |
| 7 | <sms> . . . </sms> | Inserts a input box for number and message to send a |
| | | sms message |
| 8 | <upload> . . . </upload> | Inserts an input for retrieving a file off of the phone |
| | | and uploading it to a webserver |
| 9 | <userdefined> . . . </userdefined> | Allows the user to write code to be interpreted using |
| | | a userdefined tag (This allows users to extend the |
| | | toolkit). |

where “ . . . ” represents the computer code or instructions specific to a device. For example, the “ . . . ” in <phone> . . . </phone> represents the computer code or instructions specific to a mobile phone.

Another object of the invention is the optimization of content on mobile devices to take advantage of functionality specific to mobile device, e.g. making telephone calls, sending text messages, and so on. Using markup language, a webmaster or his or her agent may indicate where a software application, e.g. mobilizer module, may insert additional objects to the webpage that take advantage of functionality specific to mobile device, e.g. <phone> . . . </phone> where “ . . . ” represents the telephone number and coding or computer instruction specific to a mobile device that makes a telephone call.

Another object of the present invention is to simplify the generation of code for webpages on mobile devices. An embodiment of the invention includes a method whereby the webmaster or his or her agent includes tags to indicate content, including text graphics and coding, intended for display or use on mobile devices. An embodiment of the invention would be the use of tags, e.g. <mobile> . . . </mobile>, to demark which content or coding is intended for mobile devices having miniature screens where “ . . . ” includes content and/or coding for mobile devices or specific to a kind of mobile device. A browser for desktop would ignore the code within these tags. The mobilizer module would use these tags to generate a web page to for mobile devices. The mobilizer module may be a component of a browser or any other software and may reside on-board the mobile device or on a remote server. In one embodiment, the mobilizer module would ignore content outside of such tags; in other embodiments, the mobilized module may utilize some or all of the tags.

Another object of the present invention is to simplify the viewing of content on mobile devices. An embodiment of the invention includes a method whereby the webmaster or his or her agent includes tags or coding indicating that pre-determined content be trimmed or skipped by a browser before the webpage is displayed on mobile device. An embodiment of the invention would be the use of tags, e.g. <nonmobile> . . . <nonmmobile>, to demark which content is not displayed on mobile devices having miniature screens but are displayed on devices having full size screens. However, this method's use of tags to indicate what content is intended for full size screens would require modification to all existing browsers including browsers for full size screens and possibly changes to the HTTP or WAP protocols. Another embodiment of the invention would embed a code in visible text, e.g. “STOP” . . . “START” as formerly used in telegrams, to demark where content of a webpage should be skipped when viewing on a mobile device, and similarly, “END OF DOCUMENT” or “END”, as formerly used in telegrams and still used in formal documents, to demark where content of a webpage should be trimmed when viewing on a mobile device. The visible text could be made small and displayed in the background color to avoid distraction. This method is superior because it does not require modification of existing browsers for devices having full screens but only for browsers designed for mobile devices such as Opera Mobile or Opera Mini. However, use of visible text would likely be indexed by search engines.

Another embodiment of the invention would be the use of tags, e.g. <mobile> . . . </mobile>, to demark which content is intended for mobile devices having miniature screens where “ . . . ” includes code or instructions for mobile devices or specific to a kind of mobile device. Since browsers for desktops and other devices with full size screens would ignore the code within these tags, it would not affect such browsers. Another embodiment of the invention uses pairs of special tags, e.g. <mobile> . . . </mobile>, where “ . . . ” is content to be display and/or codes to be used on a mobile device, to demark each section of content or code to be displayed on a mobile device and other code to be skipped on a mobile device. Similarly, the invention uses a special tag “<endmobile> . . . </endmobile>, where “ . . . ” may be empty, to indicate where to trim mobile webpage. Since tags would be ignored by search engines, the search results would not be affected.

Another object of the present invention is to enhance usability. A webmaster or his or her agent may wish to design webpages that allow a user to select a function represented by a graphical object with minimal effort. Ideally, an agent would automatically re-arrange the mobile webpage to enhance usability. In one embodiment, the webpage is designed to have graphical objects arranges in a matrix of columns and rows corresponding to buttons on the keypad. In this way, a user could select up to 9 pre-defined functions, links, or other commands by pressing corresponding keys “1” to “9” and could select even more commands by pressing “0” to toggle between sets of pre-defined functions similar to the SHIFT or ALT keys on the standard computer keyboard.

In addition, a webmaster or his or her agent may wish to design webpages to avoid user needing to scroll down the webpage, or at minimum, to limit the amount of necessary scrolling avoid or limit the scrolling required be a user. Ideally, an agent would automatically modify the code to avoid a user needing to scroll down the webpage, or at minimum, to limit the amount of necessary scrolling. For example, an agent would could be the mobilizer module, a browser, or any software application. In one embodiment, the webmaster or agent inserts a META that defines the maximum length of page. In another embodiment, an agent could insert a tag or other code, e.g. <endmobile> . . . </endmobile>, at a location in the webpage afterwhich content and/or coding should be trimmed on a mobile device.

This invention also relates to computer-implemented systems and methods for systems and methods for distributing targeted messages and the serving, collecting, managing, and analyzing and reporting of information relating to mobile and other electronic devices, and in particular, to methods and systems for targeting messages to users of mobile devices and other electronic devices using geographical and other pertinent information, and to methods and systems for serving, collecting, managing, analyzing and reporting information of users of mobile devices for individuals and/or multiple users of mobile and electronic devices. Such methods and systems can also be used for advertising, marketing, promotions, campaigns, orders, sales, subscriptions, donations, pledges, and so on.

New mobile phones and communication devices have GPS or A-GPS capability that allows their use as navigational aids and their location during an emergency or in response to a crime. However, despite having GPS capability, this capability is underutilized for other purposes such as marketing, and thus, mobile communications devices are currently unexploited as are marketing channel. In addition, no one has employed self-executing methods that utilize variables that do not require user input. Self-executing methods may include base variables geographic variables, time of day, calendar date, as well as spatial and kinetic variables that are derived from geographic variables including distance from destination, travel velocity, heading, dynamic range, etc. Such spatial and kinetic variables would allow potential destinations to be filtered by opening hours, product and service offerings, pricing, and so on. For example, based on distance from destination alone, a mobile device could keep informed the driver of a vehicle of the nearest fuel station(s), food establishment(s), and so on. In another example, based on time of day and heading, a mobile device could keep informed the driver of a vehicle of the upcoming destination(s) that are “open for business”. In a further example, based on heading and travel velocity, a mobile device could keep informed the driver of a vehicle of the upcoming destination(s) that are within a range. Thus, an object of the invention is to predict the likelihood or alacrity of a user to go to a particular destination.

An object of the present invention is location of a mobile communication device carried or worn by a human who may be an adult or child or may be a leader of a group.

Another object of the present invention is location of a mobile communication device carried or worn by a pet or other animal.

Another object of the present invention is location of a mobile communication device carried, hauled or transported by a thing or object, e.g., plane, train, ship, auto, bicycle, motorcycle, truck, or other vehicle, or a container carried or held by such vehicle.

Still another object of the present invention is to target messages to a device based on a user's place of residence such as the district, city, county, state, country or other jurisdiction. The capability to target messages to a device based on the user's place of residence is advantageous for political campaigning where a user is only eligible to vote at his or her place of residence. Targeting the political message to residents of the jurisdiction improves efficiency in the campaign process.

Still another object of the present invention is to target messages to users of devices on the basis of one or more variables such as current location, velocity, time of day, ETA and other geographic or temporal variables, or a combination of such variables. The capability to target messages to a device based on geographic, temporal, and other variables is advantageous for marketing, advertising, promotions and sales in various industries including but not limited to real estate, retail stores and shops, restaurants and eating establishments, bars and clubs, hotels or motels, casinos, malls or shopping centers, and so on.

Still yet another object of the invention is the optimization of the method of delivery of targeted message in accordance with the functionality of mobile device. Lookup the device identification number or the telephone number to recall the functionality of mobile device and determine optimal method of delivery for the particular message, e.g. audio only through speaker(s), video through display(s), audio-visual through both speaker(s) and the display(s), or simply be a text message, and so on.

Still yet another object of the invention is the narrowcast and/or near field communication of information to the user of a device to improve efficiency of information distribution such as that information distributed in the real estate industry to prospective buyers, tenants, and so on. One reason that the present invention is useful for promotion of real property is that the cost of targeted promotions is small relative to the cost of nearly any parcel of real property. Another reason that the present invention is useful for promotion of real property is that the cost of promotion is generally much less than existing forms of promotion used in relation to real property such as listings, showings, classified advertisements, print advertisements, videos, media spots, and so on, with the possible exception of flyers and temporary signs. Yet, flyers and signs have drawbacks in that a flyer requires a prospective buyer to exit a vehicle, may run out of supply, requires re-filling, and consumes paper, and similarly, a sign may not be seen by a prospective buyer, even from a short distance away, and thus, often requires additional signs to aid to prospective buyers. In comparison, the cost of distributing digital information is inexpensive, requires less time and effort, does not require re-filling, extra signs, and so on, and the cost of digital promotion may be considerably less than traditional forms of promotion used in relation to real property.

Still yet another object of the invention is to improve efficiency of information distribution such as that information distributed to prospective buyers about garage or yard sales, swap meets, and so on. Organizers of such events generally must utilize classified advertisement or prepare and display extra signs at a distance from the event. In comparison, distributing digital information is inexpensive, requires less time and effort, does not require extra signs.

Still yet another object of the invention is for advertising and promotion of manufacturers and vendors of any goods and services that are targeted to a specific geographic location(s) such as southern locations, northern locations, state specific, MSA specific, community specific, resort destination(s), rather than targeted to other users such as specific demographic, e.g. persons 25-40 years of age.

Still yet another object of the invention is integration of targeted messages including but not limited to campaigning, promotion and/or sales within a mobile communications device to add to the value of the device without detracting from the value of device as a communications tool. Although a message may be displayed on the device prior to making a connection to a network for purposes of communication, display of a message prior to making a connection may delay, and thus, detract from the value of the device as a communications tool. Yet, a message may also be displayed of the device without detracting from its value by being displayed when the user is dialing a telephone number and/or after termination of a communication. For example, if the message is a sound bite, it would fit in during dialing. A longer message could be paused during a communication and resume when the communication is terminated.

Still yet another object of the invention is to enable law enforcement officer(s) to safely and accurately identify themselves to the public, especially when making a traffic stop. Officers need the ability to identify themselves prior to approaching the stopped vehicle. When the officer signals to the driver of a vehicle to pull over by turning on flashing lights, an RFID tag or other device capable of narrowcast can simultaneously inform the user of any nearby device, e.g. driver or passenger, of the name and badge number of the officer(s). One reason the invention is useful for the identification of officers is that the incidence of crimes involving the impersonation of officers is increasing.

Still yet another object of the invention is broadcast emergency alerts to devices. For example, when an alert is officially issued such as a flash flood or tornado warning, the alert can be broadcast to all mobile devices, not just a limited number of predetermined pagers in the possession of emergency response personnel. In this way, users of mobile devices would receive the alert of possible flood or tornado. In another example, when an alert is officially issued for a kidnapped child (aka “Amber Alert”), the alert can broadcast to all mobile devices. In this way, all users of devices can be on the lookout for the kidnapped child.

Still another object of the invention is to send an emergency signal including GPS coordinates and description of the emergency to other electronic devices for relay to authorities for assistance. The other electronic devices could include other mobile phones operating on different cellular networks, other mobile devices, stationary radio stations, repeater stations, or a mesh of devices, and so on.

Still yet another object of the invention is peer-to-peer (P2P) communications of information, and in particular, forwarding of messages to others with or without comment or revision and communicating of geographical variables and information relating to current location and destinations. Such peer-to-peer communications may be transmitted directly between devices or be relayed through network(s) such as a cellular network, WIFI network, or the internet, and so on. Senders and recipients of P2P communications may or may not be members of a pre-defined group. A user of the device may be allowed to opt-in or opt-out of such P2P communications.

Still yet another object of the invention is group communications, and in particular, forwarding of messages to others with or without comment or revision and communicating of geographical variables and information relating to current location and destination(s). Senders and recipients of group communications would typically be members of a pre-defined group having two or more members. Similar to a listserv for email, a user of the device may be allowed to opt-in or opt-out of the group for sending or receiving group communications.

Still yet another object of the invention is manage the information about a user of a mobile device such as the user's personal and favorite destinations as well as other personal information e.g. appointments, contacts, and so on.

Still yet another object of the invention is analyze and report information about individual users, defined groups of users, or a multitude of users of mobile devices relating to destinations and other base metrics, e.g. popular or repeat destinations, and optionally filtering destinations by market segments and other important parameters such as calendar date, time of day, day of week, month of year, as well as demographic variables such as age, income, education, and so on, and personal preferences such as visiting destination close to work, visiting destination close to home. A panel of mobile users can be selected representing a cross-section of the population or a specific target demographic, e.g. tweens, teenagers, 18-25 year-olds, baby boomers, etc. in order to learn various base and derived metrics including which destinations users visit, how long they visit each destination, which destinations are popular with which each group of users, frequency of repeat visits, and other important information.

### BRIEF DESCRIPTION OF THE DRAWINGS

FIG. 1 is a diagram of multiple processes to generate webpage(s) intended for devices having a full size screen and multiple mobile devices having a miniature size screen.

FIG. 2 is a diagram of a process to create webpage(s) intended for devices having a full size screen and a subsequent process to reformat such webpage(s) for mobile devices having a miniature size screen.

FIG. 3 is a diagram of a process to mobilize or convert webpage(s) intended for devices having a full size screen to both devices having a full size screen and mobile devices having a miniature size screen.

FIG. 4 is a diagram of an alternative process to mobilize or convert webpage(s) intended for devices having a full size screen to both devices having a full size screen and mobile devices having a miniature size screen.

FIG. 5 is a flowchart of execution of the mobilizer software module using an interpreter of the source code.

FIG. 6 is a flowchart of the execution of a mobilizer software module using executable code after compiling the source code.

FIG. 7 is a flowchart of the steps of execution of the mobilizer software module.

FIG. 8 is an alternate flowchart of the steps of execution of the mobilizer software module.

FIGS. 9A and 9B are alternate flowcharts of a mobilizer software module running on-board a mobile device or a remote server, respectively.

FIG. 10 is a front view of a mobile device showing a selection matrix on its display and a magnified view of the display.

FIGS. 11A and 11B are schematic drawings of alternative circuits of mobile devices.

FIGS. 12A, 12B, and 12C are schematic drawings of alternative circuits of other electronic devices including stationary electronic devices.

FIGS. 13A through 13D are perspective drawings of alternative mobile devices.

FIG. 13E is a perspective drawing of a stationary electronic device.

FIGS. 14A, 14B and 14C are schematic drawings of alternative networks for mobile devices.

FIGS. 14D and 14E are schematic drawings of alternative networks for other electronic devices.

FIG. 15 is a flowchart of alternative processes for distributing (aka pushing) messages, serving information, collecting information, and analyzing and reporting information.

FIG. 16A is a flowchart of the front end portion of the process for distributing (aka pushing) messages.

FIG. 16B is a flowchart of the front end portion of the process for serving information.

FIG. 16C is a flowchart of the front end portion of the process for collecting information.

FIG. 16D is a flowchart of the front end portion of the process for managing information.

FIG. 16E is a flowchart of the process for analyzing and reporting information.

FIGS. 17A and 17B are flowcharts of the back end processes for pushing, serving, collecting, and managing information.

FIG. 17C is a flowchart of the back end process analyzing and reporting information.

FIGS. 18A through 18E are flowcharts of general subprocesses of the alternatives processes.

FIGS. 19A through 19D are flowcharts of specific subprocesses for clustering of destinations.

FIGS. 20A through 20C are a series of flowcharts of alternative combinations of algorithms in series, parallel and hybrid combinations.

FIGS. 21 and 22 are flowcharts of alternative algorithms for determining if current location is a destination.

FIGS. 23 through 33 are flowcharts of alternative algorithms for prediction of alacrity.

FIGS. 34 through 36 are flowcharts of alternative algorithms for prediction of jurisdiction, territory or other boundary.

FIGS. 37A through 37C is a series of drawings of alternative signs showing the prior art.

FIGS. 38A through 38C is a series of drawings of alternative signs showing the method and system of the invention.

### DETAILED DESCRIPTION OF THE INVENTION

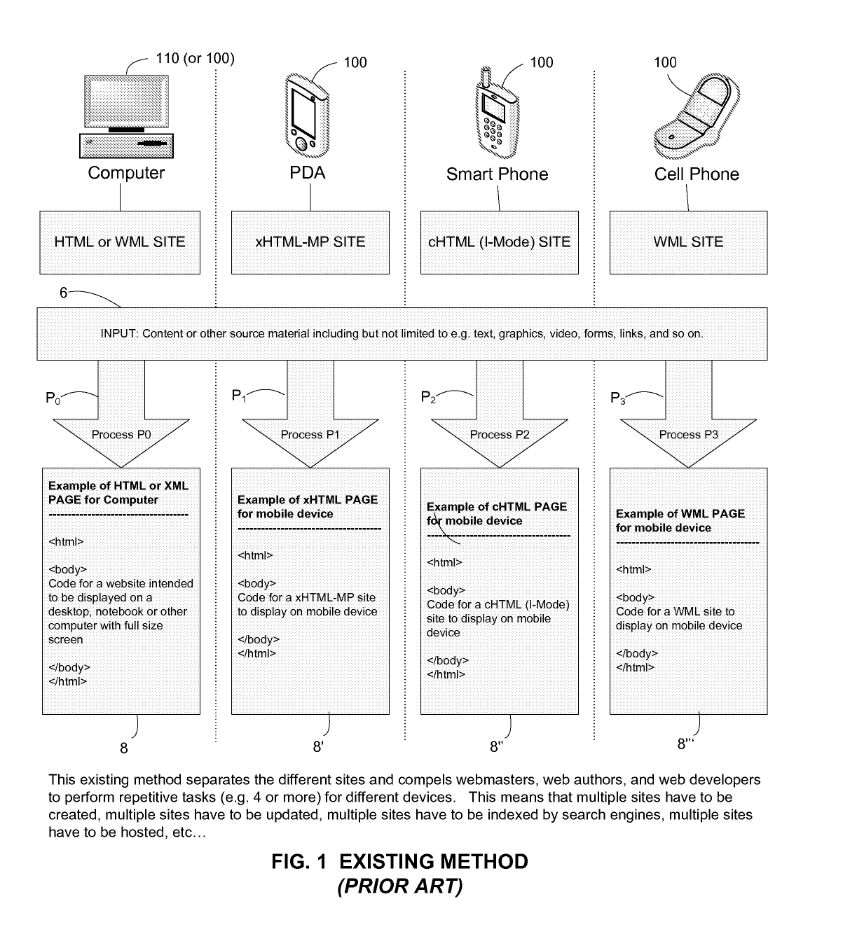

With reference to FIGS. 1 through 4, 9A, 9B, 10, 11A, 11B, 12A through 12C, 13A through 13E, and 14A through 14E, a mobile electronic device is depicted by numeral 100 and any other electronic device is depicted by numeral 110. The mobile device 100 may include any electronic device including a mobile phone, a PDA, a hybrid PDA and phone, a mobile computer such as a laptop, notebook, tablet, and so on, as the term “device” is defined herein. The other electronic device 110 may be a desktop, workstation, mainframe, server, control unit for a building automation system, control unit for a telecommunication system, or other immobile electronic device.

With reference to FIGS. 1 through 10, the mobilizer module is denoted by numeral 2, the mobile module library by numeral 4, the input by number 6, and output denotes by numeral 8 (or 8′,8″,8′″). The mobile device 100 has an input device 40 (or 40a, 40b, 40c) and a display 30 that is a miniature size screen such as a mobile phone, a PDA, a smart phone, a hybrid PDA and phone, and so on.

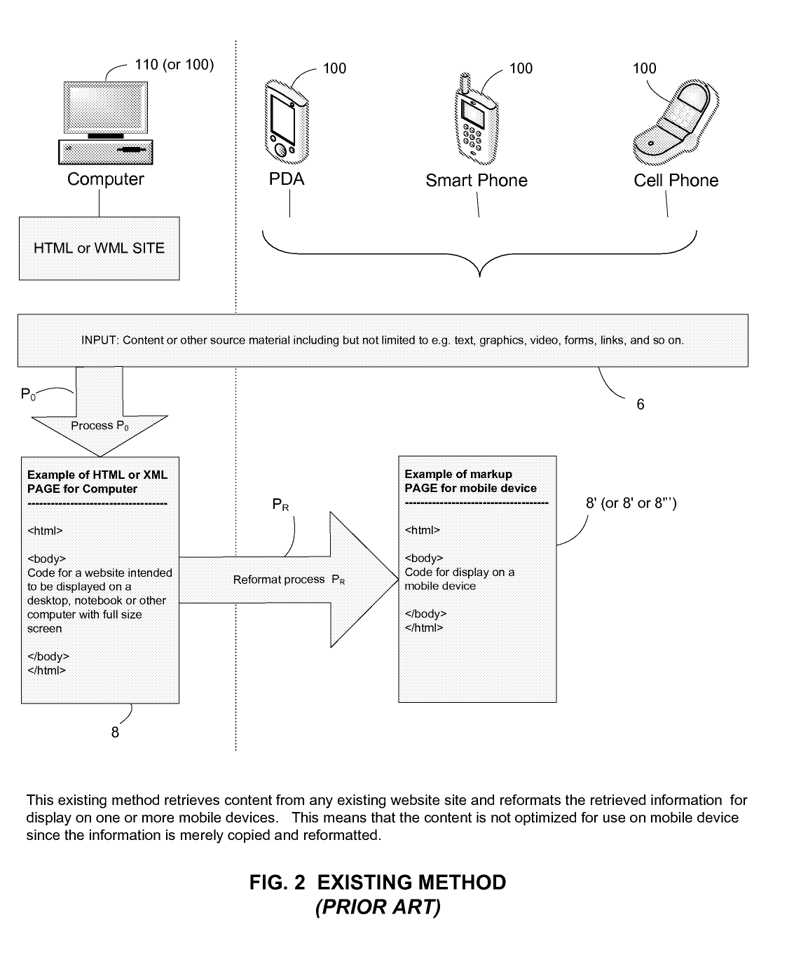

With reference to FIGS. 1 through 2, these existing methods represent the prior art. In FIG. 1, multiple processes are used for each kind of device: P₀, P₁, P₂, P₃, . . . , P_{N} where P₀ is the process for devices with full size screens and processes P₁, P₂, P₃, . . . , P_{N} are for various kinds of mobile devices. This existing method separates the different sites and compels webmasters, web authors, and web developers to perform repetitive tasks (e.g. 4 or more) for different devices. This means that multiple sites have to be created, multiple sites have to be updated, multiple sites have to be indexed by search engines, multiple sites have to be hosted, etc.

In FIG. 2, the process P₀ is first used for devices with full size screens followed by process P_{R} for devices with miniature size screens. Process P_{R} involves reformatting of existing webpages to fit on miniature size screens but does not remove or supplement the content of the existing webpages. This existing method retrieves content from any existing website site and reformats the retrieved information for display on one or more mobile devices. This means that the content is not optimized for use on mobile device since the information is merely copied and reformatted.

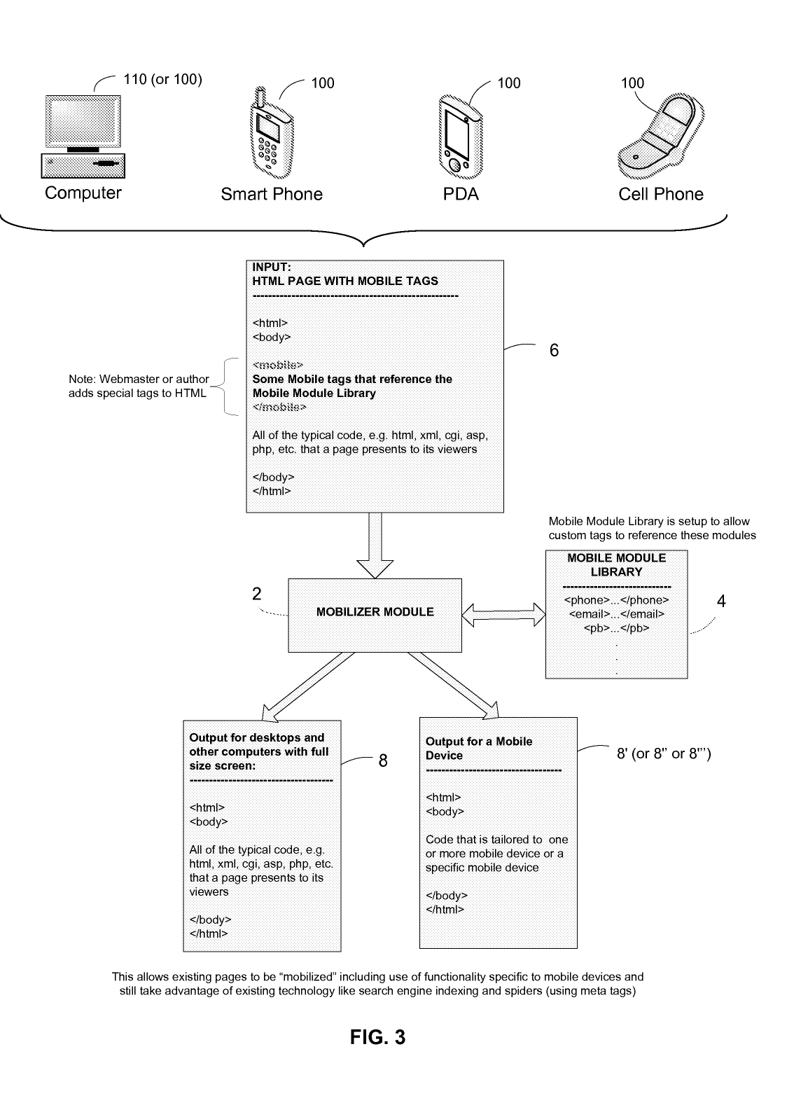

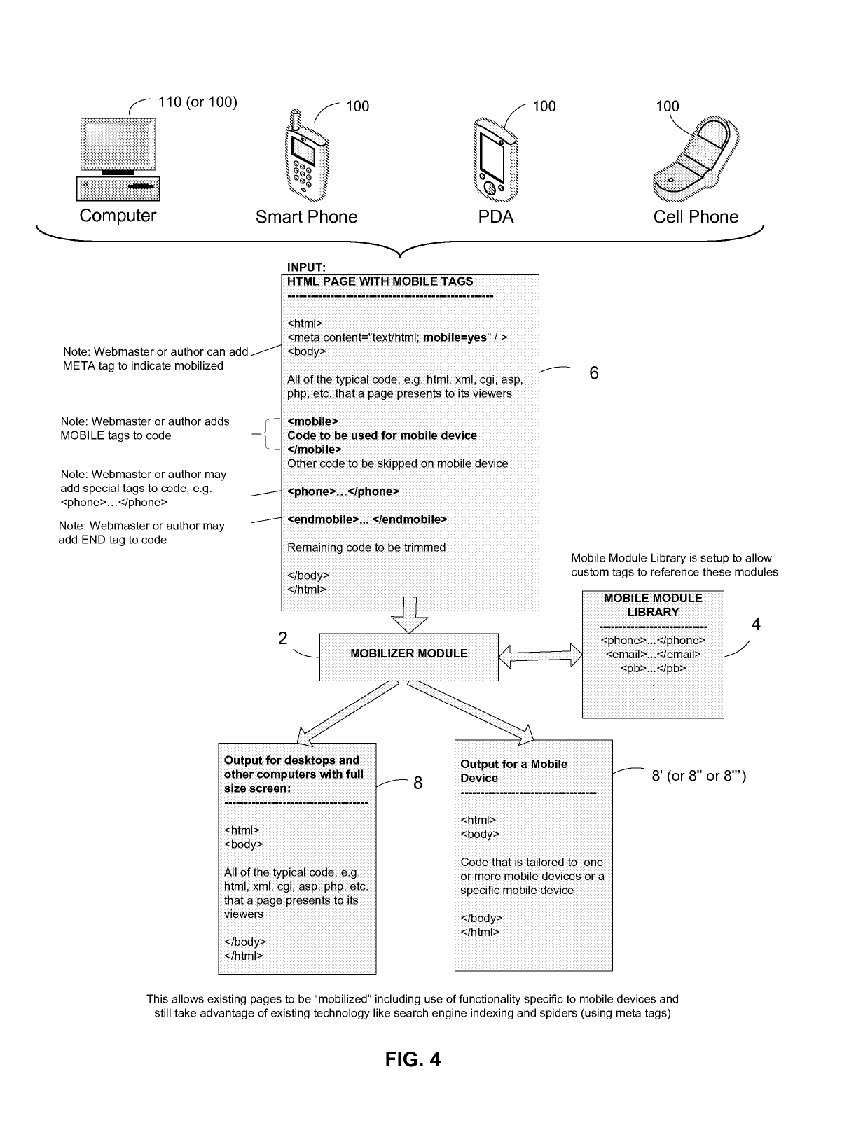

With reference to FIGS. 3 and 4, a webmaster or web author, or web developer adds special tags to the code, e.g. HTML. The special tags may be any tags or code that is recognized by the mobilizer module 2. For example, the special tags may be <mobile> . . . </mobile>, <gomobile> . . . </gomobile>, <mobilize> . . . </mobilize>, and so on. The “ . . . ” between these tags represents content to be display on the mobile device and tags or codes that reference or make calls to the mobile module library 4 which is setup to allow special tags to reference these modules. In FIG. 3, the mobilizer module receives input 6 and generates output 8 (or 8′, 8″, 8′″), where output 8 is for a device with a full size screen and 8′, 8″, or 8′″ are for various devices with miniature size screens. In one embodiment, the entire page is served to desktop or notebook browsers, while only certain parts of the page are served to mobile devices, and thus, for browsers for full size screens output 8 is equivalent to input 6 while for browsers for miniature size screen output 8′, 8″, or 8′″ the webpage is replaced with one or more modules from the mobilizer module library 4 that are compatible with the kind of device that is requesting the page. In another embodiment, the special tags in input 6 are stripped by the mobilizer module 2 when it generates output 8. The entire page is served to desktop browsers, while only certain parts of the page are served to mobile devices

In FIG. 4, the mobilizer module also receives input 6 and generates output 8 (or 8′, 8″, 8′″), where output 8 is for a device with a full size screen and 8′, 8″, or 8′″ are for various devices with miniature size screens. The

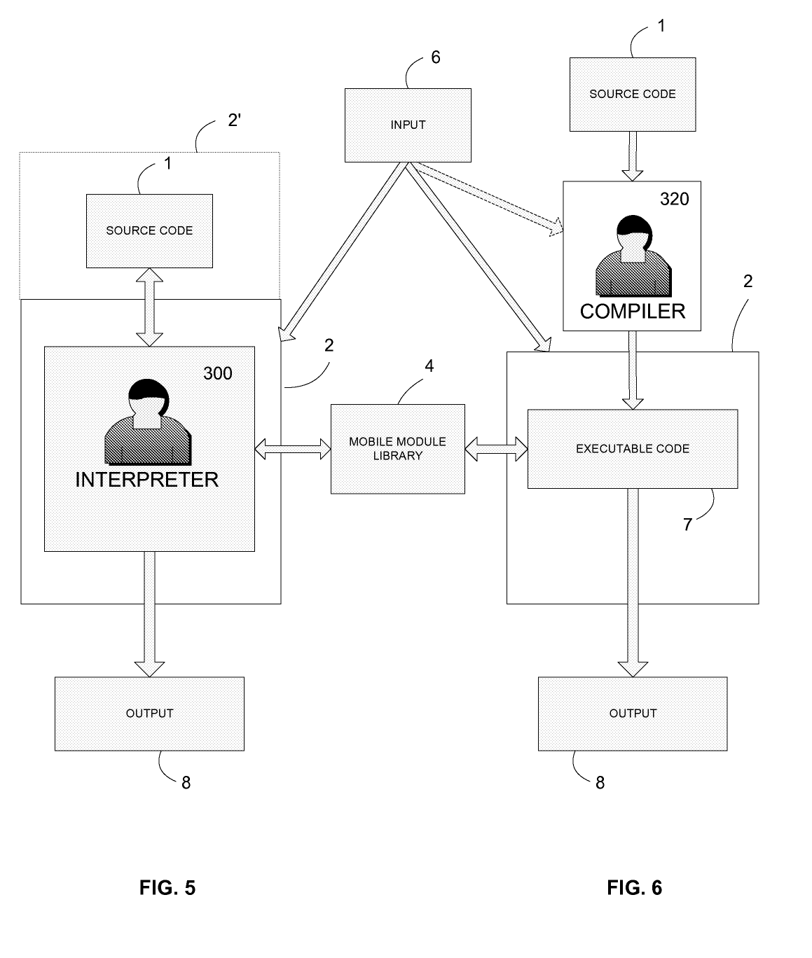

In FIG. 5, the source code of the mobilizer software module 2 is executed using an interpreter. In one embodiment, the source code is contained within the mobilizer module 2. In another embodiment, the source code is contained external the mobilizer module 2′. In FIG. 6, the source code of the mobilizer software module 2 is first compiled for the device 100 or the server 200 afterwhich the mobilizer module is executed using executable code. In either case, the mobilizer module generates output 8 (or 8′, 8″, 8′″).

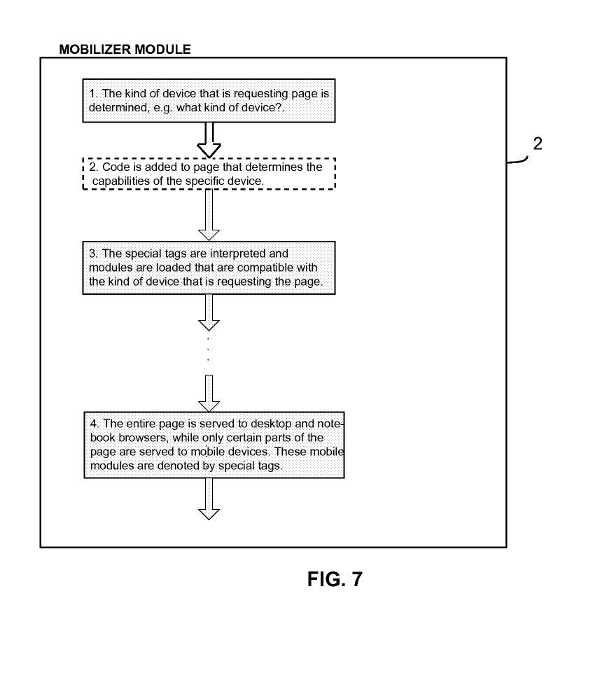

In FIG. 7, the steps of a method of execution of the mobilizer software module 2 are shown. The steps include determining what kind of device 100 or 110, and depending on the kind of device, either interpreting special tags, loading modules compatible with the kind of device, and serving a mobilized page as output 8′, 8″, or 8′″ to the device 100, or serving output 8 to the device 110. The method includes an optional step of adding code to determine the functionality of the specific device 100.

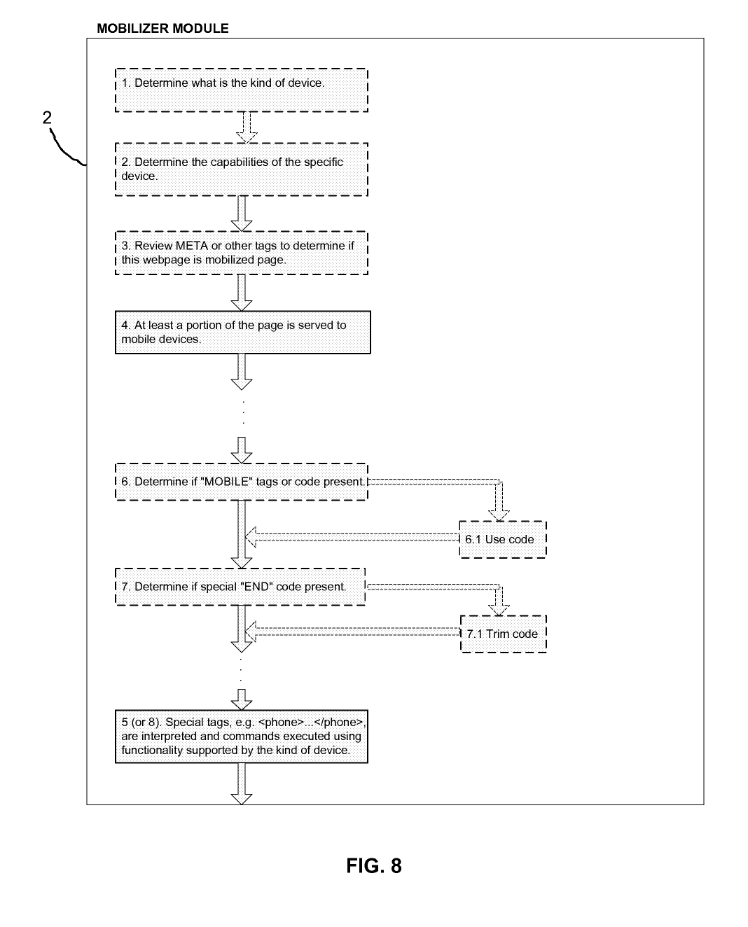

In FIG. 8, the steps of an alternate method of execution of the mobilizer software module 2 are shown. The steps include serving a portion of webpage to mobile devices and interpreting special tags and executing commands using functionality supported by the kind of device. In one embodiment, a special tag is <phone> . . . </phone> that makes a telephone call. In another embodiment, a special tag is <sms> . . . </sms> that creates and sends a SMS message. In another embodiment, a special tag is <email> . . . </email> that creates and sends an email or IM. In still another embodiment, a special tag is <pb> . . . </pb> that opens the phone book onboard the device 100 or a remote server 200. The method includes an optional preliminary steps of determining what kind of device 100 or 110, and depending on the kind of device, determining the capabilities of the device, reviewing META or other tags to determine if this webpage is a mobilized page, determining if special MOBILE tags, e.g. <mobile> . . . </mobile> are present, and determining if special END tag, e.g. <endmobile> . . . </endmobile> is present. In one embodiment, if special MOBILE tags are present, then mobilizer module 2 uses the code between the tags. In another embodiment, if special MOBILE tags are present, then mobilizer module 2 uses the code between the special tags and skips code outside the special tags. In still another embodiment, if special END tag is present, then mobilizer module 2 trims the code at the location of the tag. In yet still another embodiment, if the META tag, e.g. <meta content=“text/html; mobile=yes”/> includes an affirmative indication that the page is mobilized, then mobilizer module 2 can take pre-determined action such as reducing the length of content displayed to avoid or limit excessive scrolling, re-arranging the content displayed on the device, downsampling the images displayed on the device, and adding a selection matrix comprising one or more items to the display 30 of the device 100, or taking other action(s) to enhance usability. Such a selection matrix may include one, two, three or four graphical objects in a single row, or the selection matrix may have various graphical objects in multiple rows and columns, e.g. 2 rows by 2 columns, 2 rows by 3 columns, . . . 2 rows by M columns, or 3 rows by 1 column, 3 rows by 2 columns, 3 rows by 3 columns, . . . , and so on to N rows by M columns. In some embodiments, the graphical objects are images, pictures, iconographics, and/or symbols.

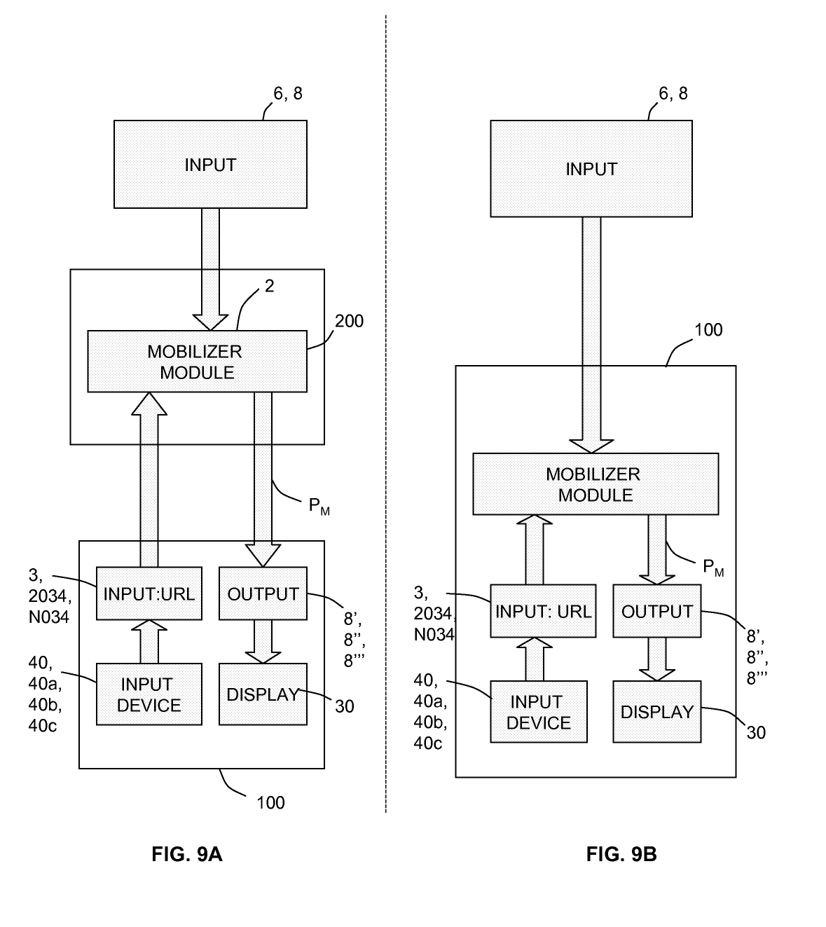

In FIGS. 9A and 9B, the mobilizer software module 2 first receives input 3, (or 2034 or N034) in the form of a URL, and then using the URL, retrieves input 6 in the form of webpage(s) from the webserver identified by the URL. The input 3 may be input by various input devices 40 (or 40a, 40b, 40c), or be an active link in existing document such as another webpage. The output 8′, 8″, or 8′″ is displayed on the display 30 of the mobile device 100. In FIG. 9A, the mobilizer software module is located on a remote server 200. In FIG. 9B, the mobilizer software module is located onboard the mobile device 100.

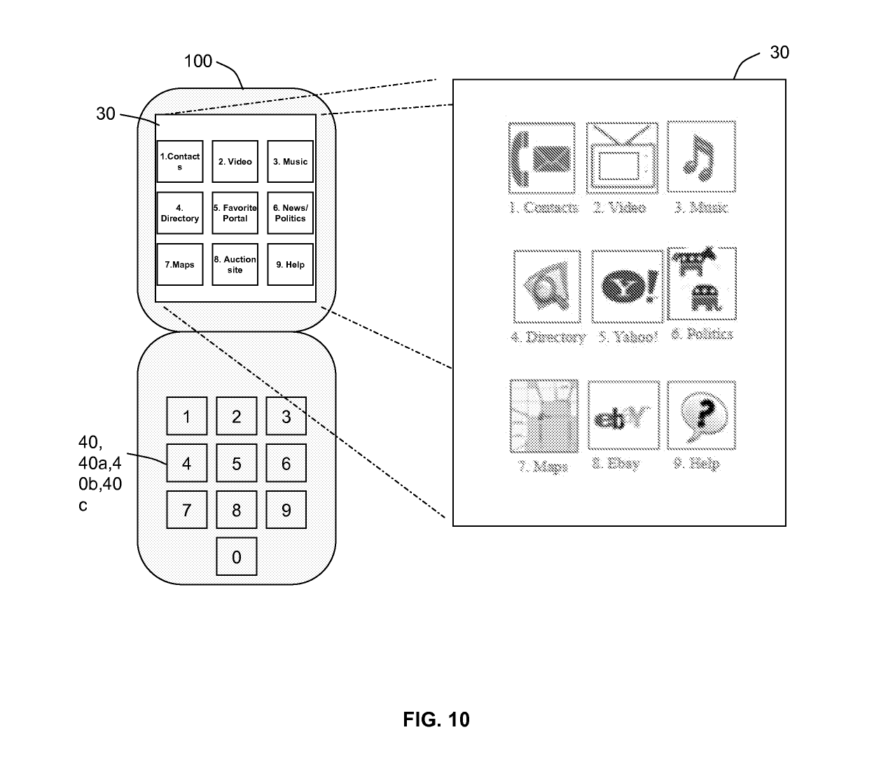

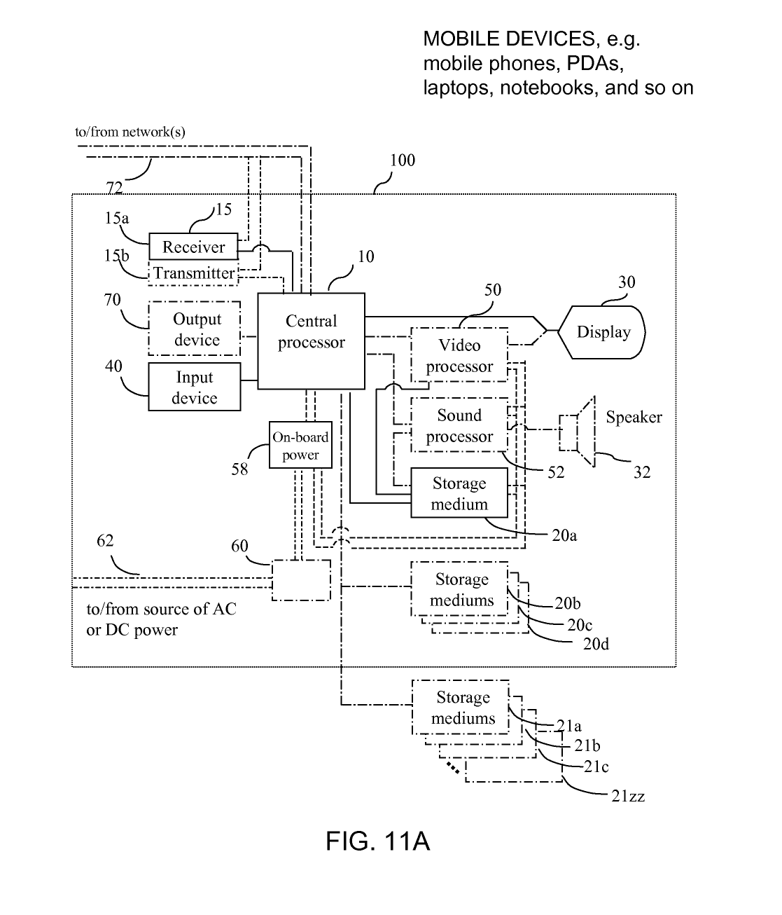

In FIG. 10, a mobile device 100 has a display 30 showing a selection matrix. The selection matrix may include one, two, three or four graphical objects in a single row, or the selection matrix may have various graphical objects in multiple rows and columns, e.g. 2 rows by 2 columns, 2 rows by 3 columns, . . . , 2 rows by M columns, or 3 rows by 1 column, 3 rows by 2 columns, 3 rows by 3 columns, . . . , and so on to N rows by M columns. In some embodiments, the graphical objects are images, pictures, iconographics, and/or symbols. In one embodiment, the webpage is designed to have graphical objects arranged in a matrix of columns and rows corresponding to number keys on the keypad. In this way, a user could select up to 9 pre-defined functions, links, or other commands by pressing corresponding keys “1” to “9” and could select even more commands by pressing “0” to toggle between sets of pre-defined functions similar to the SHIFT or ALT keys on the standard computer keyboard. In the preferred embodiment, when a user presses a key, the pre-defined function is initiated with the single key stroke rather than multiple keystrokes. In one embodiment, the key “1” is pre-defined to open the user's contact list, key “2” opens a video play list, key “3” opens a music play list, . . . key “8” goes to an auction site, key “9” opens help, and so on. Thus, the matrix can act as the user's mobile “launchpad”. In another embodiment, the user may customize the selection matrix. In still another embodiment, the selection matrix includes a feature product, service, website as an item in the selection matrix, or make a promotional message in a message display area 500. In still yet another embodiment, the selection matrix is adaptive and opens, e.g. a list of most recent activities, or most recent URLS, and so on.

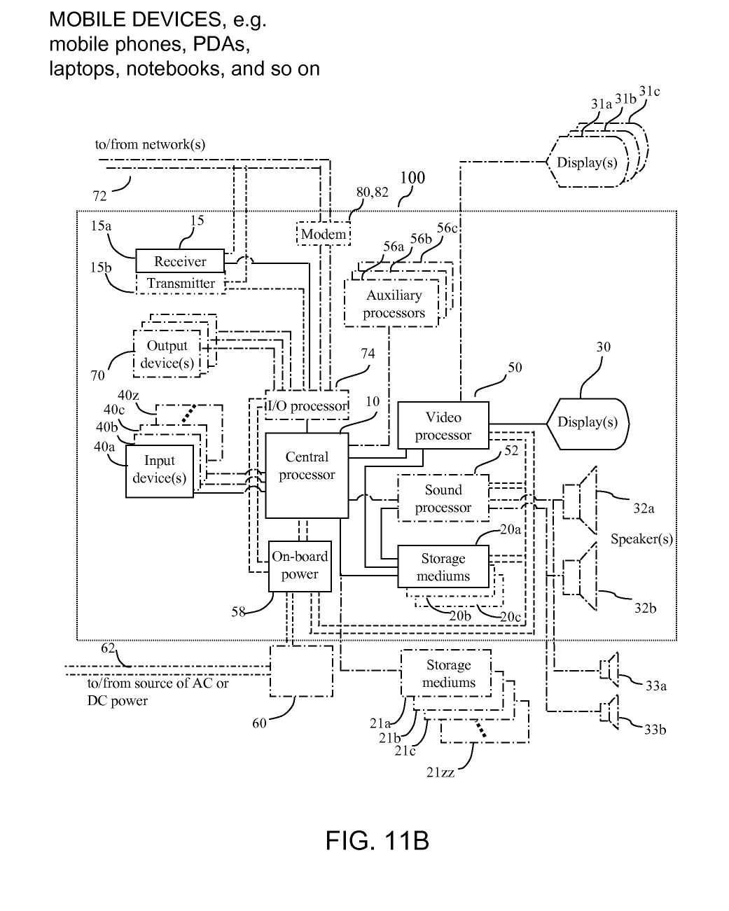

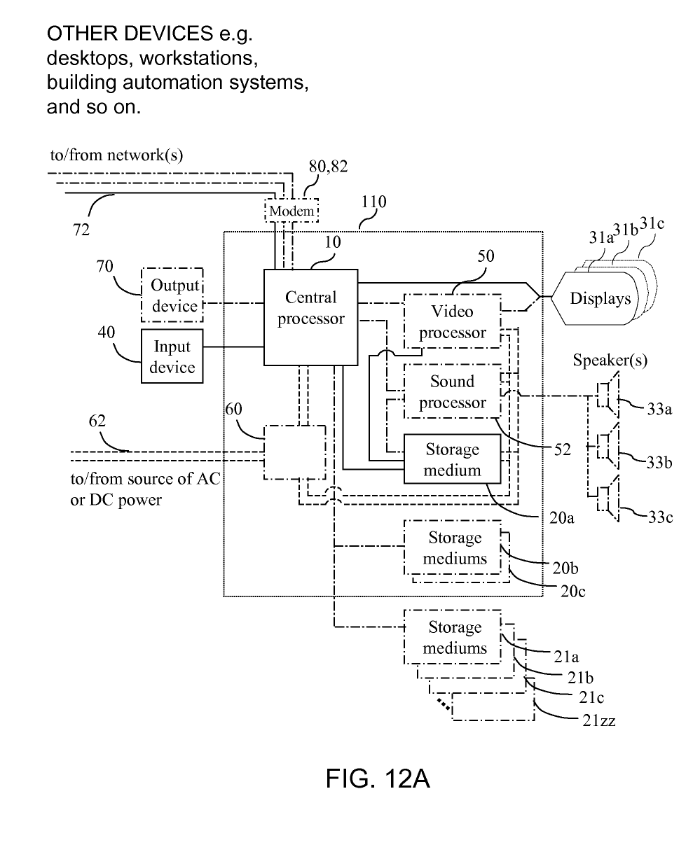

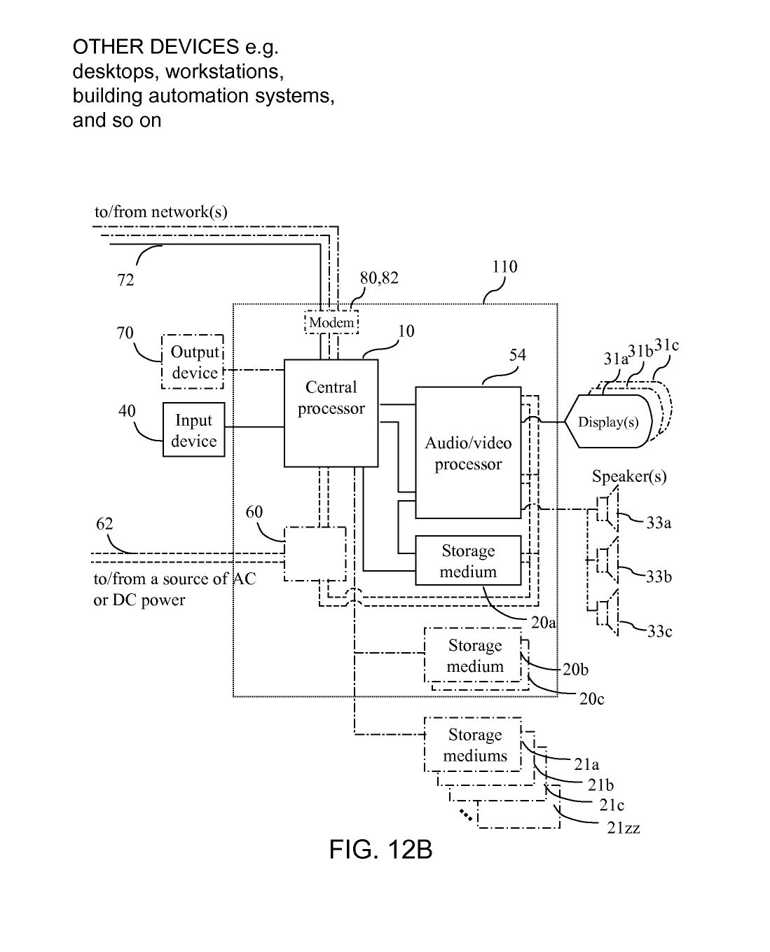

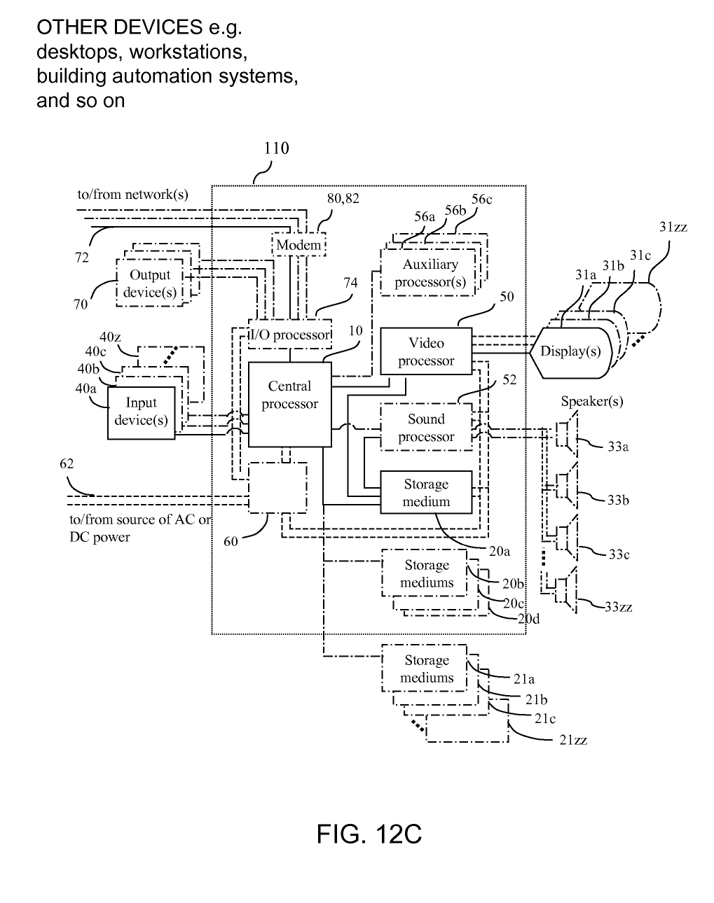

With reference to FIGS. 11A, 11B, and 12A through 12C, the perimeter of the device is shown by dotted lines, electric power (or bus) lines are shown by dashed lines, and alternative components and devices are shown by phantom (or dot-dash) lines.

FIGS. 11A and 11B are schematic drawings of alternative circuits of a mobile device 100 having a central processor 10 in communication with at least one storage medium 20a. In one embodiment of the invention, the circuit comprises the central processor 10, the storage medium 20a, at least one display 30, and at least one on-board power source 58. For example, the display can be any type of display including a flat panel display such as LED, LCD, TFT, plasma, and so on, or a combination of these including a backlit display. For example, the on-board power source may be a battery, a fuel cell, a photovoltaic cell, and so on. In another embodiment, the central processor is in communication with a receiver 15a and at least one speaker 32, and in another embodiment, the central processor is in communication with a transmitter 15b. In still another embodiment, the circuit comprises a sound processor 52 in communication with the central processor and the speaker 32. In one embodiment, the central processor 10 is in communication with a wireless cellular network of the type operated by Verison or AT&T through the receiver 15a and the transmitter 15b. In still another embodiment, the central processor is in communication with the receiver/transmitter 15 which comprises a receiver 15a and/or transmitter 15b. In still another embodiment, the device comprises at least one input device 40. In yet still another embodiment, the circuit also comprises a video processor 50 in communication with the central processor and the display. In a further embodiment, the circuit also comprises one or more additional storage mediums in communication with the central processor where the additional storage mediums may be internal storage mediums 20b, 20c, and 20d and/or external storage mediums 21a, 21b, 21c . . . 21zz. The second storage medium may be flash memory or any type of external device capable of storing data including but not limited to a memory stick, CF card, a SD card, a jump drive, and so on. In still another embodiment, the circuit also comprises an output device 70 in communication with the central processor. In still another embodiment, the central processor is in communication with a server 200 at a remote location whereby information is transmitted to and from the remote location. In yet still other embodiments, the device 100 has additional displays 31a, 31b, and 31c and/or additional speakers 33a and 33b. In still yet another embodiment, in addition to the onboard power source 58, the device 100 has a connection to an external power source 62, and as necessary, a transformer 60. The transformer may be a AC-to-DC converter, a step down transformer, or any type of transformer or adapter.

With reference to FIG. 11B, the circuit includes an input-output processor 74 which is in communication with the central processor 10. In another embodiment, the input-output processor 74 is in communication with a modem 80 and/or a wireless network adapter 82 which in turn is connected to a network 72. In still another embodiment, the modem 80 or network adapter 82 is an external component rather than an internal component. In still another embodiment, the device 100 includes additional input devices 40a . . . 40z such as alternative keys, touchpads, or touchscreens for data entry, a microphone, and/or digital camera. In yet still another embodiment, the device 100 includes auxiliary processor(s) 56a, 56b, and 56c in communication with the central processor 10.

FIGS. 12A, 12B and 12C are schematic drawings of alternative circuits of other electronic devices 110 including stationary electronic devices having a central processor 10 in communication with at least one storage medium 20a, and at least one input device 40, and at least one connection to an external power source 62. In one embodiment of the invention, the circuit comprises the central processor 10, the storage medium 20a, at least one display 30, and the input device 40. In another embodiment, the central processor is in communication with a network 72. In still another embodiment, the circuit includes at least one speaker 33a. In yet still another embodiment, the circuit also comprises multiple output devices 70, and/or network connections 72. In yet still another embodiment, a modem 80 and/or a wireless network adapter 82 is in communication with the central processor. In yet still other embodiments, the circuit also comprises multiple internal storage mediums 20a . . . 20c, external storage mediums 21a . . . 21zz, displays 31a . . . 31c, speakers 33a . . . 33c, input devices 40.

In FIGS. 12A, 12B & 12C, the central processor may be in communication with a network 72 and the device 110 has at least one input-output device 74. When in communication with the network 72, the input-output device 74 may be a network card of the type manufactured by Novell Communications of Provo Utah; a dial-up modem of the type manufactured by Hayes Corporation of Boston Mass.; or an alternative type of modem such as wireless, DSL, or cable modems. In the preferred embodiment, the I/O device 74 is a wireless modem because it has the capability to remain “always-on” similar to a mobile communications device.

With reference to FIG. 12B, the audio processor and video processor are a single audio-visual processor 54 which is in communication with the central processor 10 and/or one or more displays 31a . . . 31c and/or one or more speakers 33a . . . 33c. In another embodiment, the modem 80 and/or a wireless network adapter 82 is an internal component rather than an external component.

With reference to FIG. 12C, the circuit includes an input-output processor 74 which is in communication with the central processor 10. In another embodiment, the input-output processor is in communication with a modem 80 and/or a wireless network adapter 82 which in turn is connected to a network 72. In still another embodiment, the device 100 includes auxiliary processor(s) 56a, 56b, and 56c in communication with the central processor 10. In yet others embodiments, the circuit may include a series of displays 31a . . . 31zz, a series speakers 33a . . . 33zz, multiple input devices 40, and/or multiple output devices 70.

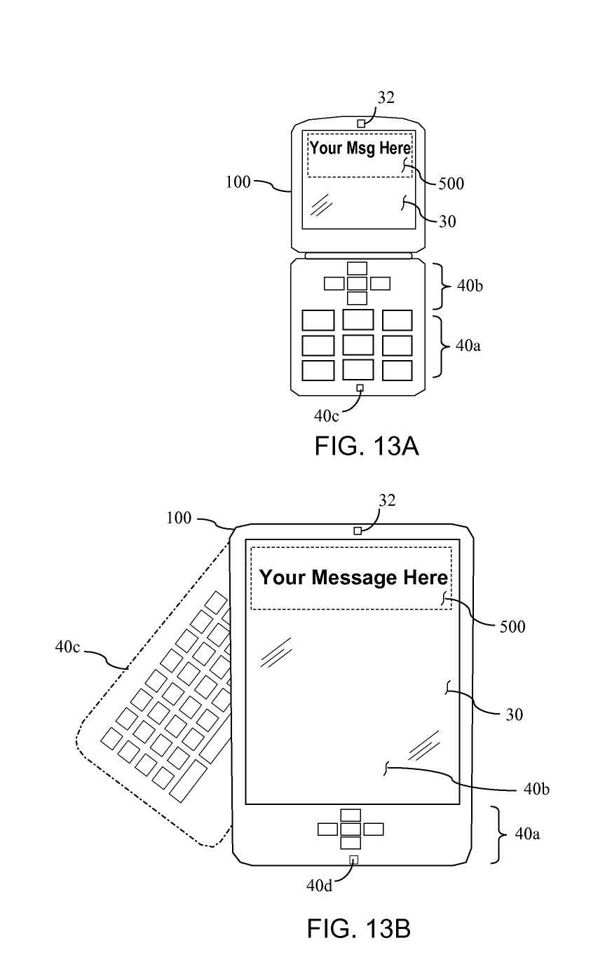

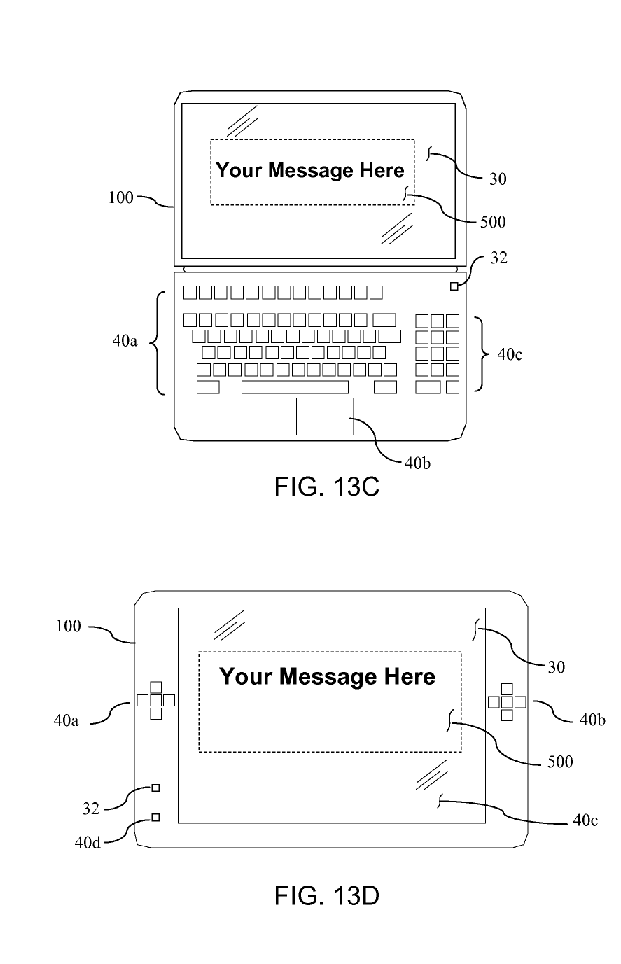

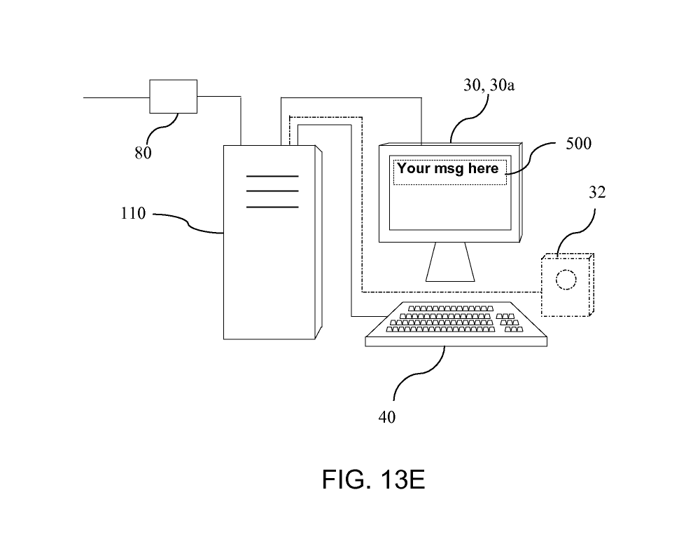

FIGS. 13A through 13D are perspective drawings of alternative mobile devices 100 having a display 30, a speaker 32, at least one input device 40, and at least one message display area 500. In one embodiment, the display 30 may be a flat panel display and the input device(s) 40 is may be one of several types including a number/letter keypad or navigation/execution keypad of the type manufactured by Samsung Electronics, a touchpad of the type manufactured by Toshiba. In FIGS. 13A and 13B, the message display area 500 is shown at or near the top of the display 30 but may be located elsewhere on the display 30 or may be enlarged to encompass the entire display 30 or shrunk to a smaller size. Similarly, in FIGS. 13C and 13D, the message display area 500 is shown at or near the center of the display 30 but may be located elsewhere on the display 30 or may be enlarged to encompass the entire display 30 or shrunk to a smaller size.

In FIG. 13A, the device 100 has three input devices 40a, 40b and 40c corresponding to a number/letter keypad, a navigation/execution keypad, and a microphone, respectively. In FIG. 13B, the device has four input devices 40a, 40b, 40c and 40d corresponding to a navigation/execution keypad, a touchscreen, a number/character keypad, and a microphone, respectively. In FIG. 13C, the device has three input devices 40a, 40b, and 40c corresponding to a character keypad, a touchpad, and a number keypad, respectively. In FIG. 13D, the device has four input devices 40a, 40b, 40c and 40d corresponding to a first navigation/execution keypad at the left, a second navigation/execution keypad at the right, a touchscreen, and a microphone, respectively.

FIG. 13E is a perspective drawing of a stationary electronic device having a display 30, a speaker 32, at least one input device 40, and at least one message display area 500. In FIG. 13E, the message display area 500 is shown at or near the top of the display 30 but may be located elsewhere on the display 30 or may be enlarged to encompass the entire display 30 or shrunk to a smaller size. In FIG. 13D, the device has one input device 40 corresponding a keyboard.

The circuit and is powered by either an internal power source 15 or by an external source 62 of direct current (DC) power or alternating current (AC) power. Where the source is internal, the power source 15 may be including but not limited to a battery, a fuel cell, photovoltaic cell, and so on. Where the source is AC power, a transformer 60 is in communication with the source 62. The transformer may be a board-mounted transformer of the magnetic type manufactured by Hammond Manufacturing of Cheektowaga, N.Y. or a stand-alone power adapter of the type manufactured by Motorola Corporation of Schaumburg, Ill.

In one embodiment the storage medium(s) 20a . . . 20d may be a hard drive of the type manufactured by Quantum Corp. of Milpitas, Calif., and in another embodiment, the storage medium may be a flash memory device of the type manufactured by Sandisk. Alternatively, the central processor receives instructions and/or data from the storage medium 20 and/or a second storage medium 22. The second storage medium 22 may be a DVD, CDROM, memory stick, CF card, SD card, jump drive, programmable read only memory (PROM), electronically-alterable programmable memory (EPROM), or the like. In another embodiment, the second storage medium 22 is an integrated circuit housed within a game box. In still another embodiment, the second storage medium is a CDROM which is removeably connected to the circuit.

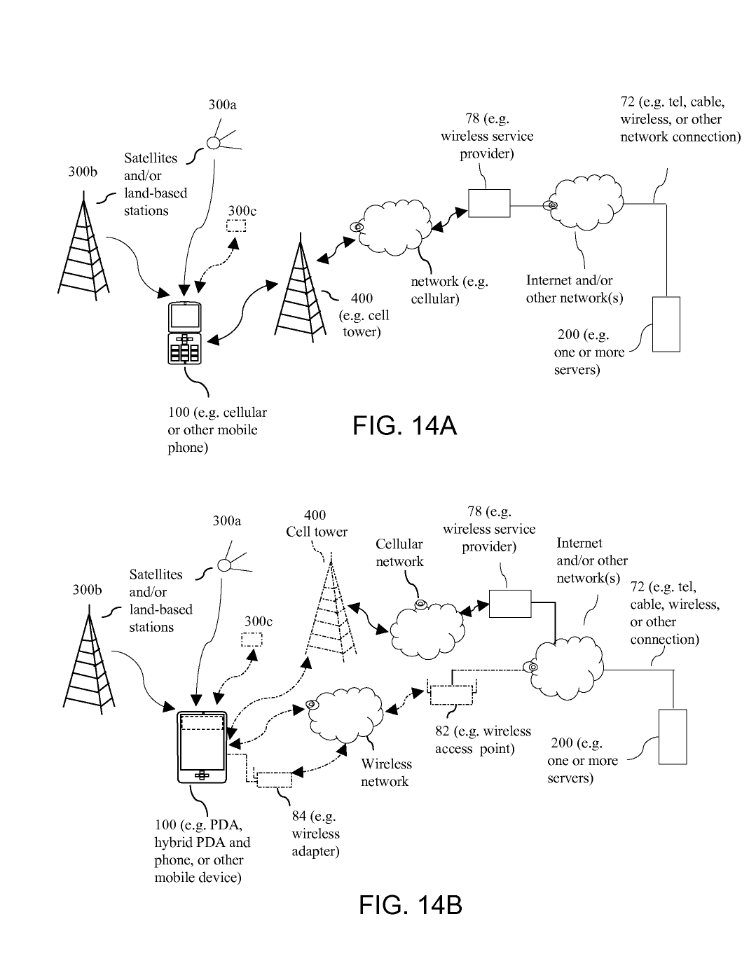

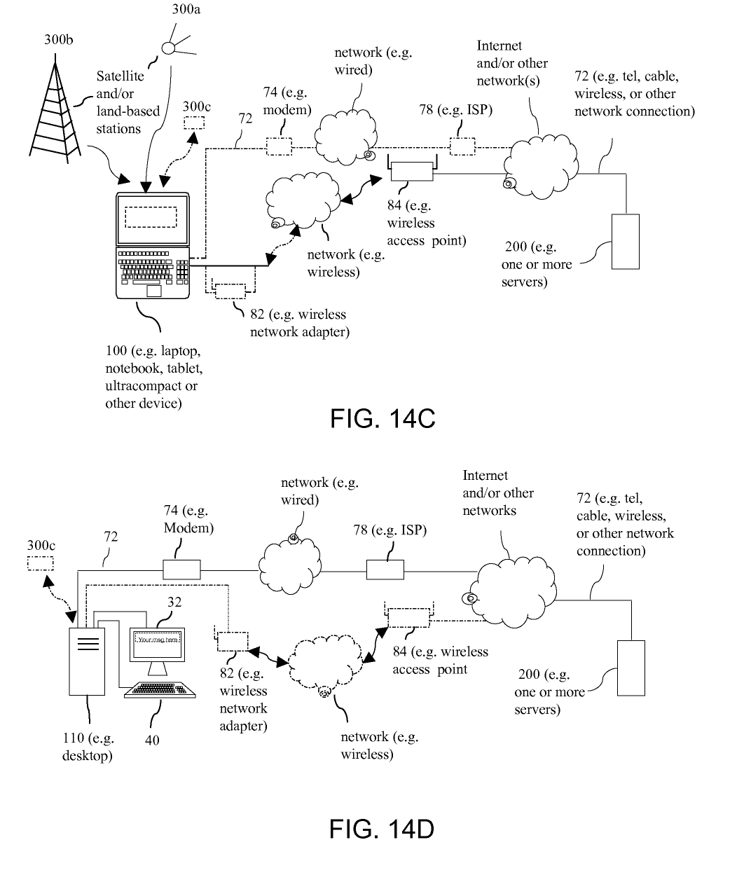

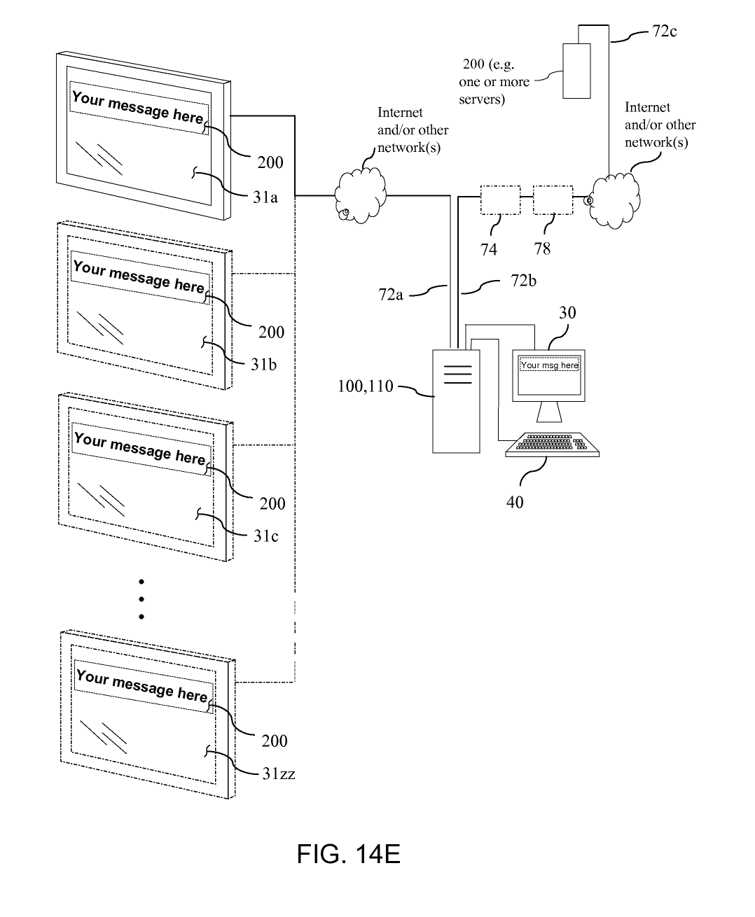

With reference to FIGS. 14A through 14E, a computer server is depicted by numeral 200. The computer server 200 may include any computer including a file server, a web server, and so on.

With reference to FIGS. 14A through 14E, satellite-based positioning station(s) is/are depicted by numeral 300a, land-based positioning station(s) are depicted by numeral 300b, and source(s) using narrow cast or near field communications are depicted by numeral 300c. The positioning station(s) 300a may be located in geo-stationary orbit, the positioning station(s) 300b may be located in any fixed position on a temporary or permanent basis, and source(s) 300c may be located anyplace or located on anything, whether mobile or non-mobile, on a temporary or permanent basis. For example, source(s) 300c may be RFID tags, NFC chips, or the like.

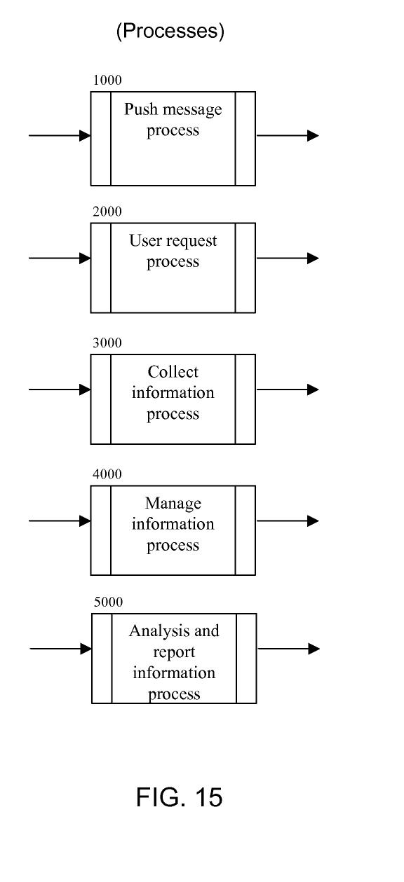

With reference to FIG. 15, the methods and systems of the invention include one or more processes including but not limited to a push message process 1000, a user request process 2000, a collect information process 3000, a manage information process 4000, and/or an analysis and report information process 5000. Each of these processes 1000, 2000, 3000, 4000, and 5000 may be initiated from the device 100 or 110, at the direction of the user or user's agent, or may be initiated from the server 200, at the direction of the system administrator, a computer operator, a customer, or a third party, or by an agent of any of these. Various embodiments of the invention may include one or more of these processes, running independently or in combination. For example, a process 1000 may be initiated in response to a customer order independent of other processes; a process 2000 may be initiated in response to a user request independent of other processes; and a process 3000 may by initiated each time a user activates a device independent of other processes. Another embodiment of the invention may include both a process 1000 and a process 2000. For example, in response a message distributed in a process 1000, a user may initiate a process 2000. Another embodiment may include both a process 1000 and a process 3000. For example, a process 1000 may depend on information collected in a process 3000 if a process 1000 targets messages based on user demographics, preferences, or purchases. Still another embodiment may include both a process 2000 and a process 4000. For example, at or near completion of a process 2000, the mobile device 100, device 110, or server 200 may initiate process 4000. Still yet another embodiment may include both process 3000 and process 5000. For example, at some time after completion of process 3000 for one or more users, server may initiate process 5000. Still other embodiments may include any combination of processes 1000, 2000, 3000, 4000 and/or 5000.

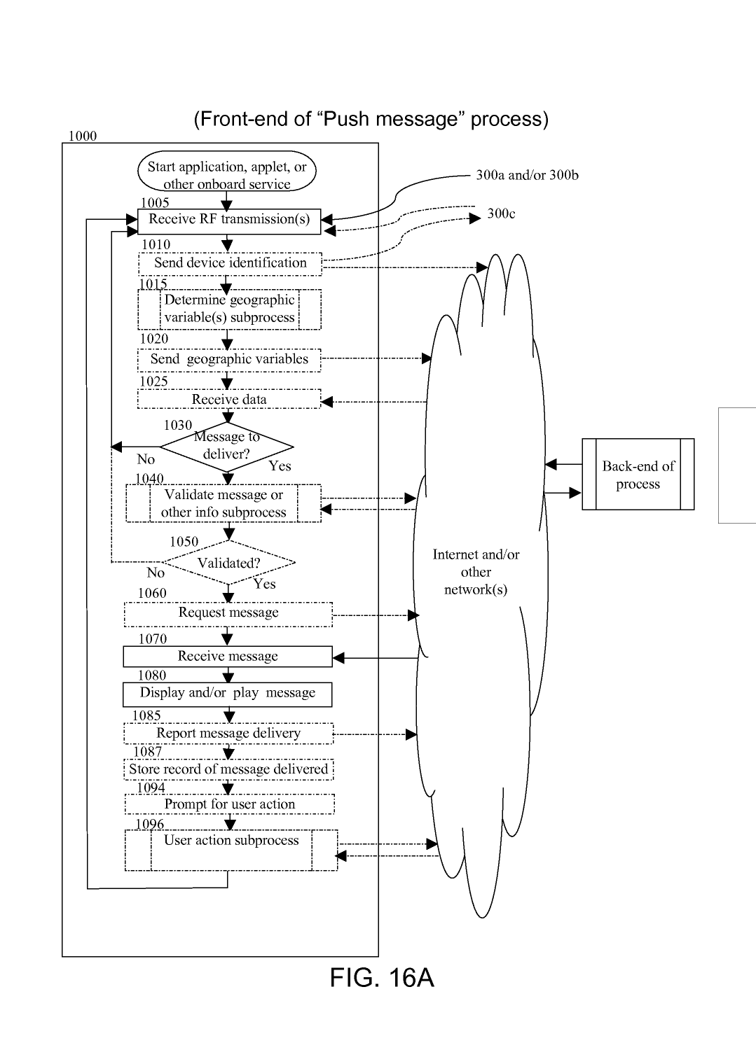

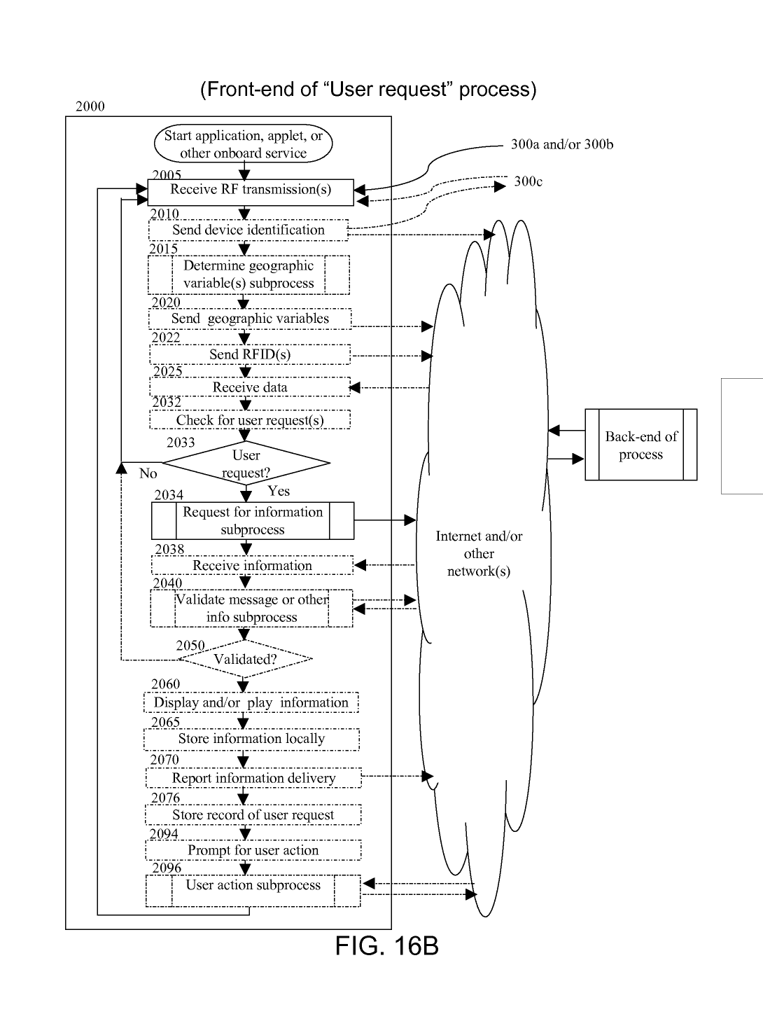

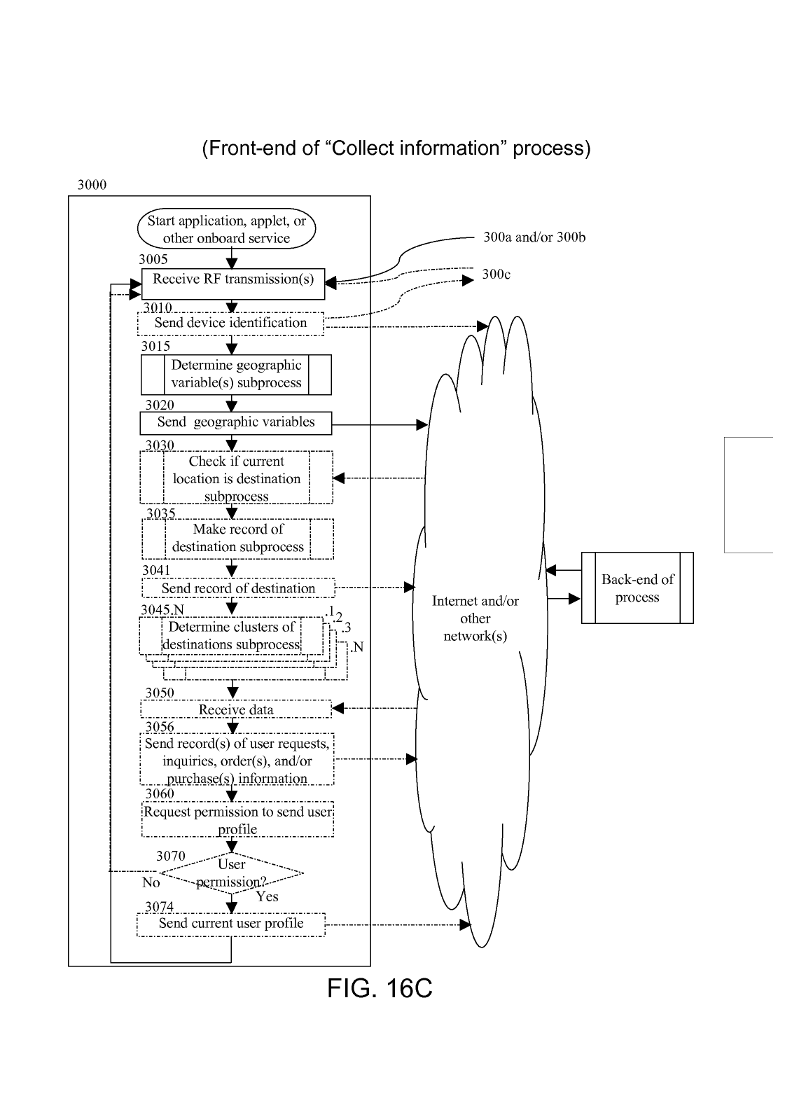

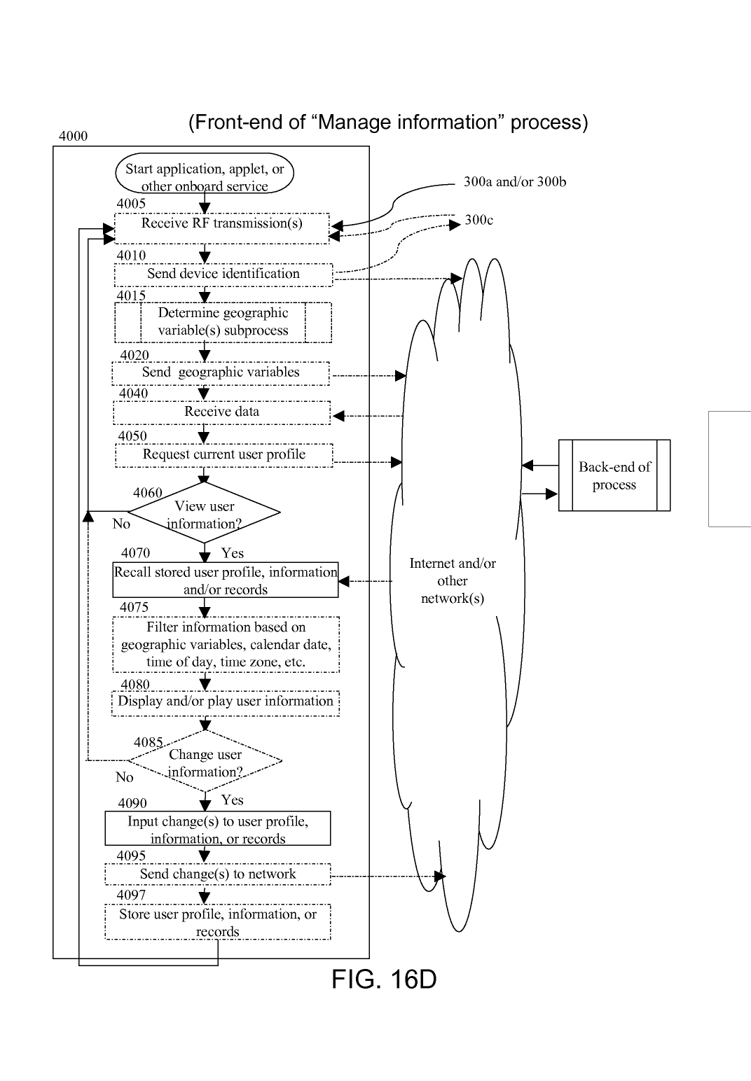

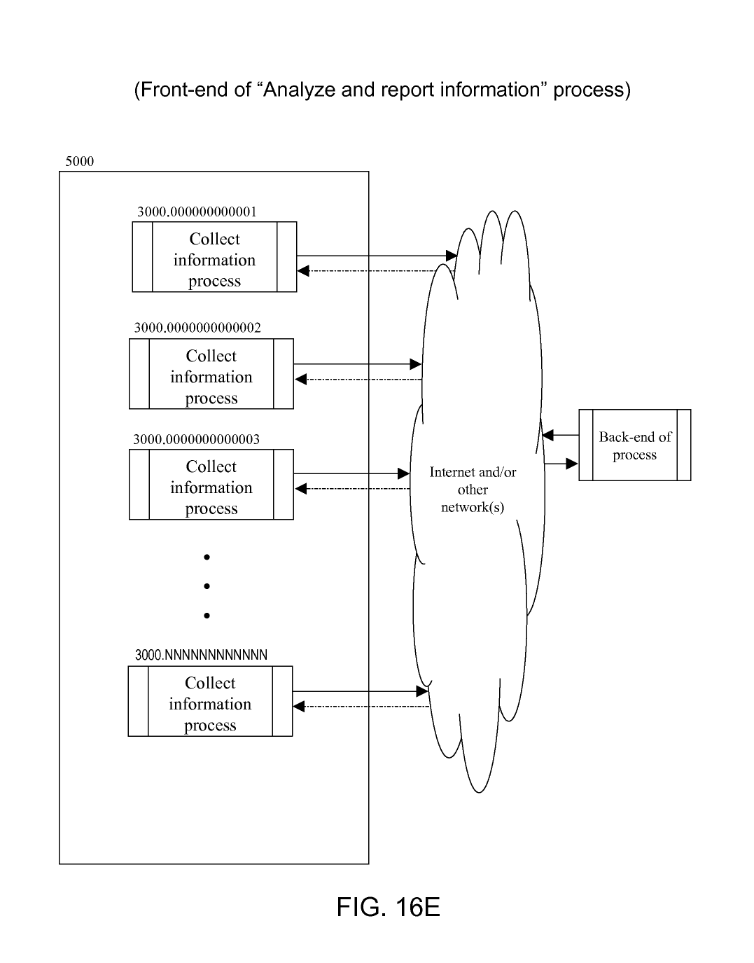

With reference to FIG. 16A, the front-end of process 1000 includes a series of steps 1005 . . . 1096. Several steps, e.g. 1015 and 1096, comprise subprocesses detailed in FIGS. 8A and 8B. The front-end of process 1000 is in communication with the back-end of process 1000 through the internet and/or other networks. In one embodiment, steps shown in solid lines, e.g. 1070 and 1080, are generally required while steps shown in dot-dash lines are optional.

With reference to FIG. 16B, the front-end of process 2000 includes a series of steps 2005 . . . 2096. Several steps, e.g. 2015, 2034, 2040 and 2096, comprise subprocesses detailed in FIGS. 8A, 8D, 8C, and 8B. The front-end of process 2000 is in communication with the back-end of process 2000 through the internet and/or other networks. In one embodiment, steps shown in solid lines, e.g. 2034, is generally required while steps shown in dot-dash lines are optional.

With reference to FIG. 16C, the front-end of process 3000 includes a series of steps 3005 . . . 3074. Several steps, e.g. 3015, 3030, 3035 and 3045.N, comprise subprocesses detailed in FIGS. 8A, 8E, 8F and in 9A, 9B, 9C and/or 9D. The front-end of process 3000 is in communication with the back-end of process 3000 through the internet and/or other networks. In one embodiment, steps shown in solid lines, e.g. 3015 and 3020, are generally required while steps shown in dot-dash lines are optional.

With reference to FIG. 16D, the front-end of process 4000 includes a series of steps 4005 . . . 4095. One step, e.g. 4015, comprises a subprocess detailed in FIG. 8A. The front-end of process 4000 is in communication with the back-end of process 4000 through the internet and/or other networks. In one embodiment, steps shown in solid lines, e.g. 4070 and 4090, are generally required while steps shown in dot-dash lines are optional.

With reference to FIG. 16E, the front-end of process 5000 includes one or more subprocesses 3000.000000000001, 3000.000000000002, 3000.000000000003 . . . 3000.NNNNNNNNNNNN. Each subprocess may be equivalent to a process 3000 detailed in FIG. 16C or may be another subprocess for collection of information. The front-end of process 5000 is in communication with the back-end of process 5000 through the internet and/or other network(s). In one embodiment, communication lines shown in solid lines are generally required while communication lines shown in dot-dash lines are optional.

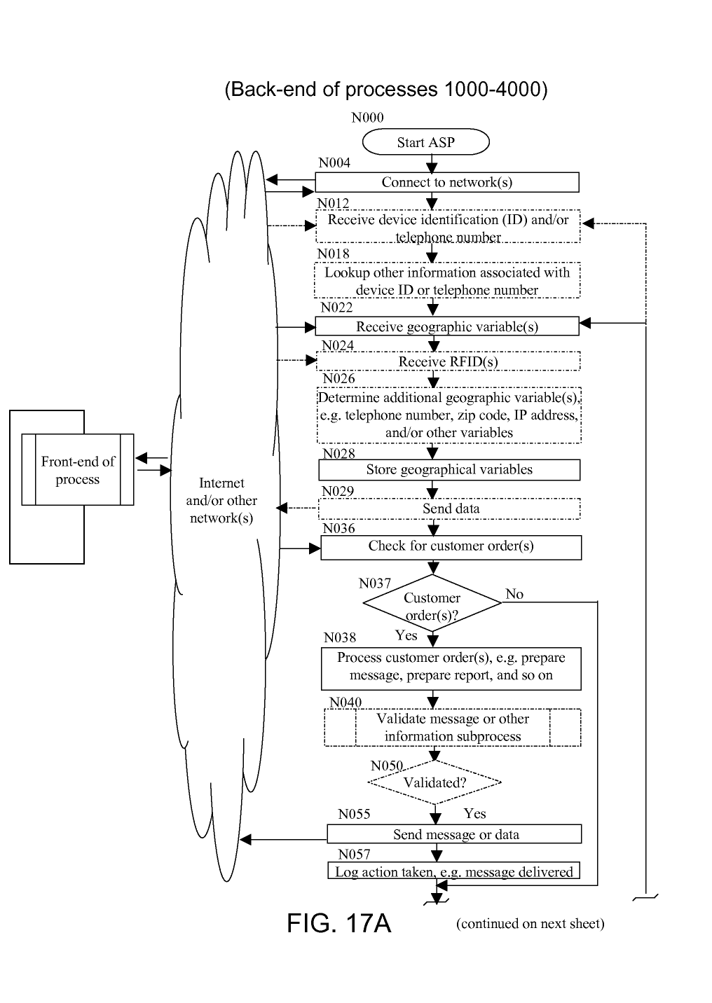

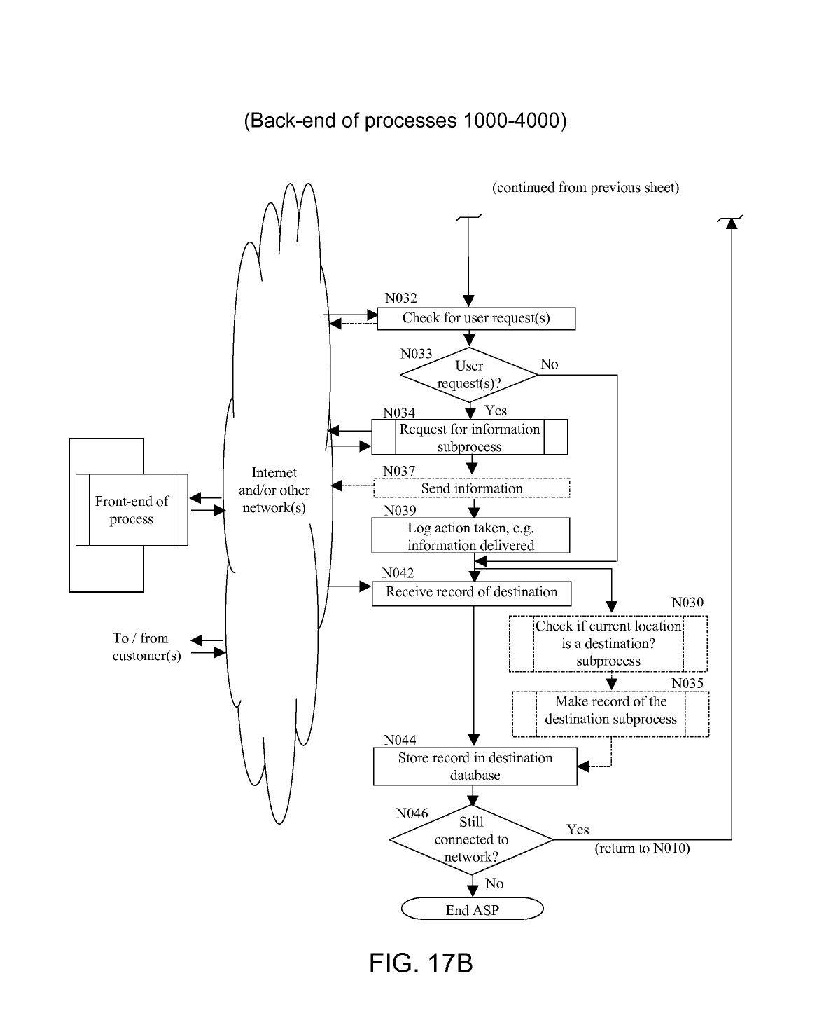

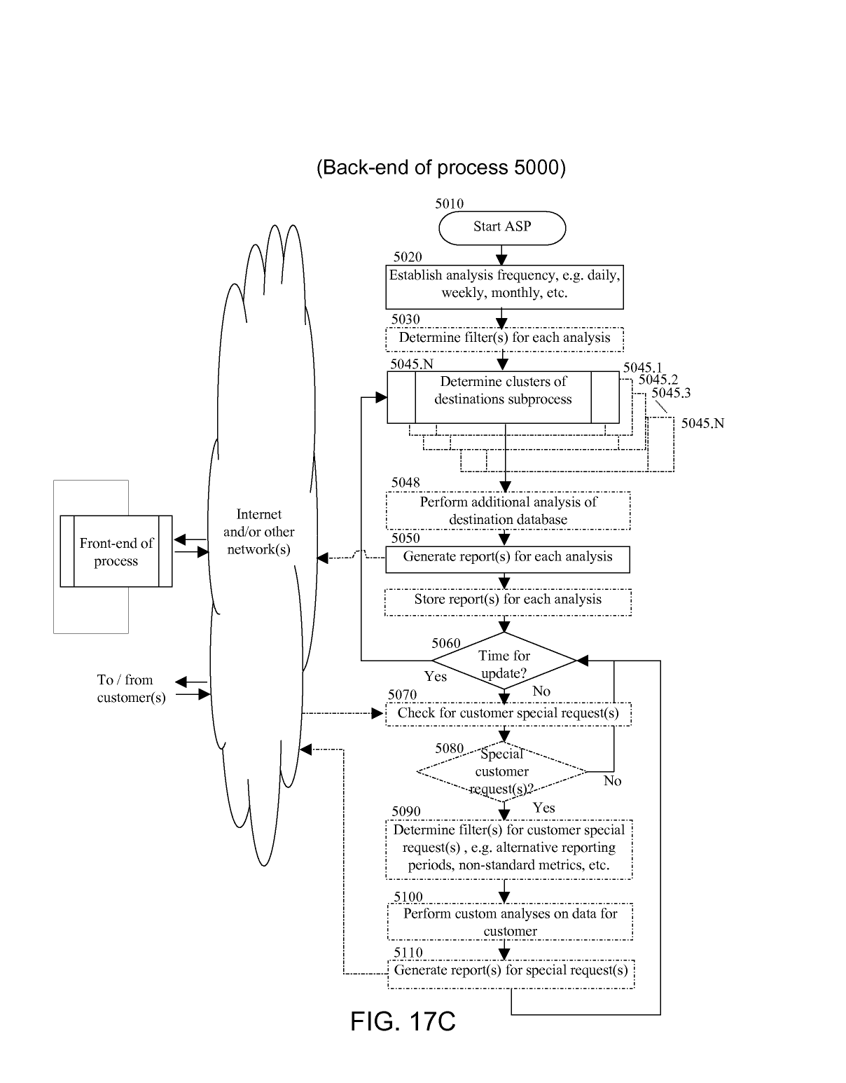

With reference to FIGS. 17A and 17B, the back-end of process 1000, 2000, 3000, or 4000 includes a series of steps N005 . . . N057 and N032 through N046. Several steps, e.g. N040, N034, N030, and N035, comprise subprocesses detailed in FIGS. 8C, 8D, 8E and 8F. The front-end of the process 1000, 2000, 3000 or 4000 is in communication with the back-end of the same process through the internet and/or other network(s). In one embodiment, steps shown in solid lines, e.g. N022, is required while steps shown in dot-dash lines are optional.

With reference to FIG. 17C, the back-end of process 5000 includes a series of steps 5020 . . . 5110. Several steps, e.g. 5045.N, comprise one or more subprocesses detailed in FIGS. 9A, 9B, 9C and/or 9D. The front-end of processes 5000 is in communication with the back-end of process through the internet and/or other network(s). In one embodiment, steps shown in solid lines, e.g. 5020 and 5050, are required while steps shown in dot-dash lines are optional.

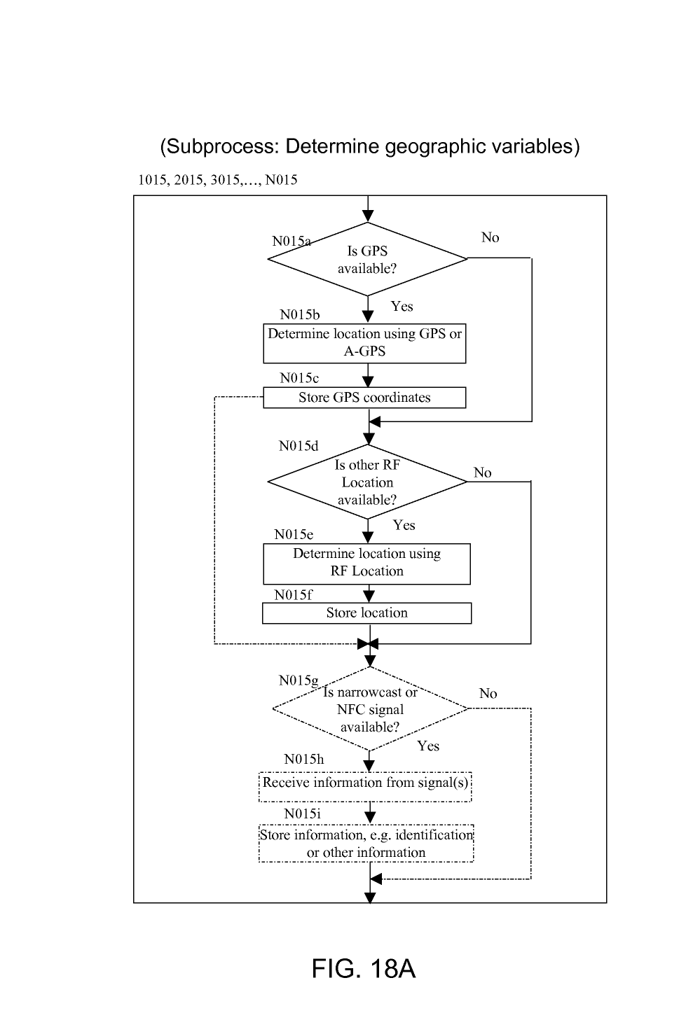

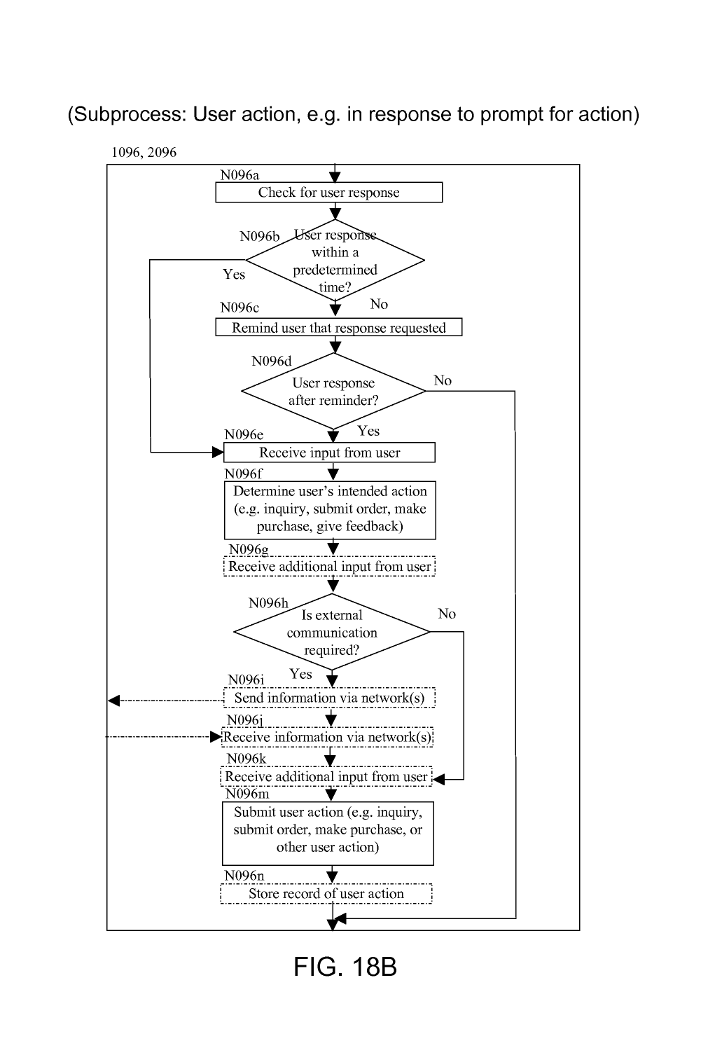

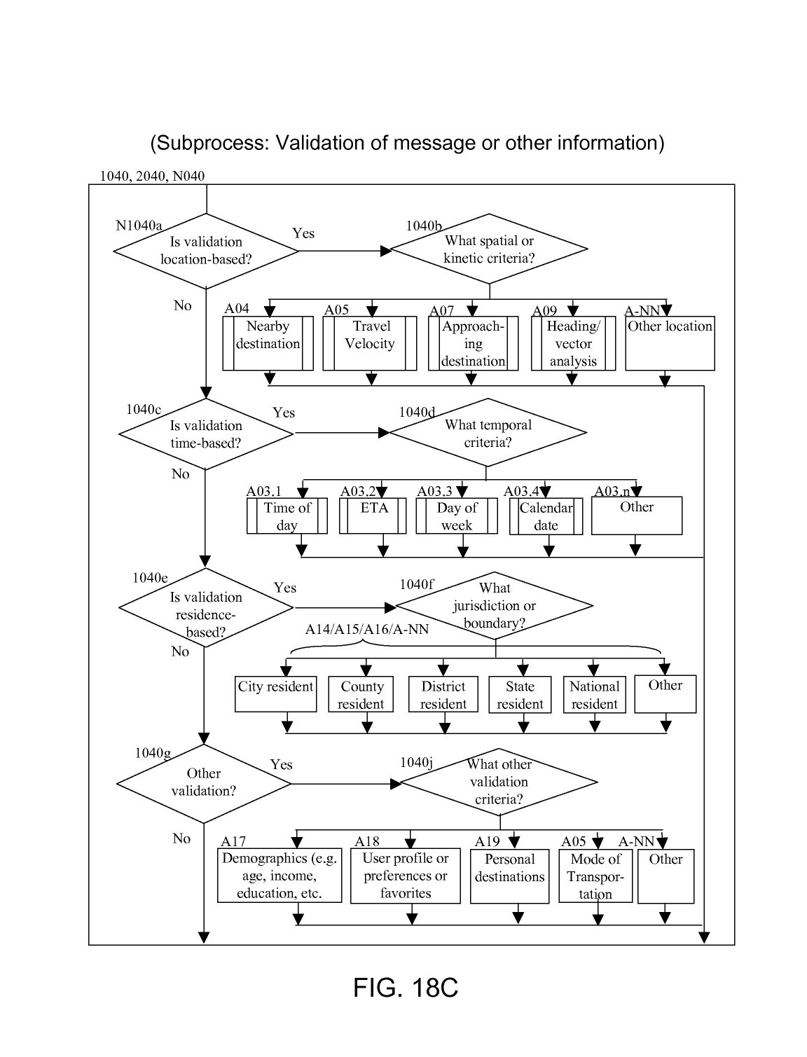

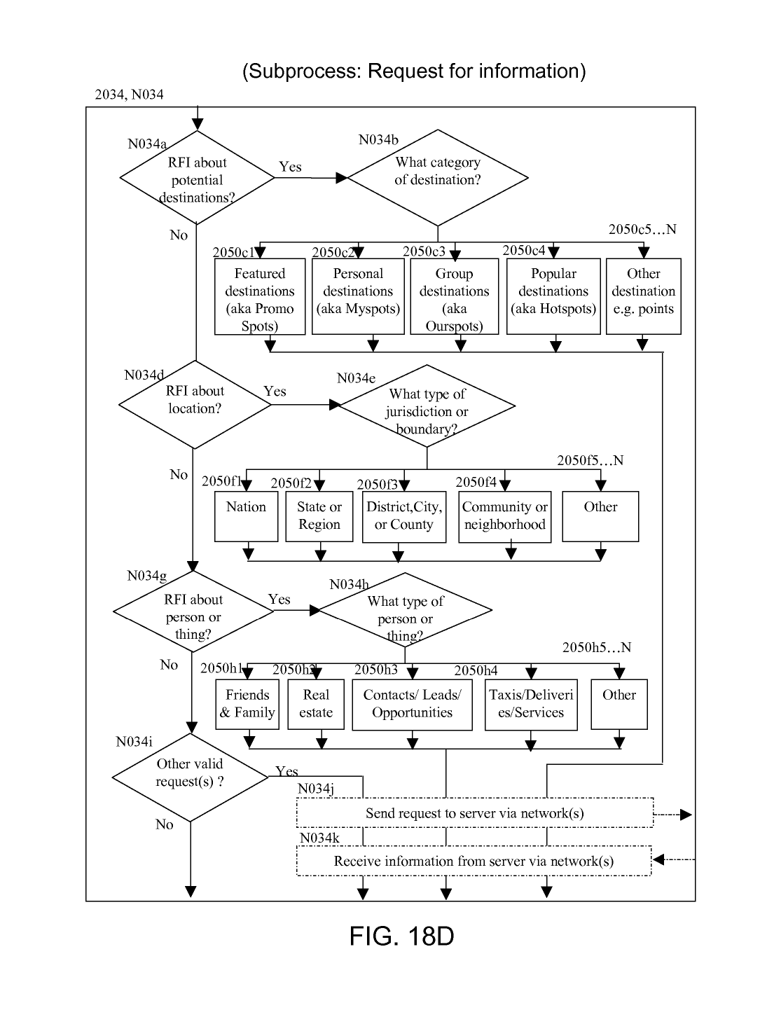

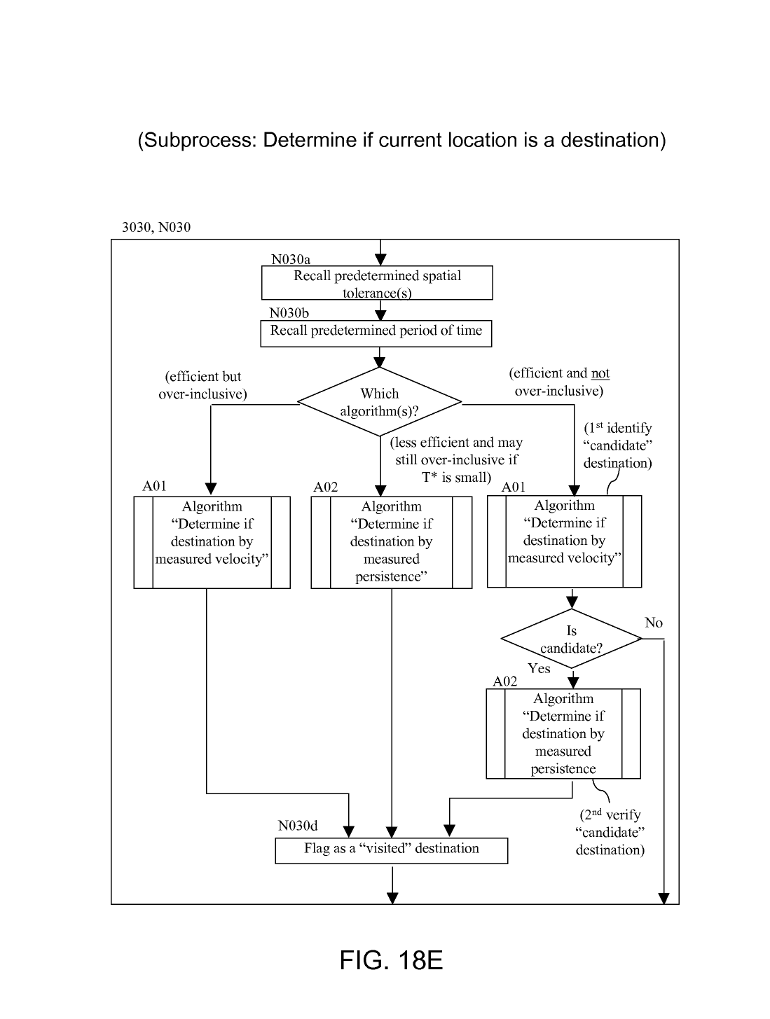

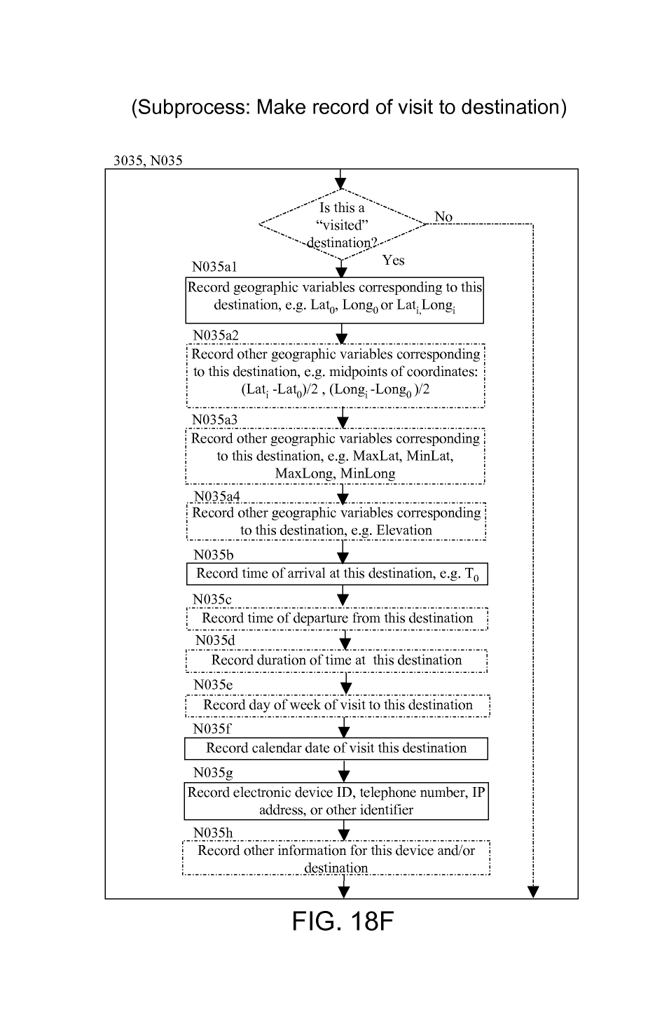

With reference to FIGS. 18A through 18E, several subprocesses of the processes 1000 through 4000 are shown. Each subprocess includes one or more steps. In at least one embodiment, steps shown in solid lines are required and steps shown in dot-dash lines are optional.

In FIG. 18A, subprocess 1015, 2015, . . . , N015 entitled “Determine geographic variables” details steps N015a through N015i of determining geographic variables. In one embodiment, geographic variables comprise GPS coordinates or a portion thereof such as the latitude, longitude, and/or elevation. In another embodiment, geographic variables comprise a telephone number or portion thereof such as the area code (or city code) and the exchange. In still another embodiment, geographic variables comprise an IP address or mobile IP address. In yet still other embodiments, geographic variables comprise information from a narrowcast or a near field communication.

In FIG. 18B, subprocess 1096 or 2096 entitled “User action” details steps N096a through N096n of user action in response to a prompt for user action. In one embodiment, a user action may make a reservation. In another embodiment, a user action may place an order. In still another embodiment, a user action may inquire of the status of an order or reservation. In yet still another embodiment, a user action may make a purchase. In still other embodiments, a user action may take any action for which the mobile device 100 or electronic device 110 has the capability. For example, a user action may include but not limited to making a reservation, making an appointment, placing an order, purchasing a product or service, entering into a contract, subscribing to anything, making a donation or pledge to a cause, charity or the like. User actions are typically in response to a prompt for user action, e.g. a prompt in the form of an advertisement or promotion, but user action may also be undertaken without a prompt for action. When the user takes an action without a prompt for action, the process is often known as a user request process 2000 and/or subprocess 2034, N034.

In FIG. 18C, subprocess 1040, 2040 . . . N040 entitled “Validation of message or other information” details steps N040a through N040j of validating a message or other information. In one embodiment, a validation may be location based using spatial, kinetic or a combination of these criteria such as position, altitude, velocity, heading, and so on, e.g. is device nearby destination or is device approaching destination? In another embodiment, a validation may be time based using temporal criteria such as date, time of day, day of week, and so on, e.g. is time of day within operating hours? In still another embodiment, a validation may be residence based, e.g. is user a resident of the city, county, state, etc. In still other embodiments, a validation may be based on other criteria such as demographics, user preferences, personal destinations, and so on.

In FIG. 18D, subprocess 2034, N034 entitled “Request for information” details steps N034a through N034k of performing a request for information (RFI). In one embodiment, a RFI may be about potential destinations. Such potential destinations may be nearby or distant from the device, and if the device is a mobile, the device may be heading toward or away from such potential destinations or may be on a trajectory that will pass close by or far away from such potential destinations. In another embodiment, a RFI may be about a user's location based on a jurisdiction or boundary, e.g. municipality, county, state, nation, community or neighborhood, and so on. In still another embodiment, a RFI may be about other users or things, e.g. family and friends, real estate, contacts/leads/opportunities, taxis/deliveries, and so on. For example, a RFI relating to real estate may seek a property profile, contact information, pictures, a video walkthrough, and so on, and the RFI may obtain information from a narrowcast source, e.g. a RFID tag, a near field communication source, e.g. NFC chip, a database located on a remote server based on a property identified, or a combination of sources. Information delivered in response to a RFI may or may not be stored in a database; if information is held in a database containing information about one or more properties including but limited to a properties of a single real estate agent, a team of real estate agents, a real estate brokerage company, or a multiple listing service (MLS) of the type maintained by the National Association of Realtors, or any other database. In yet still other embodiments, a user request may be a RFI about anything including both tangibles or intangibles. In yet still other embodiments, a user request may be for virtually anything including but not limited to set up meetings, make appointments, apply for jobs, join clubs or organizations, opt-in or opt-out, obtain autographs, obtain reports, and so on, including but not limited to making a reservation, making an appointment, placing an order, purchasing a product or service, entering into a contract, subscribing to anything, making a donation or pledge to a cause, charity or the like.

In FIG. 18E, subprocess 3030, N030 entitled “Determine if current location is a destination” details steps N030a through N030d of determining if current location of a mobile device 100 is a destination. In one embodiment, the subprocess calls algorithm A01 to determine destinations by measured travel velocity T-Vel. Since a device may become relatively immobile, e.g. near zero velocity, at locations other than a destination, e.g. stopped traffic, Algorithm A01 is efficient but tends to be over-inclusive. In another embodiment, the subprocess calls algorithm A02 to determine destinations by measured persistence. Such measured persistence is more accurate than using measured velocity but is less efficient. In still another embodiment, the subprocess first calls algorithm A01, and if a destination is a “candidate” destination, then calls algorithm A02. In this hybrid process, algorithm A01 is used to screen potential destinations as “candidate” destinations and algorithm A02 is used to verify “candidate” destinations as “visited” destinations. Such hybrid process is efficient and not over-inclusive.

In FIG. 18F, subprocess 3035, N035 entitled “Make a record of visit to destination” details steps N035a through N035h of making record of visit to destination. In one embodiment, the subprocess records the longitude and latitude of the device 100 at time of arrival at visited destination. In another embodiment, the subprocess records the longitude and latitude of the device at time of departure from visited destination. In still another embodiment, the subprocess records the midpoints of the longitudes and latitudes corresponding to time of arrival and departure. In yet still other embodiments, the subprocess records other geographic variables such the maximum latitude, minimum latitude, maximum longitude, minimum longitude, elevation, and so on.

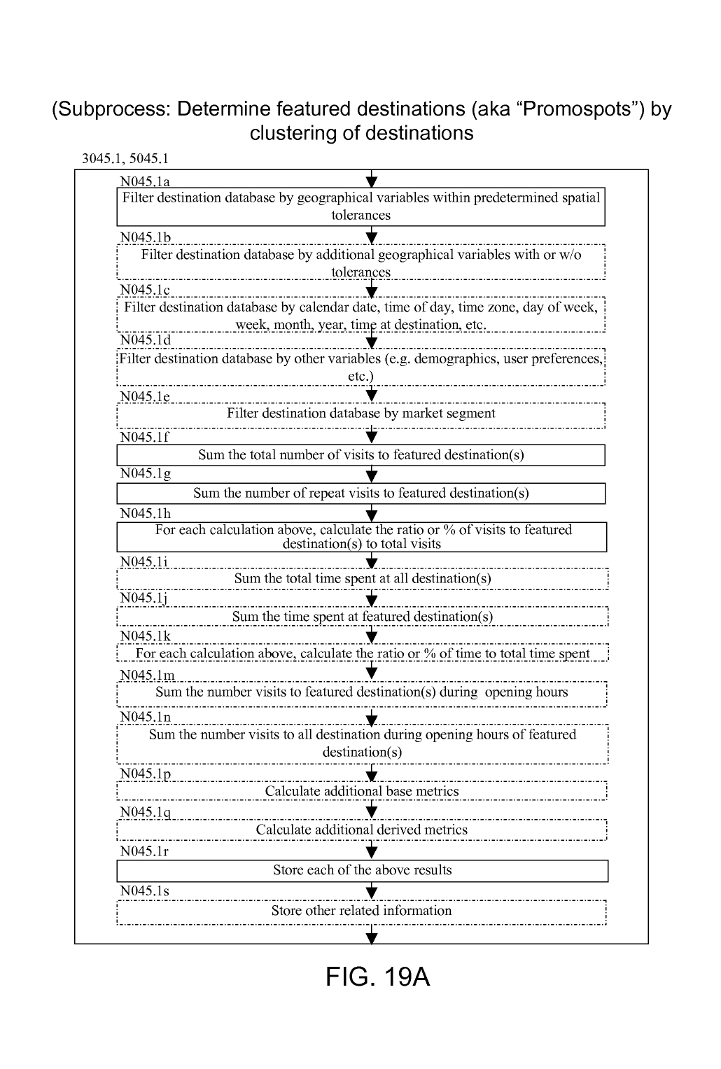

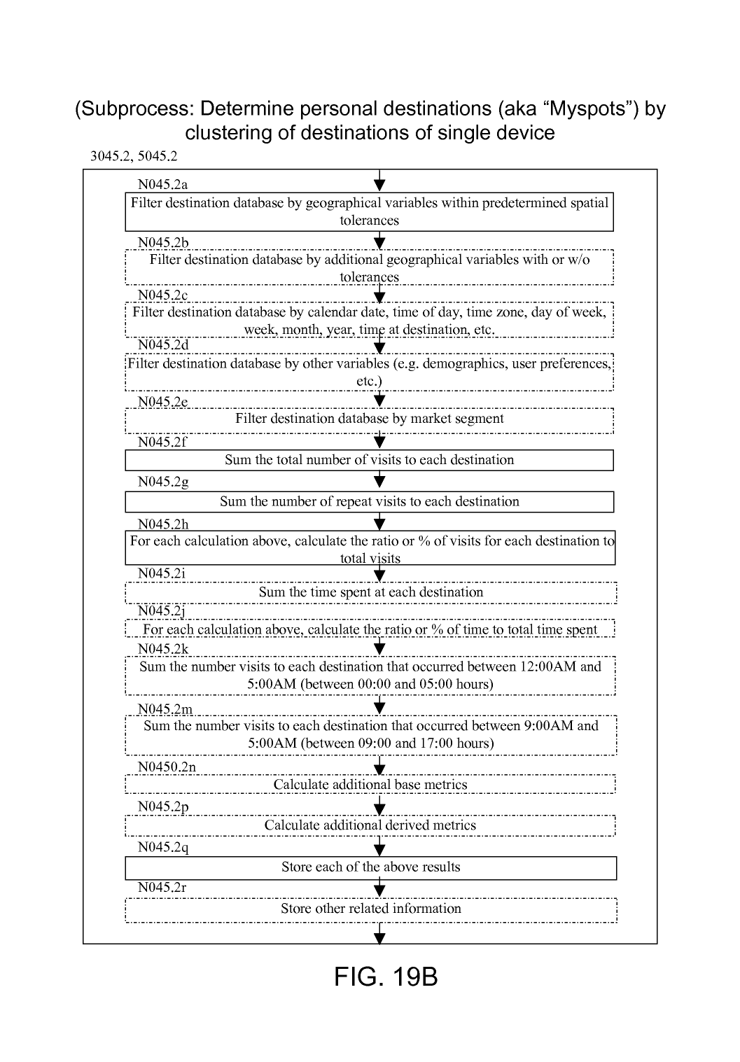

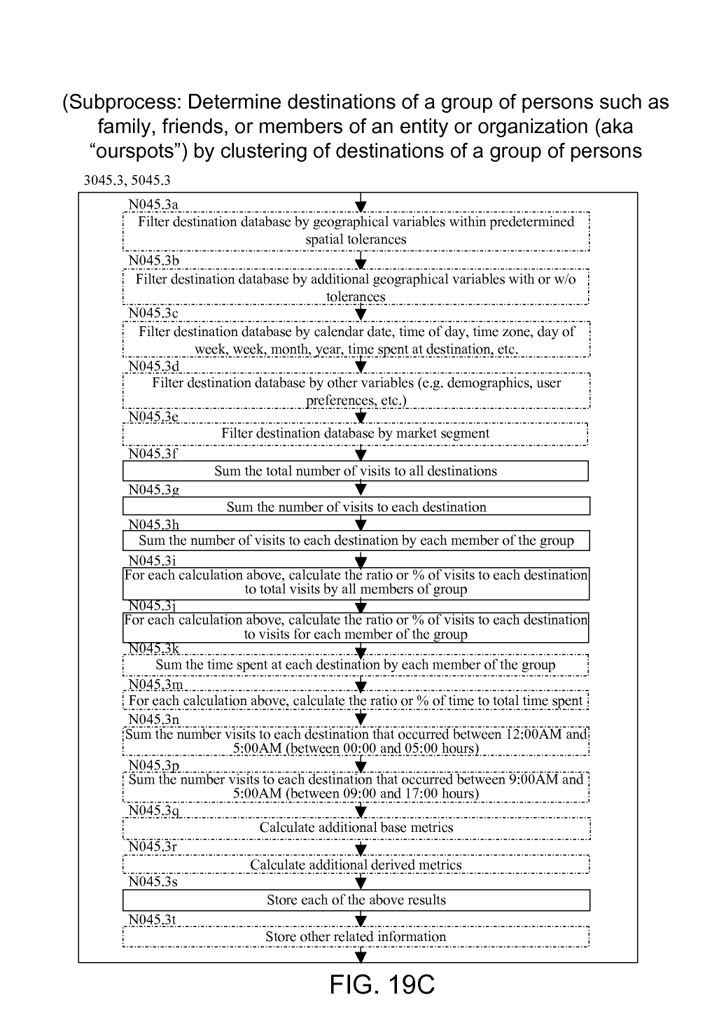

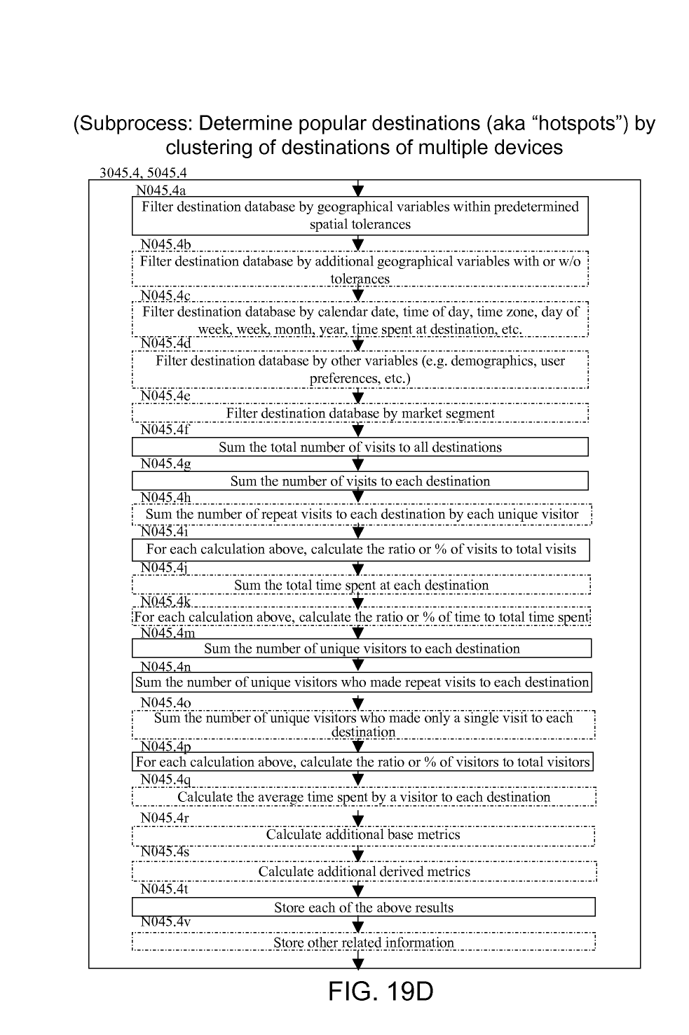

With reference to FIGS. 19A through 19D, several subprocesses of the process 5000 and/or process 3000 are shown. Each subprocess includes one or more steps. Generally, each subprocess mines a destination datatable generates a list of clustered destinations based on one or more criteria such as frequency, familiarity, popularity, and so on. An example of a destination datatable is shown in Table 4 below. Other subprocesses may generate information using other datatables and other criteria such as user demographics, preferences, purchasing behavior, and so on. In at least one embodiment, steps shown in solid lines are required and steps shown in dot-dash lines are optional.

TABLE 4
Example of Destination Datatable

| Record No. | | | | | | |
|---|---|---|---|---|---|---|
| 1 | 2 | 3 | 4 | 5 | . . . | n |

| | | | | | |
|---|---|---|---|---|---|
| User Identifier | 760-218- | 760-218- | 760-218- | 760-641- | 760-641-8916 |
| | 1733 | 1733 | 1733 | 8916 | |
| Time of day | 6:00 AM | 7:00 AM | 8:00 AM | 7:00 AM | 9:00 AM |
| Time zone | PT | PT | PT | PT | PT |
| Day of week | | | | | |
| Time of arrival | | | | | |
| Time of | | | | | |
| departure | | | | | |
| Duration of visit | | | | | |
| Calendar date | | | | | |
| Lat₀ | | | | | |
| Latᵢ | | | | | |
| Long₀ | | | | | |
| Longᵢ | | | | | |
| (Latᵢ − Lat₀)/2 | | | | | |
| (Longᵢ − Long₀)/2 | | | | | |
| MinLat | | | | | |
| MinLong | | | | | |
| MaxLat | | | | | |
| MaxLong | | | | | |
| . | | | | | |
| . | | | | | |
| . | | | | | |
| Field m | | | | | |

In FIG. 19A, subprocess 3045.1, 5045.1 entitled “Determine featured destinations (aka Promospots) by clustering of destinations” details steps N045.1a through N045.1s of determining featured destinations by clustering of destinations or another method of determining featured destinations. In one embodiment, the featured destinations may be filtered by one or more criteria, e.g. temporal, geographic, demographic, and so on as in examples N045.1a . . . N045.1e.

In FIG. 19B, subprocess 3045.2, 5045.2 entitled “Determine personal destinations (aka Myspots) by clustering of destinations” details steps N045.2a through N045.2r of determining personal destinations by clustering of destination or another method of determining personal destinations. In one embodiment, the personal destinations may be filtered by one or more criteria, e.g. temporal, geographic, demographic, and so on as in examples N045.3a . . . N045.3e.

In FIG. 19C, subprocess 3045.3, 5045.3 entitled “Determine destinations of a group of persons (aka Ourspots) by clustering of destinations of multiple devices” details steps N045.3a through N045.3t of determining destinations of a group of persons by clustering of destinations or another method of determining destinations. The group of persons may or may not be a pre-defined group and the composition of the group may remain unchanged over time or may vary in number depending on qualifications for membership in the group, each individual's decision to opt-in or opt-out of membership, and other factors necessary to maintain membership such as fees. The group of persons may be acquaintances, strangers, or both. For example, the group may be the employees of a legal entity such as a company, business enterprise, or non-profit; members of an organization or association; members of a club, members of a family, a group of friends, and so on; or any other group of persons, or even members of a division a group. In one embodiment, the destinations may be filtered by one or more criteria, e.g. temporal, geographic, demographic, and so on as in examples N045.3a . . . N045.3e.

In FIG. 19D, subprocess 3045.4, 5045.4 entitled “Determine popular destinations (aka hotspots) by clustering of destinations of multiple devices” details steps N045.4a through N045.4v of determining destinations visited by a plurality of persons by clustering of destinations or another method of determining destinations. The plurality of persons may or may not to be in a pre-defined group and may include persons that are acquaintances, strangers, or both. In one embodiment, the plurality of persons is a pre-defined sample (aka “panel”) of persons in accordance with demographic requirements or another sample of the population. In another embodiment, the plurality of persons is a multitude of persons in the general population. In still another embodiment, the destinations may be filtered by one or more criteria, e.g. temporal, geographic, demographic, and so on as in examples N045.4a . . . N045.4e.

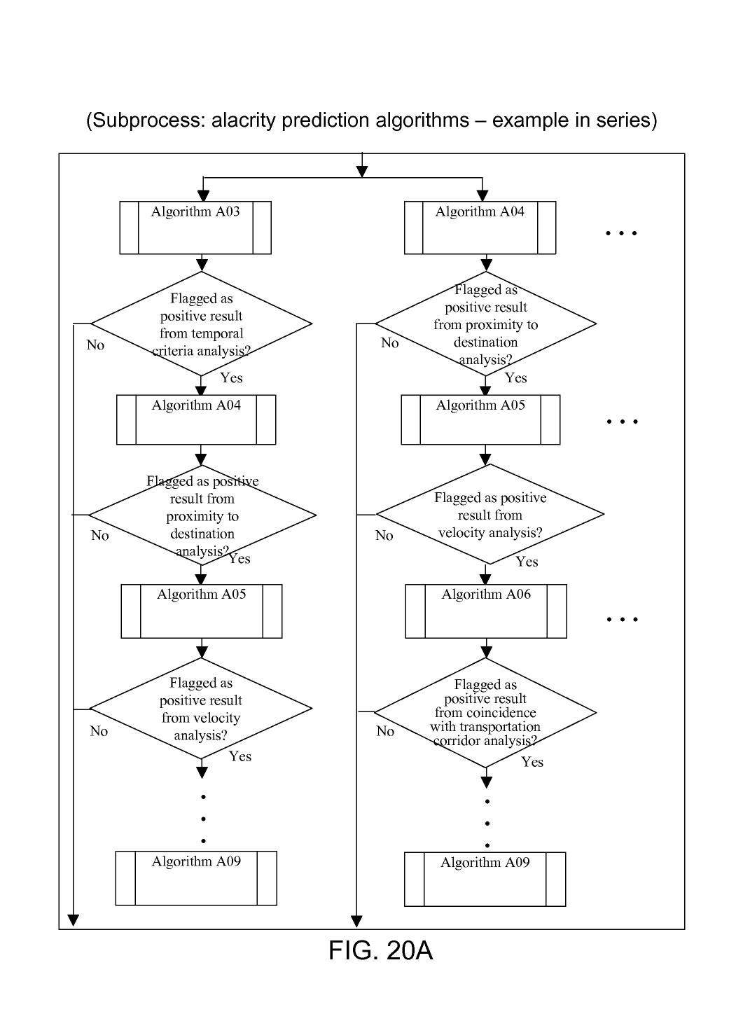

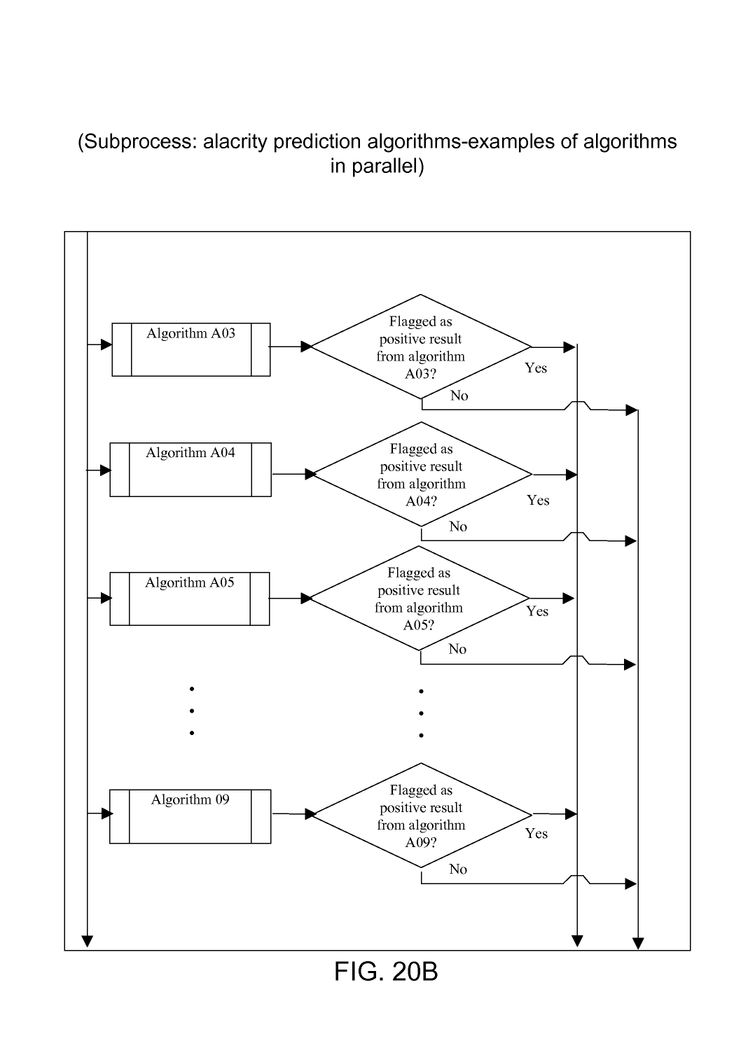

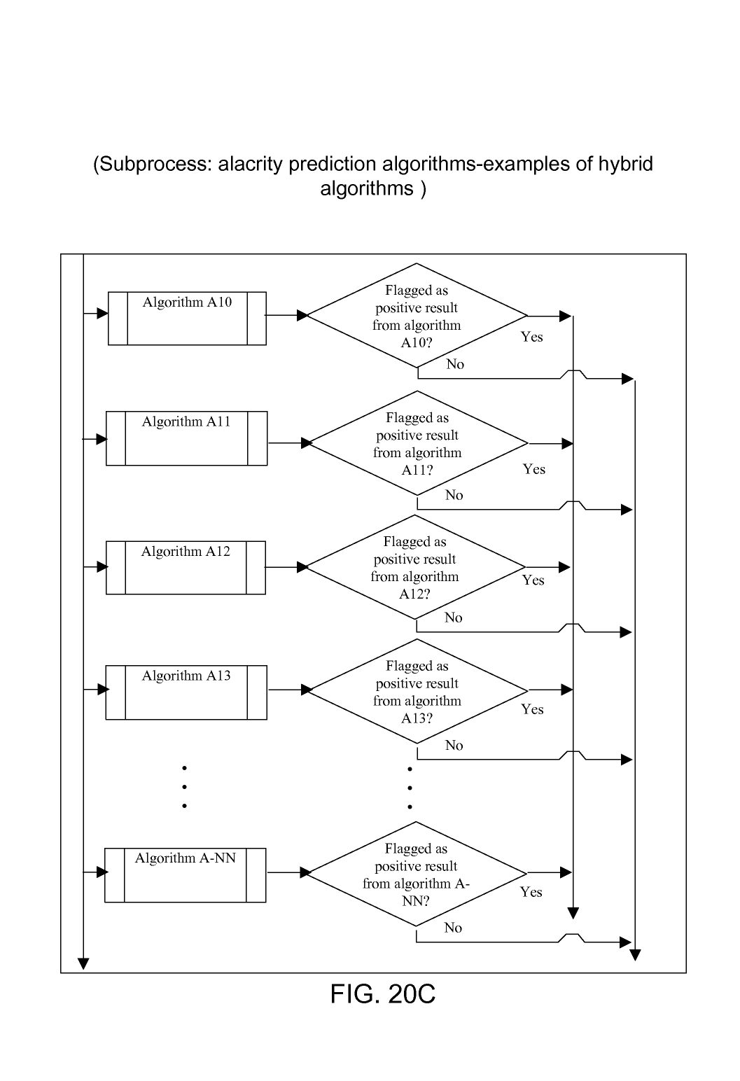

FIGS. 20A through 20C show examples of alternative flowcharts of algorithms for alacrity predication. FIG. 20A shows an example of alacrity prediction algorithms used in series. FIG. 20B shows an example of alacrity prediction algorithms used in parallel. FIG. 20C shows an example of hybrid alacrity prediction algorithms that integrate two or more algorithms A03 through A09, inclusive. In addition to the examples shown in these figures, any alacrity prediction algorithm may be used to predict the alacrity of the user of a mobile device. For example, algorithms A03 through A09 may be used, individually or in combination, or one or more of hybrid algorithms A10 through A13 may be used, or one or more other alacrity algorithms may be used.

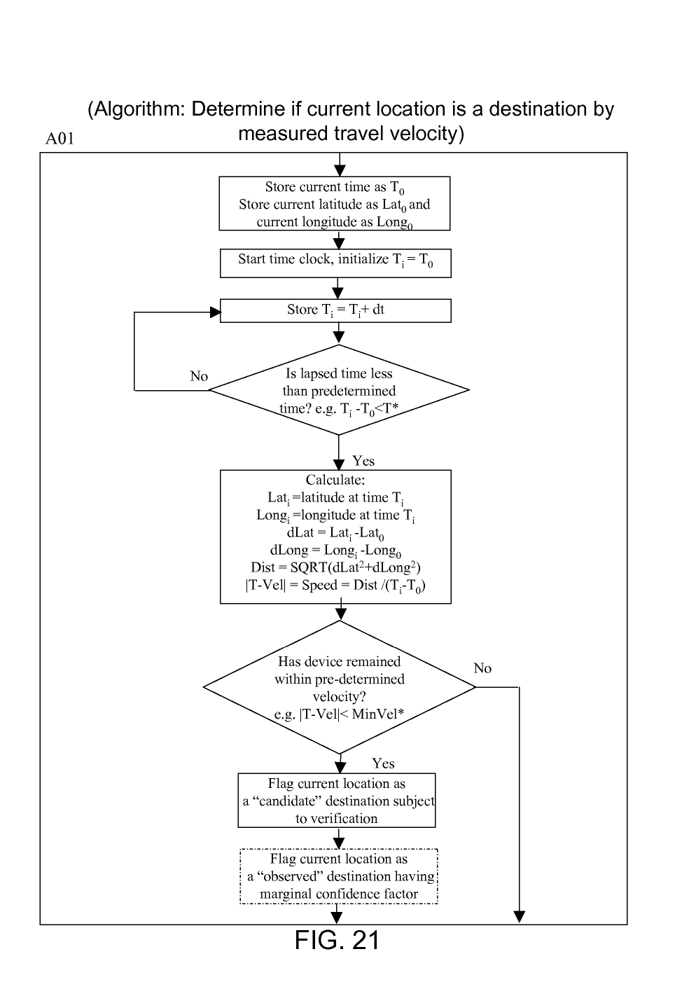

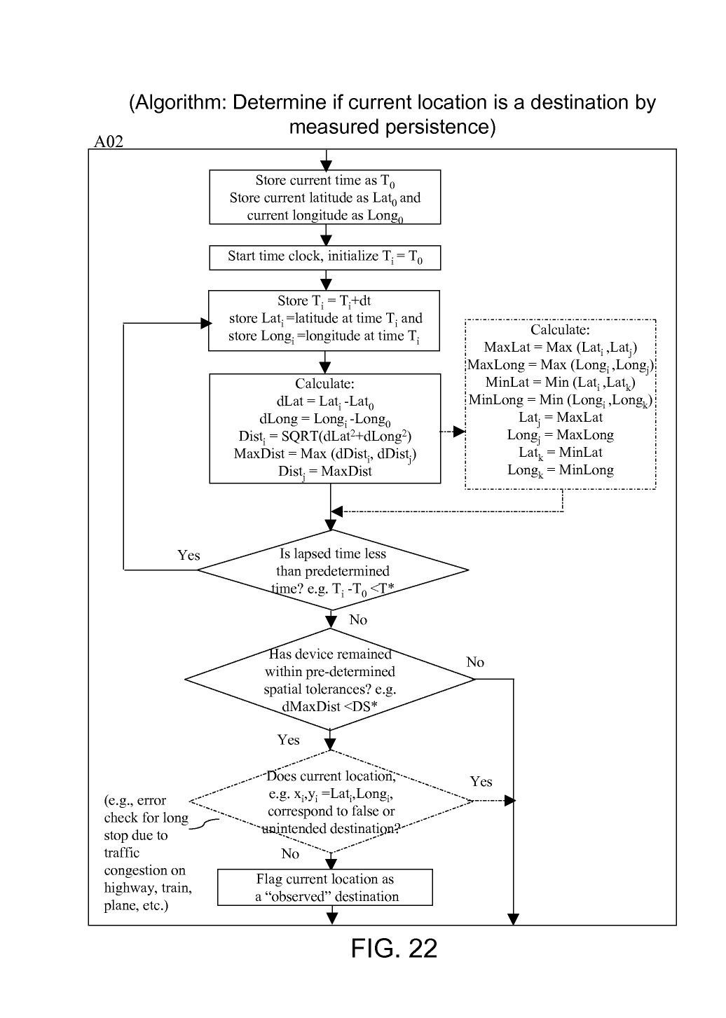

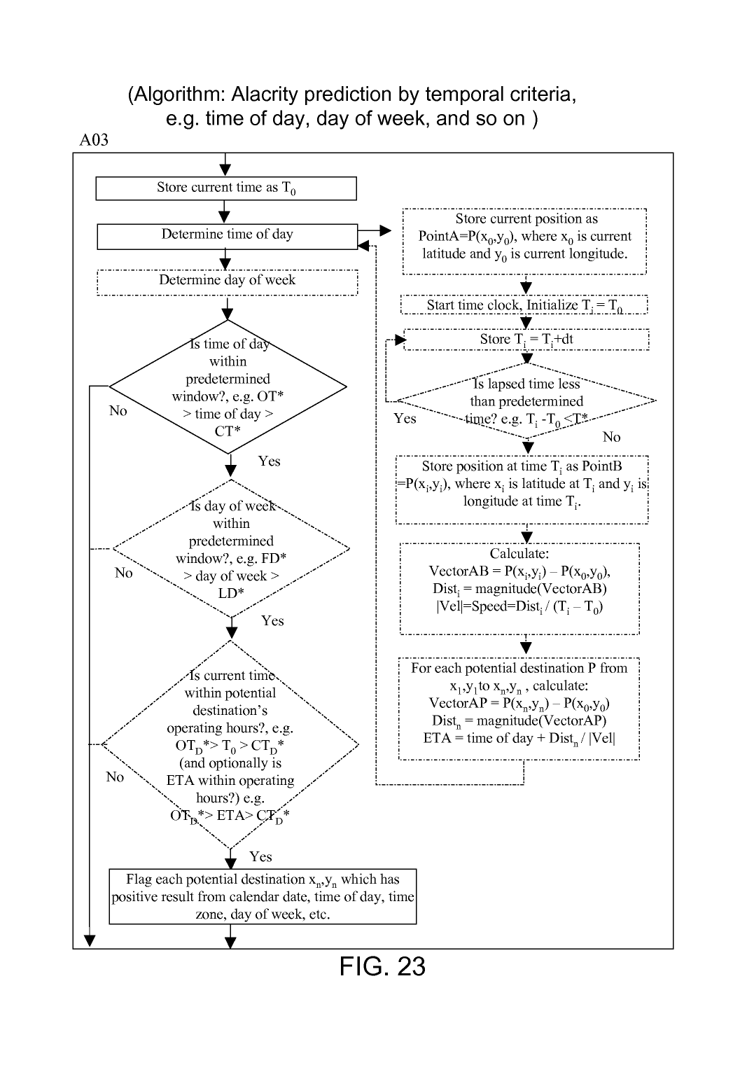

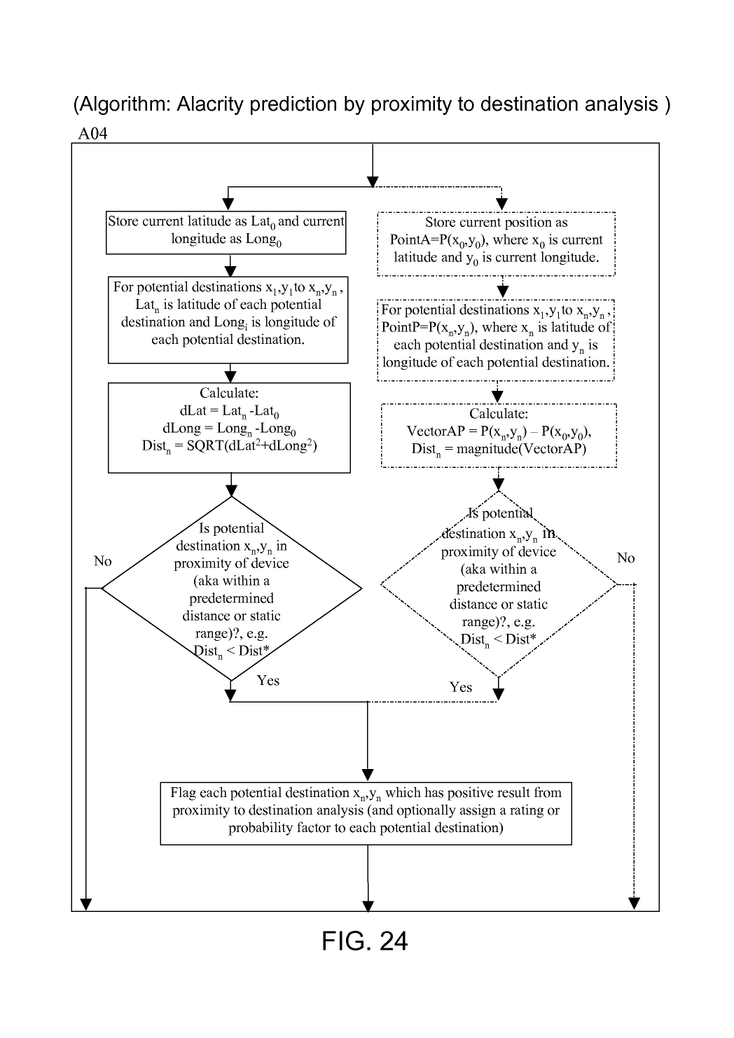

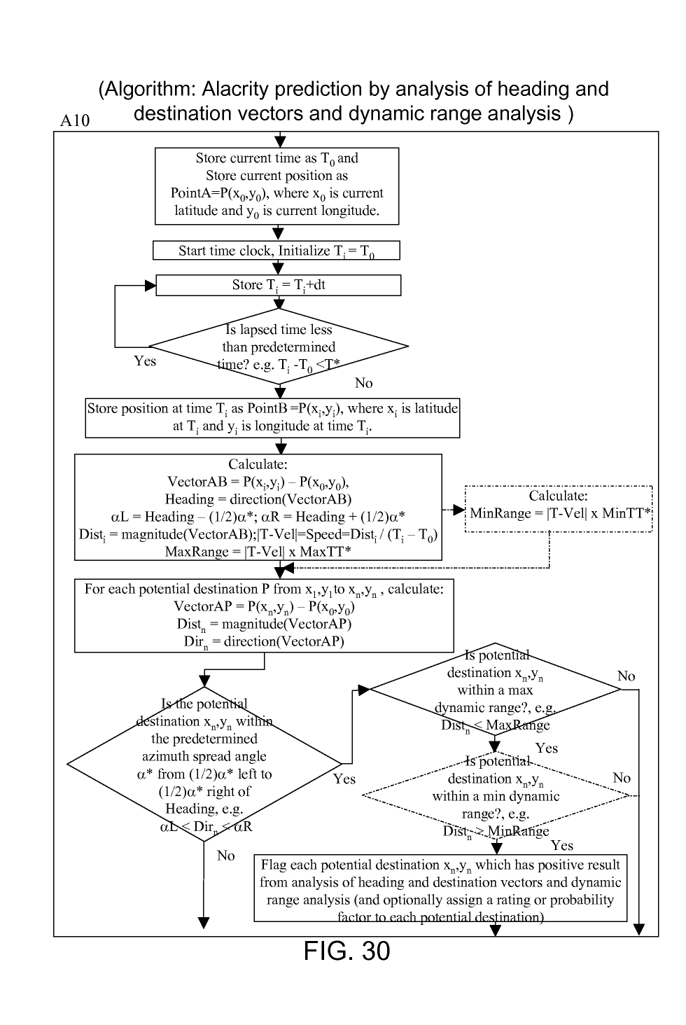

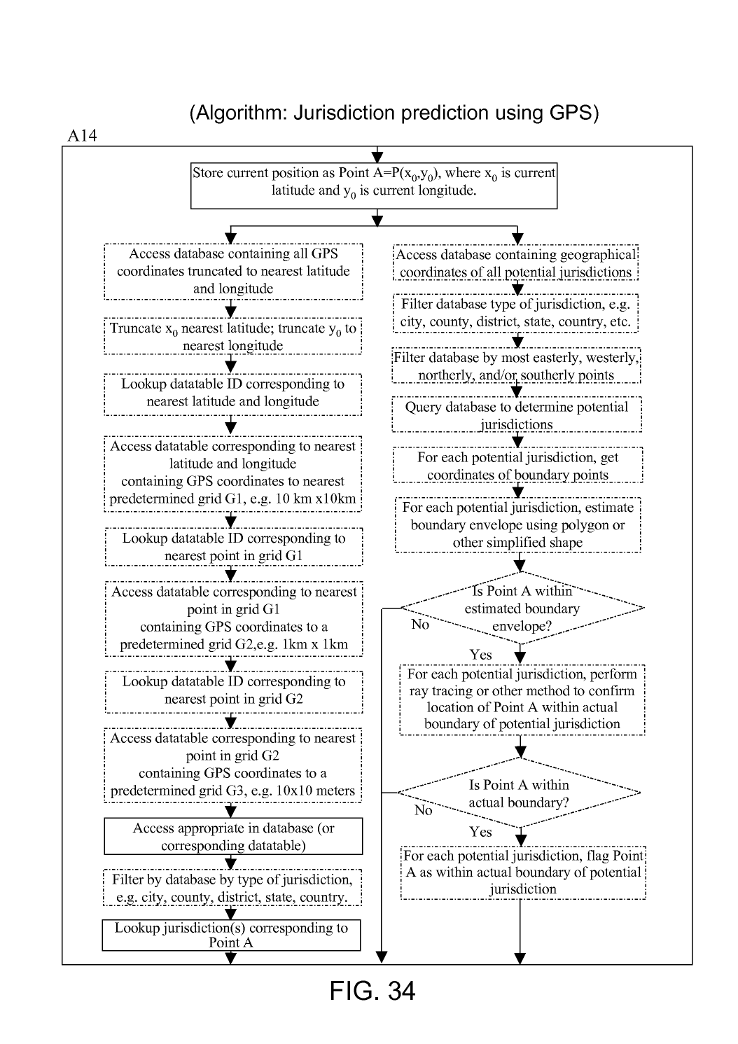

With reference to FIG. 21 through FIG. 36, the algorithms include but are not limited to identification of actual destinations, alacrity prediction with respect to potential destinations, and jurisdiction predication. FIGS. 21 and 22 relate to identification of actual destinations, FIGS. 23 through 33 relate to alacrity prediction with respect to potential destinations, and FIGS. 34 through 36 relate to jurisdiction, territory, or other boundary prediction. In some embodiments, the algorithms may comprise a contemporaneous or “real-time” process. In other embodiments, one or more algorithms may comprise a contemporaneous or “real-time” process while other algorithms are a batch process. Also, the algorithm(s) may be executed by processors on-board the electronic device, e.g. 10, 56, and so on, or by processors in the server 200. Further, all of the algorithms would not be utilized unless redundancy is desired. For example, the algorithms shown in FIGS. 30 through 33 are hybrid algorithms that integrate two or more algorithms shown in FIGS. 24 through 29. Thus, to maximize efficiency and/or minimize redundancy, the particular algorithms used may vary by the embodiment. In fact, FIGS. 20A, 20B, and 20C illustrate many of the possible combinations of algorithms. As a further example, in one embodiment, algorithm A03 may be used in conjunction with algorithms A04 and A08, or in conjunction with algorithms A07 and A08, or in conjunction with hybrid algorithm A10, A11, A12 or A13.

In various embodiments, using the data collected from a mobile device, algorithm(s) may be used to predict the user's mode of transportation and the alacrity of the user to go to one or more potential destinations. The algorithm(s) may take into account one or more spatial or kinetic variables—measured and/or derived—including but not limited to geographic variables and temporal variables such as horizontal velocity, vertical velocity, latitude, longitude, altitude, heading, orientation, travel distance, travel time, range and/or past points of reference to predict the most likely destinations among potential destinations or predicts the path of travel. For example, in one embodiment, an algorithm may predict likely destinations in close proximity to the highway, or if not on a highway, in close proximity to the heading. In another embodiment, the algorithm may predict likely destinations in close proximity to the highway or the heading that are within a predetermined range, e.g. 1, 5 or 10 km. In still another embodiment, the algorithm(s) predict the likely destinations based on travel velocity of user, e.g. within a dynamic range, or based on mode of transportation. In at least one embodiment, algorithm(s) assigned a probability factor, weight, or rating to each potential destination, where a potential destination of closer proximity to the user or the heading, as applicable has a higher probability factor than a potential destination of farther proximity to the user or the heading, as applicable. For example, if a user is traveling at 80 kph heading due east for 45 minutes, the user is more likely want to go to destinations that are within 5-15 minutes of his future predicted location. Also, the user would not likely be interested in locations that are due west of his current position since user is traveling due east. The algorithm(s) result in prediction of more accurate potential destination(s) than any other previous methods.

In another embodiment, the database(s) are populated automatically by data that is collected from mobile devices, stored on one or more server(s), and processed by one or more algorithms. In still another embodiment, the results from the algorithms are also be stored in a database and referenced against known datapoints, landmarks, points of interest, etc. Using a unique identifier for each user, any visited destinations are new data points and are converted to real life or ‘actual’ places. A reference database of actual ‘places’ is the Geographical Names Information System (GNIS) maintained by the U.S. Geographic Survey. In other words, any destination the person goes including an address, a geographical location such as a forest, lake, park—basically, any place that person goes—will be checked against known location points and converted to predicted points of interest. These points of interest will all hold a probability influence factor in the algorithm. In one embodiment, a database stores the personal destinations of each user—whether locations or ‘actual’ places—that can be used to predict future destinations for that user in various processes, e.g. 1000, 2000, and so on. Such personal destinations can be presented to user via the user's mobile device 100 or other electronic device 110. In another embodiment, a databases stores the common destinations of a group of users—whether locations or ‘actual’ places—that can be used to predict future destinations for the group of users in various processes, e.g. 1000, 2000, and so on. Such group destinations can be presented to user(s) via the users' mobile device 100 or other electronic device 110. In still another embodiment, a databases stores the frequently visited or popular destinations of a multitude of users—whether locations or ‘actual’ places—that can be used to predict future destinations for multiple users in various processes, e.g. 1000, 2000, and so on. Such popular destinations can be presented to user(s) via the users' mobile devices 100 or other electronic device 110.

Knowing personal destinations, group destinations and/or popular destinations of users will also allow weighting of these destinations more than others. In addition, knowing such histories of destinations will extrapolation of information about user habits, preferences, and behaviors that can be used to identify future destinations more likely to be visited than others based on that past data as well as to identify opportunities for targeting of messages to users. Further, the system and methods can be used to develop profiles of users without user input. Even if a user's profile may be unknown a priori, a new user may be given an initial profile based data extrapolated from data of existing users using limited geographic information, e.g. a single destination, without user input and without knowing an extensive dataset of past datapoints or destinations for the new user. The user's profile can be updated and/or refined by a self-executing process by recording destinations and other information about individual user such as habits, preferences, reservations, orders, purchases, and so on.

Each algorithm utilizes one or more predetermined variables indicated by an asterisk “*”. In one embodiment, the predetermined variables are established for multiple users based in part on expert knowledge or heuristics. In another embodiment, the predetermined variables are established dynamically for individual users. In still another embodiment, the predetermined variables are default values based on assumptions. Examples of minimum, maximum, and typical values of these predetermined variables are shown in Table 5 below.

TABLE 5
Predetermined Variables for Algorithms A01 . . . AN

| | Predetermined | | | |
|---|---|---|---|---|
| Algorithm | Variable | Min Value | Max Value | Typical Value |
| For A01 . . . AN | dt | <1 second | 10000 sec | 60-600 sec |
| A01 | T* | <1 min | >60 min | 5-20 min |
| A01 | MinVel* | <1 kph | 20 kph | 2-5 kph |
| A02 | T* | <1 min | >1000 min | 10-120 min |
| A02 | DS* | <1 meter | 30000 km | 10-500 meters |
| A03 | T* | <1 min | >60 min | 5-20 min |
| A03 | OT* | 0:00 | 24:00 | 05:00-10:00 |
| A03 | CT* | 0:00 | 24:00 | 16:00-21:00 |
| A03 | FD* | Sunday | Tuesday | Sun-Tues |
| A03 | LD* | Thursday | Saturday | Thurs-Sat |
| A04 | Dist* | <1 km | 2500 km | 10-80 km |
| A05 | T* | <1 min | >60 min | 5-20 min |
| A05 | VelA* | 10 kph | 150 kph | 50-80 kph |
| A05 | VelB* | 5 kph | 75 kph | 10-30 kph |
| A06 | ROW* | <1 meter | 1000 meter | 10-100 meters |
| A07 | T* | <1 min | >60 min | 5-20 min |
| A07 | MaxTT* | 1 min | >600 min | 15-30 min |
| A07 | MinTT* | 0 min | 120 min | 0-5 min |
| A08 | T* | <1 min | >60 min | 5-20 min |
| A08 | α* | 0° | >180° | 10°-40° |
| A09 | T* | <1 min | >60 min | 5-20 min |
| A09 | PTL* | <1 km | 100 km | 1-10 km |
| A10 | T* | <1 min | >60 min | 5-20 min |
| A10 | MaxTT* | 1 min | >600 min | 15-30 min |
| A10 | MinTT* | 0 min | 120 min | 0-5 min |
| A10 | α* | 0° | >180° | 10°-40° |
| A11 | T* | <1 min | >60 min | 5-20 min |
| A11 | α* | 0° | >180° | 10°-40° |
| A11 | Dist* | <1 km | 2500 km | 10-80 km |
| A12 | T* | <1 min | >60 min | 5-20 min |
| A12 | MaxTT* | 5 min | >600 min | 15-30 min |
| A12 | MinTT* | 0 min | 60 min | 0-5 min |
| A12 | Dist* | <1 km | 2500 km | 10-80 km |
| A13 | T* | <1 min | >60 min | 5-20 min |
| A13 | MaxTT* | 5 min | >600 min | 15-30 min |
| A13 | MinTT* | 0 min | 60 min | 0-5 min |
| A13 | PTL* | <1 km | 100 km | 1-10 km |
| A14 | G1 | 100 m × 100 m | 10 km × 10 km | 1 km × 1 km |
| A14 | G2 | 10 m × 10 m | 1 km × 1 km | 30 m × 30 m |
| A14 | G3 | 1 m × 1 m | 100 m × 100 m | 10 m × 10 m |
| A15 | — | — | — | — |
| A16 | — | — | — | — |
| . | | | | |
| . | | | | |
| . | | | | |
| A-nn | variable* | min value | max value | typ. value |

In FIG. 21, the flowchart shows Algorithm A01 for determining if the current location of mobile device is a destination by measured travel velocity, also known as T-Vel. Such measured travel velocity may be either instantaneous velocity or average velocity. In particular, for a given time T*, the algorithm calculates the T-Vel of the device and determines if device has remained below a pre-determined velocity minimum velocity MinVel*. If the answer is affirmative, then algorithm flags current location as a “candidate” destination subject to verification. This algorithm may be included a real-time process, a batch process, or both real-time and batch processes.

In FIG. 22, the flowchart shows Algorithm A02 for determining if the current location of mobile device is a destination by measured persistence. In particular, for a given time T*, the algorithm determines if device has remained within a pre-determined spatial tolerance corresponding the destination size DS*. If the answer is affirmative, then algorithm flags current location as a “observed” destination subject to verification. Also, examples of minimum, maximum and typical values for the predetermined variable DS* are shown in Table 6 below.

TABLE 6
Examples of Predetermined Variable DS* in Algorithm A02

| Jurisdiction/Boundary | Min Value | | Max Value | | Typical Value | |
|---|---|---|---|---|---|---|
| Situs, e.g. store | 1 | meter | 100 | meters | 10-30 | meters |
| Neighborhood | 10 | meters | 1000 | meters | 10-100 | meters |
| Zone, e.g airport | 100 | meters | 1 | km | 500-5 | km |

| | | | | | |
|---|---|---|---|---|---|
| Locality, e.g. city | 100 | meters | 20 | km | 1 km-10 km |
| MSA, e.g. greater city | 1000 | meters | 100 | km | 10 km-50 km |
| County | 2500 | meters | 500 | km | 10 km-100 km |
| State | 500 | km | 2500 | km | |
| Province | 1000 | km | 5000 | km | |
| Country | 100 | km | 10000 | km | 1000 km-2000 km |
| Continent | 5000 | km | 20000 | km | |
| Ocean | 10000 | km | 30000 | km | 15000 km-20000 km |

In another embodiment, the algorithm may be written in any programming language and the source code may be compiled to any executable code that can run on the device 100 or 110 and/or server 200. In addition, the includes the following variables, functions and/or methods:
dwTimeStamp: Time (in seconds since Jan. 6, 1980) of this measurement
status: Response Status
dwLat: Latitude, 180/2ˆ25 degrees, WGS-84 ellipsoid
dwLon: Longitude, 360/2ˆ26 degrees, WGS-84 ellipsoid
wAltitude: Altitude, meters, WGS-84 ellipsoid
wHeading: Heading, 360/2ˆ10 degrees
wVelocityHor: Horizontal velocity, 0.25 meters/second
bVelocityVer: Vertical velocity, 0.5 meters/second
accuracy: Accuracy of the data.
fValid: Flags indicating valid fields in the struct.
bHorUnc: Horizontal uncertainity
bHorUncAngle: Horizontal uncertainity at angle
bHorUncPerp: Horizontal uncertainty perpendicular
bVerUnc: Vertical uncertainity
GPS_UTCOffset: Time difference in seconds between UTC and GPS satellite time
LocProbability: Probability that user's actual position is within the described ellipse, expressed as a percentage
method: Bitmask providing information about the positioning method used to calculate the location.

In FIG. 23, the flowchart shows Algorithm A03 for alacrity prediction by temporal criteria, e.g. calendar date, time of day, day of week, and so on. In particular, for a given time of day, the algorithm determines if a time of day within a predetermined window such that OT*<time of day <CT*. Also, the algorithm optionally determines if time of day is within the operating hours of potential destinations. If the answer is affirmative, then algorithm flags potential destination as a positive result.

In FIG. 24, the flowchart shows Algorithm A04 for alacrity prediction by proximity to destination to analysis. In particular, the algorithm determines if potential destination is nearby or in proximity to the mobile device 100 or other electronic device 110. In one embodiment, proximity is determined by measurement of distance as a straight line from the current location to the potential destination. In other embodiments, the proximity may be determined by measurement of driving distance, flying distance, or other travel distance which depend on various factors including the mode of transportation, terrain, geography, and so on. If the answer is affirmative, then algorithm flags potential destination as a positive result.

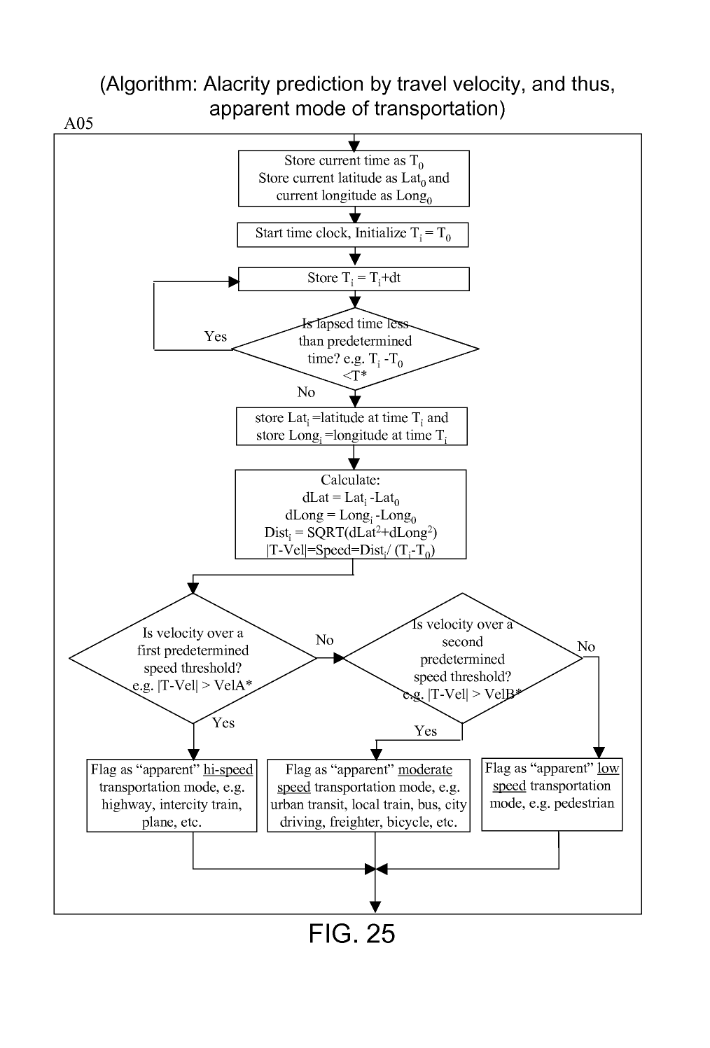

In FIG. 25, the flowchart shows Algorithm A05 for alacrity prediction by measured travel velocity also known as T-Vel. Such measured travel velocity may be either instantaneous velocity or average velocity. In particular, after a given time T*, the algorithm determines if velocity of the mobile device 100 or other electronic device 110 is over a first velocity VelA* corresponding to a high speed mode of transportation, e.g. highway, intercity train, airplane, and so on. The algorithm optionally determines if velocity of the mobile device 100 or other electronic device 110 is over a second velocity VelB* corresponding to a moderate speed mode of transportation, e.g. urban transit, local train, city bus, city driving, freighter, bicycle, and so on. If the answer is over VelA*, then algorithm flags mode of transportation as “apparent” high speed mode; if under VelA* and over VelB*, then algorithm flags mode of transportation as “apparent” moderate speed mode; and if under VelB*, then algorithm flags mode of transportation as “apparent” low speed mode. Thus, by implication, the algorithm may ascertain the apparent mode of transportation.

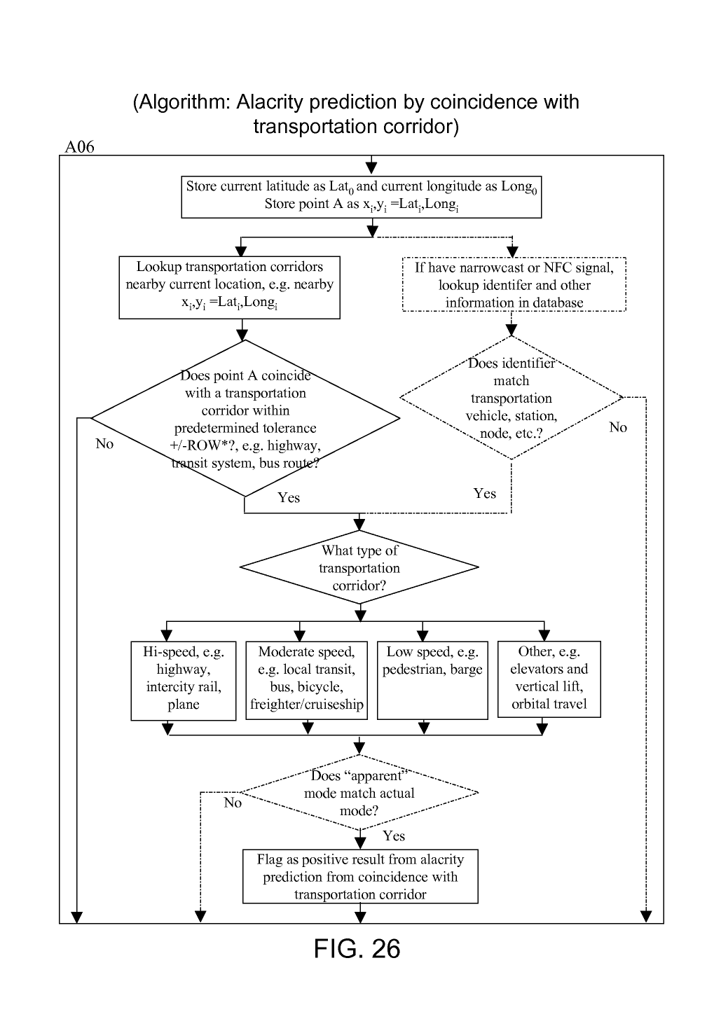

In FIG. 26, the flowchart shows Algorithm A06 for alacrity prediction by coincidence with transportation corridor. In particular, within a predetermined tolerance ROW*, the algorithm determines if the mobile device 100 or other electronic device 110 is coincident with a transportation corridor, e.g. highway, transit system, bus route, and so on. If the answer is affirmative, then algorithm flags the type of transportation corridor. Also, the algorithm may optionally determines the actual speed or the estimated speed of the transportation mode and may flag the speed of the transportation mode.

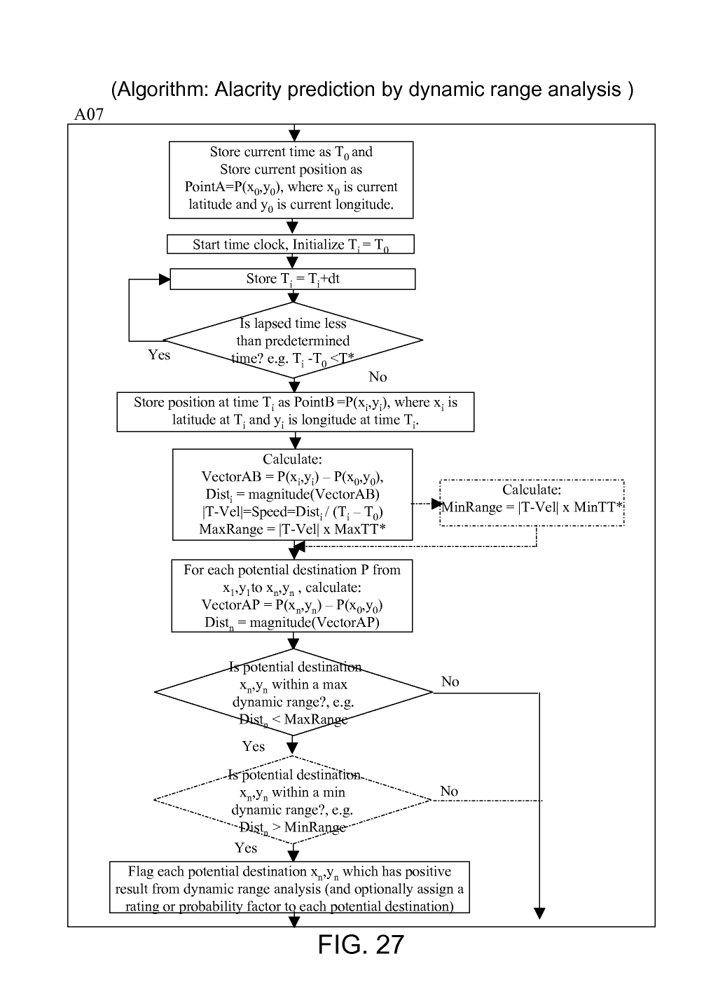

In FIG. 27, the flowchart shows algorithm A07 for alacrity prediction by dynamic range analysis. In particular, after a given T*, the algorithm determines if potential destination(s) are within the maximum dynamic range of the device. Also, the algorithm may optionally determine if the potential destination(s) are above the minimum dynamic range. In one embodiment, the algorithm calculates the maximum dynamic range as measured travel velocity multiplied by the maximum travel time MaxTT*. In another embodiment, the algorithm calculates the minimum dynamic range as the measured travel velocity multiplied by the minimum travel time MinTT*. If the answer is affirmative, then algorithm flags each potential destination as a positive result.

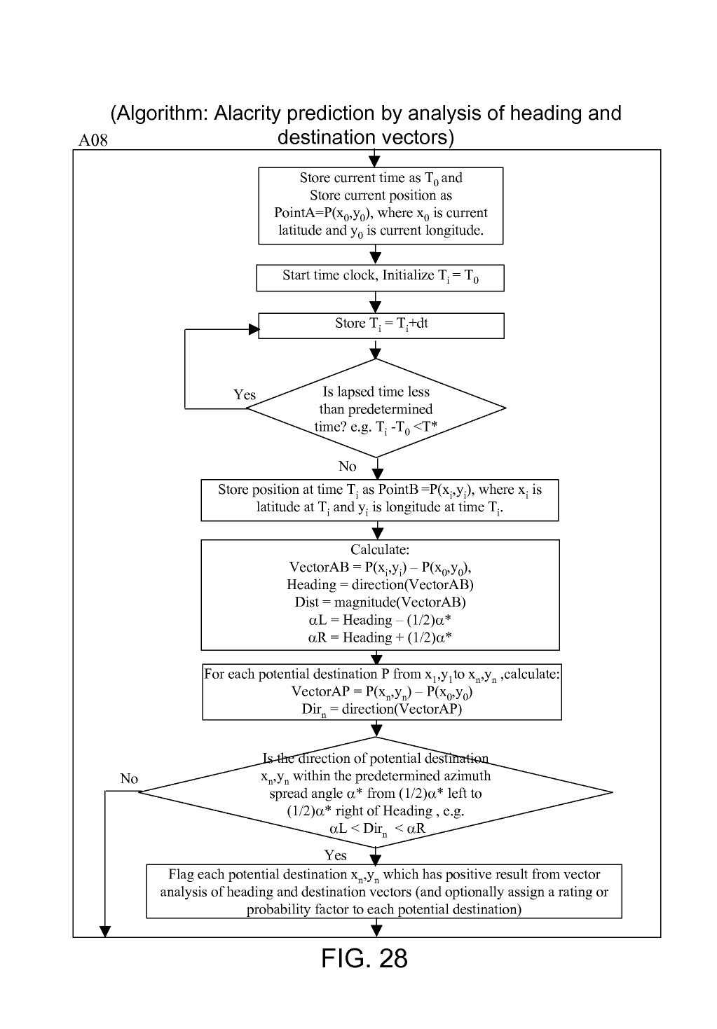

In FIG. 28, the flowchart shows algorithm A08 for alacrity prediction by analysis of heading and destination vectors. In particular, after a given T*, the algorithm determines if potential destination vector AP is within an azimuth spread angle α* of heading vector AB. In one embodiment, for each potential direction, the algorithm calculates the direction of the potential destination and determines if direction is between heading +/−10°. In other embodiments, the azimuth spread angle may be vary from 0 to at least 180°. The heading +/−(½)α* creates a so-called ‘field of view’. If the answer is affirmative, then algorithm flags each potential destination as a positive result.

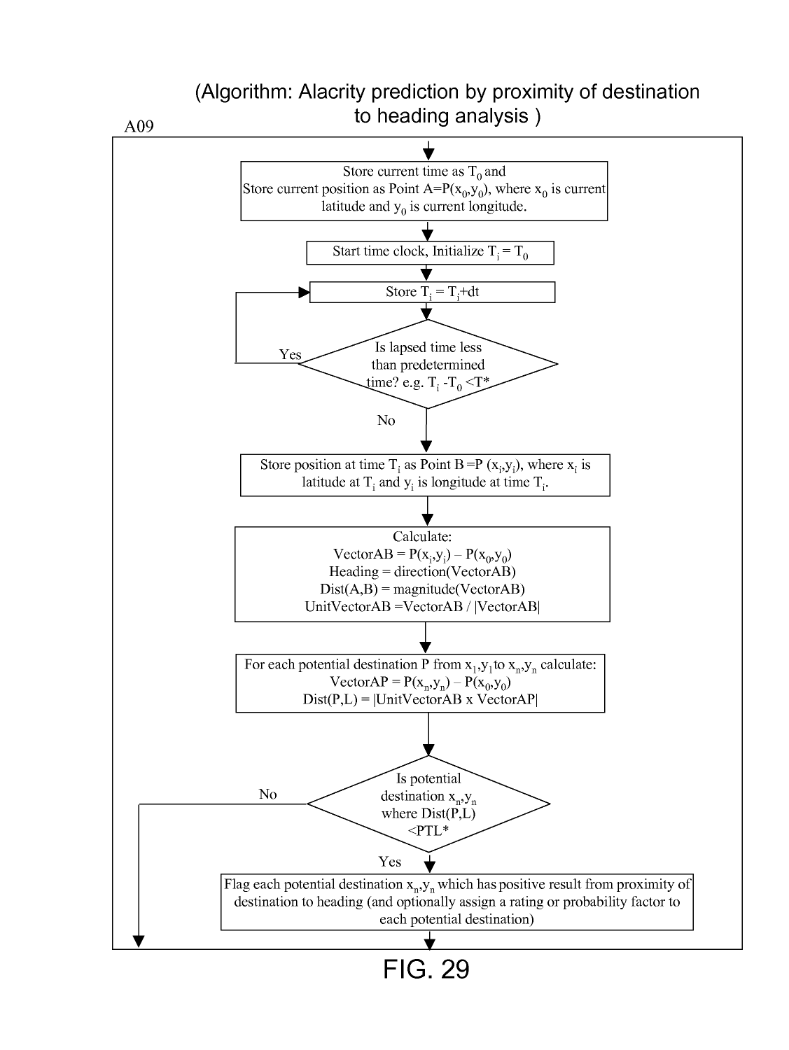

In FIG. 29, the flowchart shows algorithm A09 for alacrity prediction by proximity of destination to heading analysis. In particular, after a given T*, the algorithm determines if potential destination(s) are within a predetermined distance PTL* from the heading vector. In one embodiment, the algorithm first calculates a unit vector AB and then calculates the distance from each potential destination to the heading. First calculating the unit vector is the most efficient method to calculate distance of point to a line, e.g. heading. If the answer is affirmative, then algorithm flags each potential destination as a positive result.

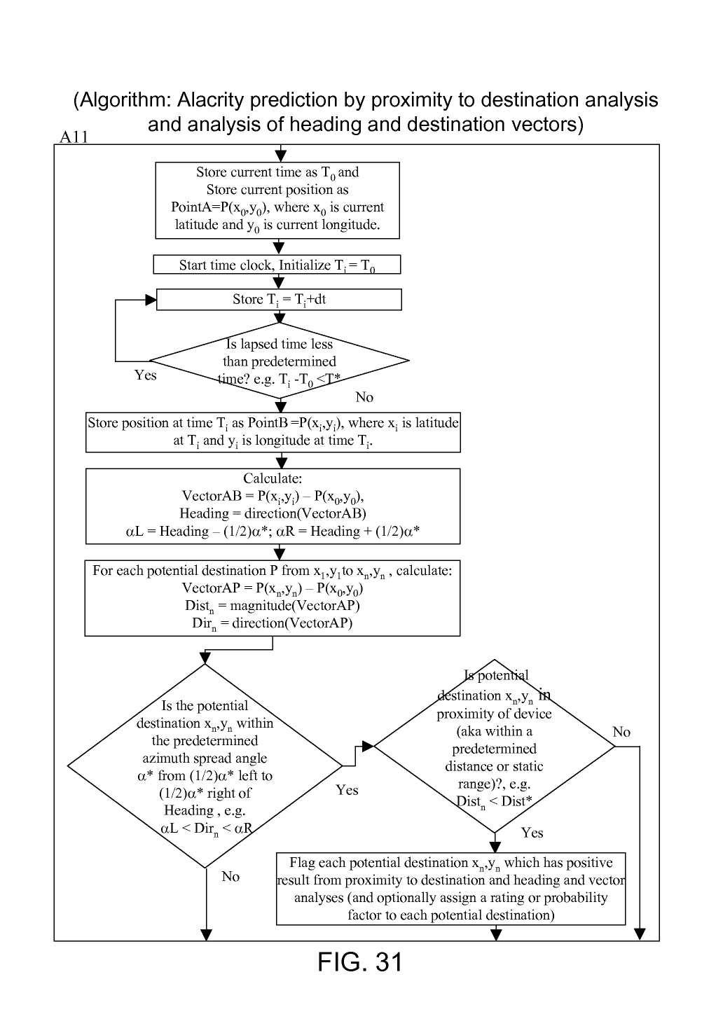

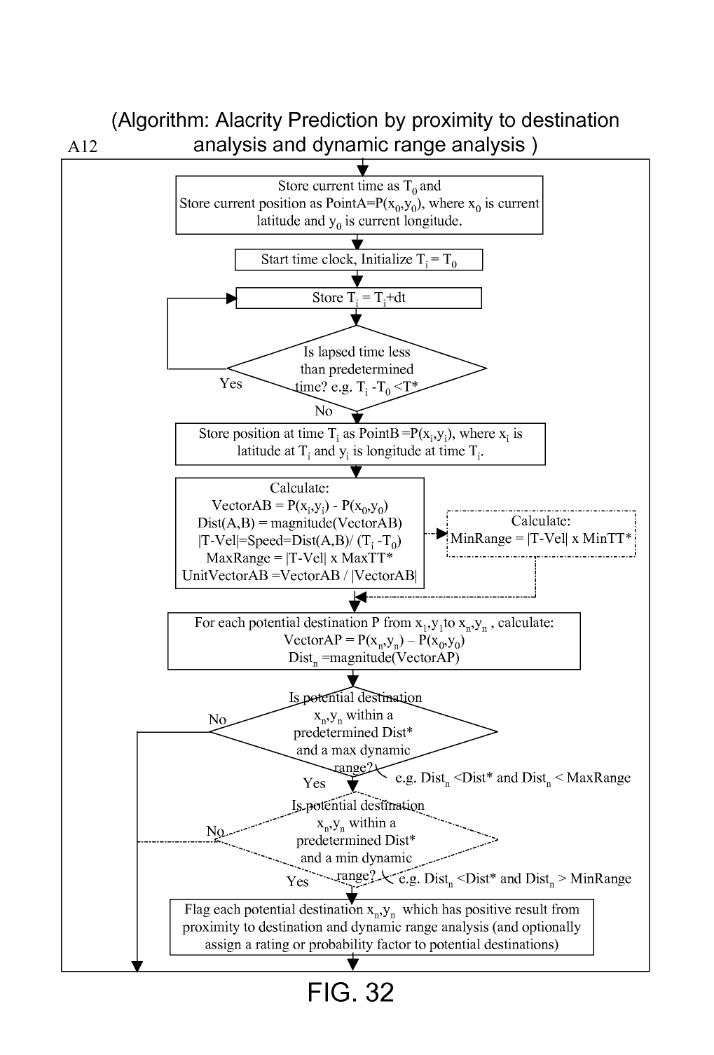

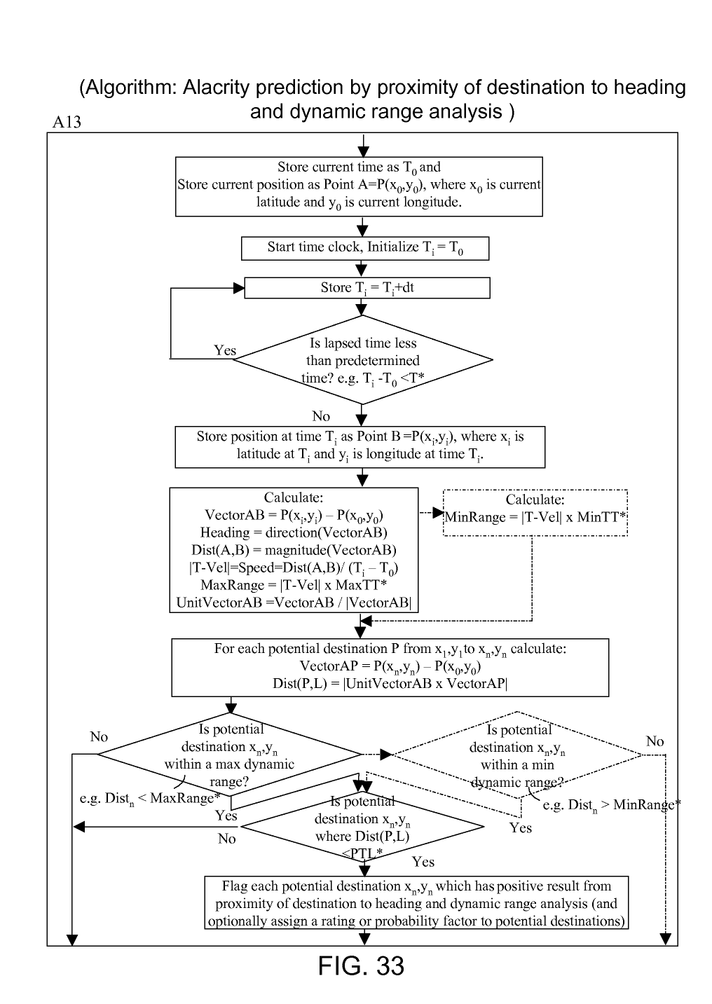

In FIG. 30, the flowchart shows a hybrid algorithm Al0 which integrates algorithms A07 and A08 for alacrity prediction by analysis of heading and destination vectors and dynamic range analysis. In FIG. 31, the flowchart shows a hybrid algorithm A11 which integrates algorithms A04 and A08 for proximity to destination analysis and analysis of heading and destination vectors. In FIG. 32, the flowchart shows a hybrid algorithm A12 which integrates algorithms A04 and A07 for proximity to destination analysis and dynamic range analysis. In FIG. 33, the flowchart shows a hybrid algorithm A13 which integrates algorithms A09 and A07 for proximity to destination to heading and dynamic range analysis.

With reference to FIGS. 34 through 36, the algorithms show jurisdiction prediction using GPS, telephone number, and IP address. In some embodiments, a jurisdiction may comprise a political jurisdiction such as a city, county, district, state or province, nation, or a continent. Knowing the legal residence of the user of the device is essential to target messages to voters in the political jurisdiction. The legal residence can be inferred from geographic variables such as GPS, telephone number, and IP address. In other embodiments, a jurisdiction may comprise a community jurisdiction such as a neighborhood, school, or home owners association. In other embodiments, a jurisdiction may comprise a geographical area such as a mountain range. In still other embodiments, a jurisdiction may comprise a metropolitan area, a downtown, a redevelopment area, and so on. In yet still other embodiments, a territory or other boundary is substituted for a jurisdiction such as a sales territory or a geographical market segment.

FIG. 34 shows an algorithm A14 for jurisdiction prediction using GPS, A-GPS, or RF location. The algorithm is usable for mobile devices 100 and other electronic devices with GPS capability. In one embodiment, an algorithm may employ a method such as ray tracing or the like to determine if the current or other location(s) is within the jurisdiction, territory or other boundary. In another embodiment, an algorithm may employ a hybrid method using ray tracing using bounding methods that are well-known in the literature. In other embodiments, an algorithm may employ a method of looking up records or queries to one or more datatables to determine the jurisdiction. For example, databases of geographical information of the type maintained by the U.S. Census Bureau such as the TIGER database has various data fields including latitude, longitude, county, state, and so on. In another example, each jurisdiction has geographical information on the boundary of its jurisdiction and the boundaries of the subdivisions of its jurisdiction.

In addition, querying a datatable may be performed as a batch process rather than a contemporaneous further increasing efficiency. Even if an appropriate datatable is not readily available, ray tracing and similar methods can be used in a batch process to create the datatable. For example, subdivisions of a political boundary such as precincts may be ray-traced to create appropriate datatables.

In another embodiment, to avoid having to load a large datatable on the mobile device, the algorithm may utilize a database broken into multiple datatables that are tiered or cascaded to reduce the size of each datatable. For example, a query to the first tier datatable would return the state or province; a query to the second tier datatable would return the county or district; a query to the third tier datatable would return the city or municipality. Examples of tiered jurisdiction datatables are shown in Table 7 below.

TABLE 7
Examples of Jurisdiction datatables

| | | |
|---|---|---|
| Latitude | Longitude | datatable ID |

Datatable truncated to Nearest Latitude and Longitude

| | | | |
|---|---|---|---|
| | | Jurisdiction(s), e.g. | |
| | | State/Province | |
| 0° | 0° | 000000 | |
| 0° | 1° W | | 000001 |
| . | . | . | . |
| . | . | . | . |
| . | . | . | . |
| 36° N | 112° W | Arizona | 036112 |
| 36° N | 113° W | Arizona | 036113 |
| . | . | . | . |
| . | . | . | . |
| . | . | . | . |
| 37° N | 112° W | Arizona | 037112 |
| 37° N | 113° W | Arizona | 037113 |
| . | . | . | . |
| . | . | . | . |
| . | . | . | . |
| 179° N | 179° W | | 179179 |
| . | . | | . |
| . | . | | . |
| . | . | | . |
| 179° S | 0° | | 359000 |
| 179° S | 1° E | | 359181 |
| . | . | | . |
| . | . | | . |
| . | . | | . |
| 179° S | 178° E | | 359358 |
| 179° S | 179° E | | 359359 |

Datatable 036112 truncated to Nearest 1/10^{th} of Latitude and
1/10^{th} of Longitude

| | | | |
|---|---|---|---|
| | | Jurisdiction(s), e.g. county | |
| . | . | . | . |
| . | . | . | . |
| . | . | . | . |
| 36.0° N | 112.0° W | Coconino | 03601120 |
| 36.0° N | 112.1° W | Coconino | 03601121 |
| 36.0° N | 112.2° W | Coconino | 03601122 |
| . | . | . | . |
| . | . | . | . |
| . | . | . | . |
| 36.9° N | 112.8° W | Mohave | 03691128 |
| 36.9° N | 112.9° W | Mohave | 03691129 |
| 37.0° N | 113.0° W | Mohave | 03701130 |
| . | . | . | . |
| . | . | . | . |
| . | . | . | . |

Datatable 03621126 truncated to Nearest 1/100^{th} of Latitude and
1/100^{th} of Longitude

| | | | |
|---|---|---|---|
| | | Jurisdiction(s), e.g. | |
| | | city/municipality | |
| . | . | . | . |
| . | . | . | . |
| . | . | . | . |
| 36.05° N | 112.03° W | | 0360511203 |
| 36.05° N | 112.04° W | | 0360511204 |
| 36.05° N | 112.05° W | Grand Canyon Village | 0360511205 |
| . | . | . | . |
| . | . | . | . |
| . | . | . | . |
| 36.29° N | 112.68° W | | 0362911268 |
| 36.29° N | 112.69° W | | 0362911269 |
| 37.30° N | 112.70° W | | 0373011270 |
| . | . | . | . |
| . | . | . | . |
| . | . | . | . |

* Data from Grand Canyon, United States

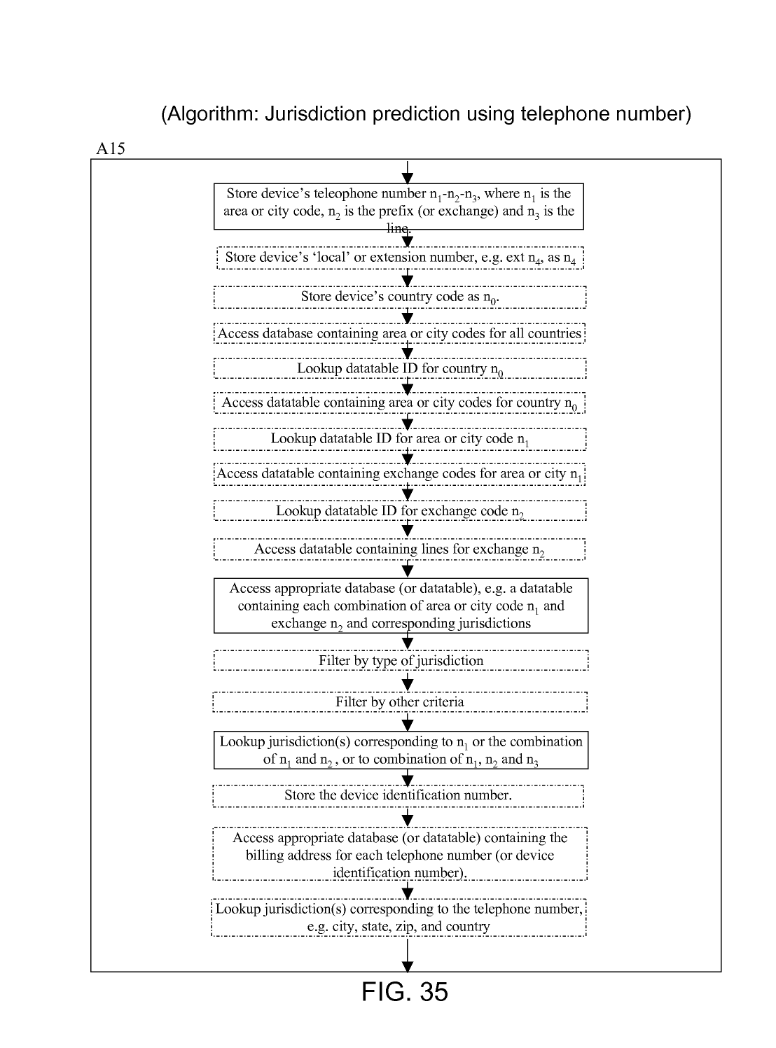

FIG. 35 shows an algorithm A15 for jurisdiction prediction using telephone numbers. The algorithm is usable for mobile devices 100. The algorithm may also be usable for other electronic devices 110 that have dedicated telephone numbers. In one embodiment, an algorithm employs a look-up table to determine the jurisdiction of the device similar to the algorithm Area Decorder developed by AmeriCom. Yet, problems arise due to mobility of users and portability of telephone numbers. In another embodiment, to verify that the user of the device has not moved nor is visitor from out-of-town, the algorithm may verify the billing address for the mobile device 110. In still another embodiment, a hybrid algorithm may also use GPS location to verify the location of person.

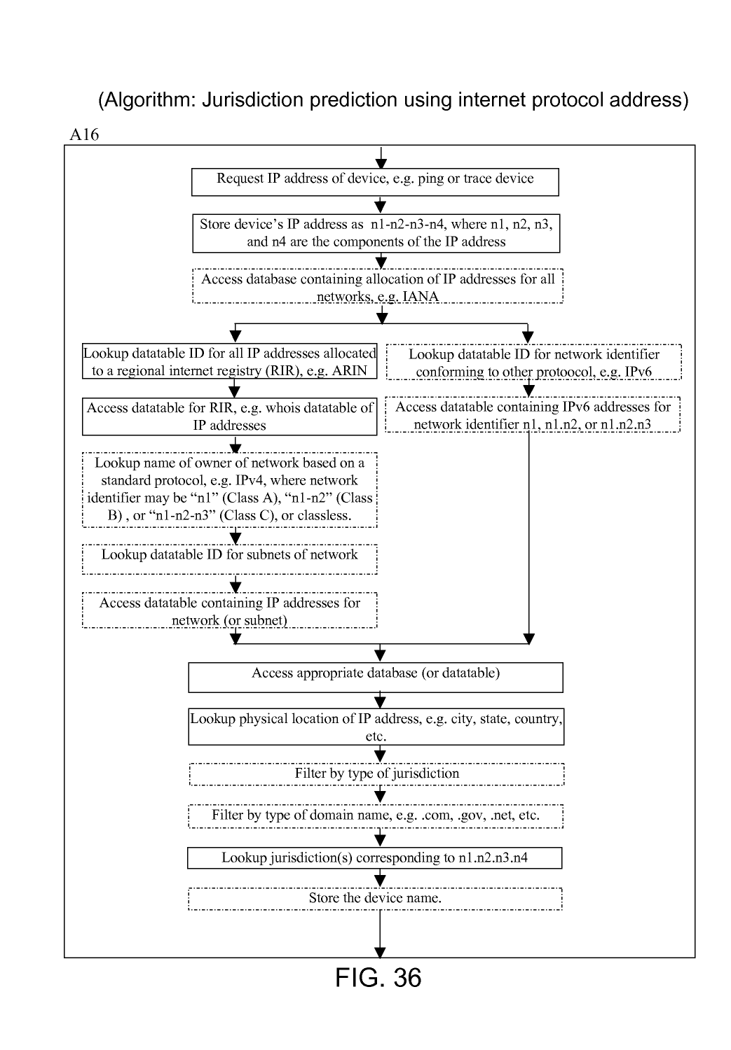

FIG. 36 shows an algorithm A15 for jurisdiction prediction using IP address. The algorithm is usable for electronic devices 110 and may be usable for mobile devices under a protocol for mobile devices such as mobile IP. In one embodiment, an algorithm employs a look-up table to determine the jurisdiction of the device similar to the algorithm Whois datatable of IP addresses maintained by ARIN of Santa Monica, Calif.

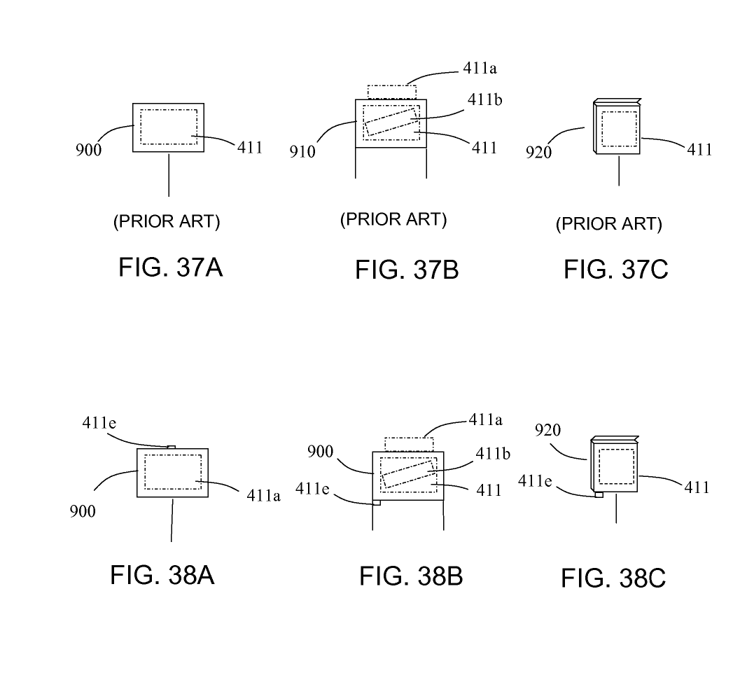

FIGS. 37A through 37C shows examples of alternative signs 900, 910 or 920 with one or more display areas 411a . . . 411c. These signs and display areas represent the prior art and are used for many purposes including retail stores, political campaigns, open houses, garage sales, and so on. FIG. 37A shows a post sign 900 having a single display area 411a. FIG. 37B shows an A-frame sign 910. In one embodiment, the sign has a single display area 411a. In another embodiment, the sign has a first display area 411a and a second overlaid display area 411b. In still another embodiment, the sign has a third display area 411c. Each display area 411a through 411c may contain text, numerals, images, or so on. For example, a display area 411a may have the text “For sale”, and/or telephone number and display areas 411b or 411c may have the text “Sold”, “In escrow”, and/or other text. In FIG. 27C, shows a box mounted on a stake 920. In one embodiment, the box has a see-through panel in front and/or a lid and the front of the box represents at least one display area 411a when it is not empty of advertising materials such as flyers. In addition to or in lieu of text, one or more display areas may be have a logo, image or colors of a brand. It will be appreciated that a sign with at least one display area will remain an effective method of advertising, promotion, and so on, but it can be improved.

FIGS. 38A through 38C shows examples of alternative signs 900 with at least one electronic device 411e for a signal such as RFID tag, a NFC chip or the like. In one embodiment, the signal is a narrowcast to devices in its vicinity. In another embodiment, the sign has at least one display area 411a and the electronic device 411e such that the sign provides both visual display and electronic information. For example, the electronic device 411e is capable of transmitting a signal to mobile devices 100 of the type manufactured by Qualcomm, Inc. or Samsung. In this way, even if a display no longer has materials, a user of a mobile device may obtain information. In addition, the user of the mobile device may obtain more extensive information, e.g. complete property profile, comparable sales information, interior pictures, and so on.

In operation, the central processor 10 receives input communicated from one or more input device(s) 40a . . . 40c or communication from server 200, processes said input or communication in accordance with instructions and/or data communicated from one or more internal storage medium(s) 20a . . . 20c, and transmits output to one or more internal display(s) 30a . . . 30c. Where one or more external display(s) 31a . . . 31zz is present, the central processor, audio processor, audio-video processor, or other processor may transmit output may transmit output to the external display(s). Where one or more internal speaker(s) 32a . . . 32c is present, the central processor, audio processor, audio-video processor, or other processor may transmit output to the speaker, and where one or more external speaker(s) 33a . . . 33zz is present, the central or other processor. The internal storage medium(s) 20a . . . 20d record information communicated from the central or other processor. Where one or more external storage medium(s) 21a . . . 21zz is present, the external storage medium(s) record information communicated from the central or other processor.

With reference to FIGS. 16A, 17A, 17B and applicable FIGS. 18A through 18D and associated algorithms in FIGS. 23 through 36, a mobile device 100 or other electronic device 110 displays at least one advertisement, promotion, or other message on one or more internal visual display(s) 30a . . . 30d and/or external display(s) 31a . . . 31zz. In addition to or in lieu a visual display of one or more display(s), the mobile device or other electronic devices plays at least one advertisement, promotion, or other message on one or more internal speaker(s) 32a . . . 32d and/or external speaker(s) 33a . . . 33zz. The mobile device 100 or other electronic device 110 can retrieve the message from at least one server 200 across one or more the network(s). In some embodiments, such retrieval and/or display may be contemporaneous or real-time; in other embodiments, such retrieval may be in advance of such visual display on the display(s) or play on one or more speaker(s) to avoid various issues such as limited bandwidth, latency, and so on. Also, such retrieval and/or display may optionally be in response to a customer request. The mobile device 100 or other electronic device 110 can optionally send a response via one or more networks to a server 200.

In one embodiment, the system may use a client/server/database model where the server 200 receives the information from the client, e.g. device 100, including but not limited to geographic variables such as latitude and/or longitude, checks the user's position and determines the user's velocity, heading, and so on by comparing information received from the client at different times, then stores the information in a database, looks up relevant information based on criteria stored by the server, and sends back to the user that information that matches one or more criteria. In some embodiments, criteria may include spatial and kinetic variables, and any other variables including but not limited to variables such as time of day, day of week, date, telephone number and/or prefix, and so on. For example, with user's velocity, heading and other derived information, the server may determine if user is driving on a road or freeway, and thus, push message(s) that are appropriate for such users. A host application will push message(s), e.g. advertisements, promotions and the like, based on the criteria stored by the server. In other embodiments, the criteria may be stored on the client. In still other embodiments, in addition to or in lieu of time, date, and spatial and kinetic variables and criteria may include user demographics, preferences, and/or purchasing behavior. In addition, a host application running on the server may save user information in a database for future advertisements, marketing, or promotions.

In addition to marketing of products and services, there are many other examples of applications for the system and methods described herein. Using political campaigning as an example, information or messages may include campaign messages in support or opposition of a candidate, proposition, or ballot initiative.

Using tourism as an example, a user's device would connect to the server and send the user's current location, velocity, heading, and so on, and any other information collected from the user's mobile device, the user would be able to start a virtual tour, being told where to walk, or drive, what they are going to see, and what else is around them. For example, as they were walking down the Las Vegas strip, a user could instantly or relatively quickly receive information regarding the hotels, shops, shows and any other points of interest, whether they be sites, events, products or services, or information about these or about what is happening around the user's location. The user could make reservations, submit orders, purchase tickets to events or shows, or receive information about the reservations events, shows, etc. As a specific example, if user is located on the Las Vegas Strip, the system could send user information regarding the shows or events at the hotels/casinos within 2 miles of user, that are not “sold out”, and that are starting within the next 24 hours. Using velocity, travel velocity, or heading as a factor from a freeway the server would be able to send the user info about cities, hot spots commercials, and maps to let you know how to get there. It could inform the user of gas prices and cheapest and/or nearest places for fuel. It could also be able to inform the user how to get to any destination and also where to stop along the way for coffee, burgers, etc. As another specific example, if user is driving on interstate 15 approaching Las Vegas, the system could send user information regarding Las Vegas, e.g. points of interest, services, etc.

Thus, the systems and methods of the invention allows targeting of information to the user to assure that it is pertinent to the user's current location, or within the current geographical area, or to potential destinations. In some embodiments, the system and/or the processes are self-executing operates without any user input, e.g. name, address, preferences, favorite stores, etc. In other embodiments, the system and/or processes utilize user input. As a specific example, if user is located on or traveling by the Las Vegas Strip, the send information regarding the shows at the hotels/casinos within 2 miles of user that match the user's entertainment preferences. In various embodiments, the information is stored in a database for future reference and a more customized user experience.

With reference to FIGS. 16B, 17A, 17B and applicable FIGS. 18A through 18D and associated algorithms in FIGS. 23 through 36, in response to a user request, a mobile device 100 or other electronic device 110 provides a response. For example, if the user request is a request for information (RFI), the device 100 or 110 retrieves and serves the information to one or more internal visual display(s) 30a . . . 30d and/or external display(s) 31a . . . 31zz. In addition to or in lieu a visual display of one or more display(s), the mobile device or other electronic devices may serve information to one or more internal audio speaker(s) 32a . . . 32d and/or external audio speaker(s) 33a . . . 33zz. The mobile device 100 or other electronic device 110 may retrieve the information from the storage medium 20a . . . 20d or 21a . . . 21zz, or may retrieve the information from the server 200 across one or more the network(s). In some embodiments, such retrieval and/or display may be contemporaneous or real-time; in other embodiments, such retrieval may lag the request depending on the time required to retrieve the information. The mobile device 100 or other electronic device 110 can optionally send a response via one or more networks to a server 200. As discussed above, in some embodiments, the information retrieved and served to the user may be targeted to the user based on various criteria including geographic location, spatial and kinetic variables, and/or temporal variables. In at least one embodiment, no user input is required and the information is served based on time, geographic location or derived variables, e.g. velocity or mode of transportation. In other embodiments, the information retrieved and served to the user may be targeted to the user based on user demographics, preferences, and purchasing behavior.

With reference to FIGS. 16C, 17A, 17B and applicable FIGS. 18A through 18D and associated algorithms in FIGS. 23 through 36, a mobile device 100 or other electronic device 110 collects information about the location(s) of the device 100 and/or the user(s) of the device 100 or 110. For example, if the device is a mobile device 100, the device may determine geographic variables corresponding to the current location of the device and send updates of geographic variables and/or other information to the server 200 across one or more network(s). In some embodiments, such transmission may be contemporaneous or real-time; in other embodiments, such transmission may be a batch transmission. In still another embodiment, a mobile device 100 may optionally determine if a location is a destination, make a record of such destination, and/or send a record of the destination to the server 200. In still other embodiment, both a mobile device 100 and other electronic device 110 may collect and transmit information about user demographics, preferences, and purchasing behavior to the server 200. Similar to transmission of location information such as geographic variables, such transmission of user information may be contemporaneous or by batch transmission.

With reference to FIGS. 16D, 17A, 17B and applicable FIGS. 18A through 18D and associated algorithms in FIGS. 23 through 36, a mobile device 100 or other electronic device 110 manages information about the location(s) of the device 100 and/or the user(s) of the device 100 or 110. For example, if the device is a mobile device 100, the device may manage information corresponding to location(s) and/or user(s) send updates of geographic variables and/or other information to the server 200 across one or more network(s). In some embodiments, a mobile device 100 may allow the user, or an agent, to manage location information such as information relating to destinations such as personal and/or group destinations. The agent may be a natural person or entity such as a user, a parent, a friend, an assistant, and so on, or the agent may be a machine, e.g. an electronic agent, robot, spider or other software. In other embodiments, both a mobile device 100 or other electronic device 110 may manage information about user demographics, preferences, and purchasing behavior. In one embodiment, the device 100 or 110 allows the user or the agent, to add, delete, and/or adjust, alter, markup, annotate, or otherwise change the information. In another embodiment, the device 100 or 110 allows the user or the agent to filter, sort, or otherwise manipulate the information by one or more criteria. In still another embodiment, the device 100 or 110 allows the user or the agent to customize the display or GUI, file or folder structure, and so on. In some embodiments, the device may manage information by transmitting information to and receiving information stored on the server 200 across one or more network(s). In other embodiments, a mobile device 100 or other electronic device 110 may manage information and/or record changes to the information stored on internal storage medium(s) 20a . . . 20d, or optionally on external storage medium(s) 21a . . . 21zz. In still other embodiments, the user or agent may manage information stored on the server 200. In some embodiments, such transmission may be contemporaneous or real-time; in other embodiments, such transmission may be a batch transmission. Similar to transmission of location information, such transmission of user information may be contemporaneous or by batch transmission.

With reference to FIGS. 16E, 17C and applicable FIGS. 18A through 18D and associated algorithms in FIGS. 23 through 36, a mobile device 100 or other electronic device 110 analyzes and reports information about the location(s) of the device 100 and/or the user(s) of the device 100 or 110. In one embodiment, the analysis and reports of information about destinations visited by multiple devices 100 is processed on the server 200. For example, information about destinations may be clustered to determine popular destinations (aka “hotspots”). Such popular destinations may be ranked, weighted, or compared by their relative popularity using various metrics including base and/or derived metrics. In another embodiment, the analysis and reporting of information about personal or group destinations may be processed on the mobile device 100, or pre-processed on the mobile device and then transmitted to the server 200 across one or more network(s). For example, if the device is a mobile device 100, the device may analyze and report information about personal and group destinations which may difficult to extract from the information from datatable(s) on the server about all destinations for several reasons. Personal destinations may be difficult to extract because some destinations visited by a user may aberrations such as accidental or inadvertent destinations or may be destinations having no or few repeat visits. Group destinations may be difficult to extract because membership in a group may not be easily identifiable. In another embodiment, analysis and reporting includes information relating the user(s) and/or other information. In some embodiments, such analysis and reporting may be processed on the server 200, or the device 100 or 110, or pre-processed on the device 100 or 110 and then transmitted to the server 200 across one or more networks. In another embodiment, the information may be stored on the server 200. In other embodiments, a mobile device 100 or other electronic device 110 may store information on internal storage medium(s) 20a . . . 20d, or optionally on external storage medium(s) 21a . . . 21zz. In some embodiments, such transmission of information may be contemporaneous or real-time; in other embodiments, such transmission may be a batch transmission.

Some other examples to illustrate the system include sending the user of mobile device information regarding the following applications:
Tourism, e.g. points of interest, tours inside museums, historical sites, resorts (sample message: “Visit ______”, “Come stay at ______”)
Real Estate, e.g. previews of houses, walkthroughs, profiles (sample message: “Open houses everyday”, “Property profiles 24/7”)
Politics, e.g. messages to constituents, polls, campaigns or elections for offices, propositions and initiatives in districts, cities, counties, states and nations. (sample message “Vote for ______”)
Retailers, e.g. independent stores or retail chains (sample message: “20% off on all kitchen items”)
Restaurants, e.g. fast-food restaurants along the highway (sample message: “______ 5 miles ahead”)
Fuel stations, e.g. gas or other fuel along the highway (sample message: “Next gas 5 miles ahead at ______”)
Movies, e.g. clips of the different movies at the theater and information regarding the movies. (sample message: “______ in theatres this weekend”)
Other

This system and methods of the invention would allow targeting of messages and delivery of information to users based on demographics, preferences, purchasing behavior, geographic location, or residence, with information using mobile devices with GPS will greatly increase the efficiency and accuracy of which information is received by users. This is particularly value for targeting a ‘local’ or regional audience or other location based audience. Thus, system and methods allow targeting of messages and delivery of information intended for a local or regional audience such as a metropolitan area, a resort area, etc. or to residents within a particular jurisdiction, territory, or other boundary such as a city, county, district, state, nation, and so on.

A non-exhaustive list of examples of uses of the systems and methods of the invention are shown in Table 8 below.

TABLE 8
Examples of potential uses of invention

| | | | | | Others, e.g. intangibles |
|---|---|---|---|---|---|
| | Digital | Tangible | | Real | including information, |
| Examples of Potential Use | Information | Goods | Services | Property | contracts, etc. |
| Distributing targeted messages to potential | Yes | Yes | Yes | Yes | Yes |
| buyers/leases/subscribers of products, | | | | | |
| services, contracts, real estate, and so on | | | | | |
| Advertising, marketing, promotion, orders, | Yes | Yes | Yes | Yes | Yes |
| sales, or subscriptions of products and/or | | | | | |
| services through an online storefront, | | | | | |
| portal, search engine, publisher, and so on | | | | | |
| Postings, listings, classifieds, auctions, | Yes | Yes | Yes | Yes | Yes |
| sales, commentary, blogs, and so on. | | | | | |
| Polling, surveying, census, and so on. | Yes | Yes | Yes | Yes | Yes |
| donations, gifts, and/or pledges to causes, | Yes | Yes | Yes | Yes | Yes |
| charities, and the like | | | | | |
| Navigational aids to find one or more | Yes | Yes | Yes | Yes | Yes |
| desired destination(s), e.g. nearest store(s), | | | | | |
| fuel station(s), bank(s), fast-food | | | | | |
| restaurant(s), and so on, or to find such | | | | | |
| desired destination that is also “open”, that | | | | | |
| also sells a particular type of food, that | | | | | |
| sells a particular category of product or | | | | | |
| service, that sells a particular brand of | | | | | |
| product or service | | | | | |
| Political campaigning for elected office, | Yes | | Yes | Yes | Yes |
| proposition, ballot measures, and so on. | | | | | |
| Reporting on personal destinations of a | Yes | | Yes | Yes | Yes |
| user(s) of mobile devices | | | | | |
| Reporting on group destinations of users of | Yes | | Yes | Yes | Yes |
| mobile devices | | | | | |
| Reporting on popular destinations of users | Yes | | Yes | Yes | Yes |
| of mobile devices | | | | | |
| Event announcements, e.g. shows, | Yes | | Yes | Yes | Yes |
| concerts, performances, webcasts, | | | | | |
| podcasts, meetings, protests, rallies, garage | | | | | |
| sales | | | | | |
| Public service announcements, e.g. | Yes | Yes | Yes | Yes | Yes |
| tornado/flood warnings, product recalls, | | | | | |
| closed highways/roads | | | | | |
| A combination of any of the above | Yes | Yes | Yes | Yes | Yes |

The invention may be practiced on any computer or electronic device capable any manner or form of visual display. All types of computers, computer systems, and computer networks having the capability of a visual display can generally be programmed to operate computer games and interactive programs. Even those without capability of visual display can be programmed to operate a variety of computer games or interactive programs. In addition, many electronic devices can be programmed to operate a computer game or interactive program.

Electronic devices may include any type of computer and computer system such as personal computers, laptop computers, notebook computers, handheld computers, arcade game machines, handheld games, video game systems, video game consoles, video game boxes, personal digital assistants, mobile computing devices, cable boxes, telephones, telecomputing devices, and telecommunication devices. The processes, subprocesses, and algorithms may be processed on a single processor, an array of processors, separated into two portions corresponding to the front-end and back-end, or split in any number of ways. The processor(s) may comprise one or more processors such as a single integrated circuit or multiple integrated circuits having different functions i.e. central processing unit (CPU), input-output (I/O) processing, video processing, audio processing, transmission, reception, and so on. The display(s) may be any type of analog or digital CRT display including monochrome or color monitor, TV, DTV, HDTV, and so on, and any combination of these such as array of CRTs; any flat panel display including but not limited to LCD, TFT, plasma, and so on, or any combination of these such as an array of LCDs; or a analog or digital projection system such as front projection or rear projection of the types manufactured by Sony Electronics of San Diego, Calif., and Da-Lite of Warsaw, Ind., or such as LCD or DLP of the type manufactured by InFocus of Wilsonville, Oreg., and so on.

In one embodiment of the invention, goods may include equipment, gear, equipment, uniforms, clothing or the like. In another embodiment, services may include training, coaching, practice, tutoring educational programs or the like. In a further embodiment, real property may include developed or undeveloped parcels in one or more locales (e.g. cities, country clubs, resorts, housing subdivisions, planned unit developments, university campuses, corporate parks, etc.) where the virtual location may emulate the actual locale. A default location may be pre-determined by the computer program or the location may be selected from a group or list of locations. Other defaults may be predetermined depending on product(s) to be promoted. For example, only a single product may be promoted, or multiple products within a single brand, or multiple brands.

The methods and systems of the present invention include processes, subprocesses, and modules which may be used separately, and also in conjunction with one another. Modules may comprise source that is interpreted or the source code may be compiled into executable code. The method and systems may use the results created by any process, subprocess and/or module of this invention for any purpose including but not limited to creating, adapting, or mobilizing web content for viewing on mobile devices.

The methods and systems of the invention also include processes, subprocesses, and algorithms which may be used separately, and also in conjunction with one another. Algorithms may be run independently, in series, in parallel or in any combination. The methods and systems may use the results created by any process, subprocess and/or algorithm of this invention for any purpose including distributing of targeted message(s), or advertising, marketing, or other promotion.

From the foregoing it will be appreciated that although specific embodiments of the technology have been described herein for purposes of illustration, various modifications may be made without deviating from the spirit and scope of the invention. For example, the user may lease products or services rather than purchase them outright. Also, the user may provide personal information as consideration in addition to or in lieu of payment for products and services. A message or information may be presented in ways other than visual display. For example, a message or information may be output in an audio form. Further, the invention can be used with mobile phones, desktop or personal computers, computer terminals, TVs and monitors, video game machines, video game boxes, web TV, cable TV, CCTV, video consoles, laptop computers, notebook computers, handheld computers, personal digital assistants, telephones, cell phones, pagers, and so on. Accordingly, the invention should be broadly construed and should not be limited.

What is claimed is:

1. A method of mobilizing a webpage comprising:
receiving a request from a browser operating on a device;
identifying the device whereby limitations of the device are determined;
reading source code of the webpage from a storage medium;
generating a version of the source code that meets the limitations of the device; and
serving the version of the webpage to the device.

2. A method of mobilizing code comprising:
identifying a source of code;
receiving input from a storage medium, where the input is existing code;
parsing the input into discrete parts;
selecting the discrete parts to be included in the output;
combining the discrete parts in a new code; and
sending output to a storage medium.

3. A method of mobilizing code comprising:
identifying a source of code;
receiving input from a storage medium, where the input is existing code;
parsing the input into discrete parts;
selecting a plurality of discrete parts to be included in a mobilized display;
inserting a set of instructions in the existing code, wherein only the selected parts are displayed on a mobile device; and
sending output to a storage medium.

4. The method of claim 3 wherein the method has an additional step of including additional content.

5. The method of claim 3 wherein the method has an additional step of adding at least one item of text, at least one image, and/or at least one command specific to the functionality of the mobile device.

6. A system for mobilizing code comprising:
a mobile device;
a webpage wherein the webpage includes codes or commands intended for the mobile device; and
a browser running onboard the mobile device wherein the browser executes the codes or commands.

7. The system of claim 6 wherein the webpage includes special tags to indicate which content is intended for the mobile device.

8. The system of claim 6 wherein the webpage includes at least one special tag to make a telephone call.

9. The system of claim 6 wherein the webpage includes at least one special tag to send a SMS message.

10. The system of claim 6 wherein the webpage includes at least one special tag to send a MMS message.

11. A method of taking an action via a mobile device comprising:
displaying a plurality of alternatives;
selecting at least one alternative; and
in response to user selecting the alternative, taking a pre-determined action.

12. The method of claim 11 wherein the alternatives are customizable.

13. The method of claim 11 wherein the alternatives are displayed as a list or menu.

14. The method of claim 11 wherein the alternatives are displayed as a plurality of images.

15. The method of claim 11 wherein the alternatives are displayed as a plurality of photos.

16. The method of claim 11 wherein the alternatives are displayed as a plurality of iconographics.

17. The method of claim 14, 15, or 16 wherein the alternatives are displayed as thumbnail sized images, photos, or icons having links wherein to other resources which are internet accessible.

18. The method of claim 11 wherein the alternatives are arranged in a matrix having at least one row and one column.

19. The method of claim 11 wherein the alternatives are arranged in a matrix having 2 rows and 2 columns.

20. The method of claim 11 wherein the alternatives are arranged in a matrix having 3 rows and 3 columns.

21. The method of claim 11 wherein the method has an additional step:
in response to user selecting a toggle key, one or more additional alternatives are displayed;

22. The method of claim 11 wherein the alternatives are selected using voice commands.

23. The method of claim 11 wherein the alternatives are selected using a touch screen.

24. The method of claim 11 wherein the alternatives are selected using a keypad.

25. The method of claim 11 wherein the alternatives are selected by pressing a single key on a keypad with a plurality of keys each having a one-to-one correspondence with the alternatives.

26. A system for taking an action via a mobile electronic device comprising:
An electronic device capable of communicating with a remote server;
a display in communication with the device wherein the device displays a plurality of alternatives;
a keypad in communication with the device wherein a user can select at least one alternative;
in response to user selecting the alternative, the device takes a pre-determined action.

27. The method of claim 26 wherein the alternatives are customizable.

28. The method of claim 26 wherein the alternatives are displayed as a list.

28. The method of claim 26 wherein the alternatives are displayed as a plurality of images.

29. The method of claim 26 wherein the alternatives are displayed as a plurality of photos.

30. The method of claim 26 wherein the alternatives are displayed as a plurality of iconographics.

31. The method of claim 28, 29, or 30 wherein the alternatives are displayed as thumbnail sized images, photos, or icons having links wherein to other resources which are internet accessible.

32. The method of claim 26 wherein the alternatives are arranged in a matrix having at least one row and one column.

33. The method of claim 26 wherein the alternatives are arranged in a matrix having 1 rows and 3 columns.

34. The method of claim 26 wherein the alternatives are arranged in a matrix having 2 rows and 2 columns.

35. The method of claim 26 wherein the alternatives are arranged in a matrix having 3 rows and 3 columns.

36. The method of claim 26 wherein the method has an additional step:
in response to user selecting a toggle key, one or more additional alternatives are displayed;

37. The method of claim 26 wherein the alternatives are selected using voice commands.

38. The method of claim 26 wherein the alternatives are selected using a touchscreen.

39. The method of claim 26 wherein the alternatives are selected using a keypad.

40. The method of claim 26 wherein the alternatives are selected by pressing a single key on a keypad with a plurality of keys each having a one-to-one correspondence with the alternatives.
